(19) United States
(12) Patent Application Publication
(10) Pub. No.: US 2004/0219486 A1
(43) Pub. Date: Nov. 4, 2004

(54) Rubber dams with operative inserts and integrally attached external frames which resist the external vector forces of displacement and effectively isolate dental anatomical structures of the alveolar arch

(76) Inventor: John Heasley, Iowa City, IA (US)

Correspondence Address: DAVIS, BROWN, KOEHN, SHORS & ROBERTS, P.C., THE FINANCIAL CENTER, 666 WALNUT STREET, SUITE 2500, DES MOINES, IA, 50309-3993, US

(21) Appl. No.: 10/728,100

(22) Filed: Dec. 4, 2003

Related U.S. Application Data
(63) Continuation-in-part of application No. 10/117,395, filed on Apr. 5, 2002.
(60) Provisional application No. 60/281,862, filed on Apr. 5, 2001.

(51) Int. Cl. A61C 5/14

(52) U.S. Cl. 433/136

(57) ABSTRACT

A rubber dam comprising a barrier membrane, an operative insert engaged to the sheet of barrier material and an integrally attached exterior frame to enable a dentist to isolate various portions of the dental alveolar arch. The rubber dam devices have integrally attached frames which eliminate the requirement of stretching the rubber dam membrane over an exterior frame which is a separate device. The rubber dams also have an integral operative insert imbedded within or attached to the interior of the barrier membrane. The operative inserts may function wholly within a single alveolar arch or alternatively may contact both alveolar arches simultaneously. The operative inserts may generally be any one of the four general classifications of elastic, malleable, resilient, and rigid or substantially rigid. The integrally attached exterior frames may be composed of elastic, malleable, resilient, or essentially rigid materials. The operative insert may be a separate entity from the integral frame, functioning independently from the frame, or alternatively the operative insert and integral frame may be directly attached in one or more locations and function as a single unit. The barrier membrane is usually an elastomeric material with a relatively high percentage of elongation, but alternatively may be composed of a foil or plastic or composite or water-proof paper or cardboard material which has physical characteristics of a low percentage of elongation. The rubber dams of this disclosure may be manufactured in flat configurations or alternatively may be three-dimensional dams. The operative inserts may have complete circumferential elements or alternatively may have abbreviated operative inserts. True rubber dams with exterior frame which retract the patient's lips 360 degrees as well as abbreviated rubber dam barrier deives are described. Rubber dams with more than one operative insert functioning simultaneously within a single dam, rubber dams of alternative material construction, and abbreviated intra-oral rubber dam devices employing the principles of design of the overall disclosure are disclosed.

This application is a continuation-in-part application of U.S. patent application Ser. No. 10/117,395, filed Apr. 5, 2002, which claims priority to Provisional Application Serial No. 60/281,862, filed Apr. 5, 2001.

### BACKGROUND OF THE INVENTION

1. Field of the Invention

The invention relates generally to dental rubber dams and more particularly to rubber dams with operative inserts and integrally attached external frameworks used for the purpose of isolating portions of the dental alveolar arch in order to retract tissues, control moisture, and maintain a dry field during dental treatment. Every embodiment of rubber dam disclosed herein has an operative insert generally at 14 which consists of a number of elements which form a perimeter around an operating site to isolate the operating site in a novel manner. Since the operative insert consists of the aggregate of a number of elements, an arrow points generally at the operative insert in the same manner in which an arrow points at each whole dam disclosed. In addition the embodiments disclosed are fabricated with an integral framework at the time of their manufacture which is labeled 16 and attached to the barrier membrane of the rubber dam alone or attached to the barrier membrane and also directly attached to the operative insert 14 at one or more locations labeled 15. The barrier membrane exterior to the operative insert is labeled 12 while the barrier membrane within the operative insert called the alveolar diaphragmatic membrane is generally labeled 19. In embodiments where an operating perimeter is incomplete, with some elements of the perimeter missing, and the barrier membrane exterior to the operative insert merges substantially with the barrier membrane interior to the operative insert, the resultant barrier membrane which serves more than one function, is hyphenated to reflect the combined function. In a few cases, exterior elements of the operative perimeter 14 are circumferentially fused with the exterior framework 16 at an extended circumferential attachment 15 to form a unitary structure. This unitary structure is either labeled with a hyphen to reflect the combined elements or structures, such as 58a-16, the fusing of a lower facial bow with the exterior frame or 58b-16, the fusing of the upper facial bow with the exterior frame. In other cases, such as the unitary dams where the intervening barrier membrane 12 exterior to the operative insert 14 is made of the same material and fused with both elements of the operative insert and exterior frame, is numbered generally at the locations where the fused functional elements are generally located according to the overall principles of construction of the dams. The dams depicted in graphic renderings generally have solid interior alveolar diaphragms labeled 19 to eliminate the complexity of different types of dams as presented in the cross-sectional representations of membranes of FIGS. 2 through 16, where details of the different types of membranes is addressed.

This disclosure is a continuation-in-part of the prior application originally entitled General Field Isolation Rubber Dam which was amended to the title: Rubber Dams With Operative Inserts Which Isolate Anatomical Structures by Effectively Resisting External Vector Forces of Displacement. The prior disclosure describes modified rubber dam membranes with operative inserts which facilitate unique alternative applications of the rubber dam in isolating the alveolar arch. Although most graphic depictions of the embodiments of rubber dams described in the parent disclosure are membranes without integrally applied frames, abundant references to this series of embodiments with integrally applied frames may be found throughout the discussion in the text, such as, but not limited to, the Summary of the Invention. “These devices generally fall into an outline of two different types of apparatus . . . the second type of field isolation rubber dam frames are integrally applied to the rubber dam in the process of its construction . . . generally, the types of integral frameworks may be of a malleable, resilient, or rigid material, made generally of metal or plastic or composite. They (rubber dams with integrally applied frames) are an important part of the proper application of the rubber dam technology to dentistry.” The integrally attached frames, in addition to being attached to the rubber dam membrane, may be integrally attached to the operative insert of a dam. References to this type of embodiment may be found on page 65, lines 5-7; “One type of intra-oral . . . rubber dam device will have an operative insert which integrally merges with a peripheral frame, and vice-versa”. Rubber dams with integrally attached frames may either be manufactured in flat configurations or alternatively as three-dimensional dams. References to the three-dimensionally fabricated dams having an integrally attached frame may be found one Page 45, lines 20-28; “The whole arch reciprocally retained rubber dam may be fabricated without an integral frame (or) another embodiment, the design of this rubber dam with an integral frame of either malleable, resilient, or rigid material, should be considered to be within the spirit and scope of this disclosure”. The geometric forms of bilateral and unilateral three-dimensional dams formed on dies or in molding forms are described within the text. The forms of whole-arch bilateral posterior dams are described on page 45, lines 1-6; “ . . . the reciprocal whole-arch rubber dam appliance must be molded on a three-dimensional die or molding element which is either a generally rounded wedge shape or a generally rounded pyramidal form, or a generally rounded conical form, with a centrally located concavity for forming a concave interior diaphragm relieving the impingement of excess rubber dam material into the patient's interior oral cavity.” The three-dimensional forms of anterior bilateral dams are disclosed on page 41, line 10-16; “Although the anterior (bilateral) resilient inter-arch dam may be manufactured in a flat form, it may also be manufactured on a three-dimensional die . . . . The molding die would be generally a rounded or a square-ended wedge-shaped form. No cut-out concavity needs to be fabricated into this dam, but it is not inconceivable that some clinicians may prefer this alternative embodiment”. The irregular, asymmetric forms of unilateral dams are described on page 8, lines 10-12; “The resultant form of the three-dimensionally stretched unilaterally retained dam is roughly an irregular pyramidal shape, which interacts with the intra-alveolar space in a generally acceptable manner”. A general reference to the resultant functional form of all rubber dams when they are actively applied in operating circumstances is described on page 2, lines 14-15; “the rubber dam, stretched from the intra-oral operative site to an external framework, creates a funnel-shaped barrier configuration”. The absolute requirement of a concave inner diaphragm for bilateral dams which extend posteriorly beyond the anterior half of the alveolar arch is described on page 7, lines 18-20; “ . . . a whole arch isolation technique that goes way back into the (intra-alveolar) space must have the concave diaphragm, but an isolation device which only seeks to isolate the anterior half of the alveolar arch generally will afford the patient enough space within the intra-alveolar space to accommodate his tongue and will also avoid the reflexive gag response”. Three-dimensional dams which behave like a foil are discussed; “The three-dimensional, fully contourable rubber dam with a mesh or solid planar malleable insert is an extension of the concept of the insertion of an operative insert” . . . “(which) allows the dam to be fully contoured in a similar manner as the action of a foil”. Field assembly of dams with operative inserts which are separate devices which are attached to a rubber dam membrane is described graphically in the provisional text and utility application, as are dams which have integrally attached operative inserts fabricated within the membrane at the time of manufacture. Abbreviated intra-oral dams applying the principles of the whole disclosure, which retract the patient's lips in less than a complete 360 degree manner like the full membrane dams is also described.

2. Background of the Prior Art

The rubber dam devices described in this patent disclosure as described in the prior disclosure: Rubber Dams With Operative Inserts Which Isolate Anatomical Structures by Effectively Resisting External Vector Forces of Displacement and are the direct descendants of the prior art of operational site isolation with the true flat-plane rubber dam. The rubber dams of this disclosure, as well as the prior disclosure, may be applied with the conventional technique of rubber dam usage, with the dental practitioner perforating the thin, flat sheet of rubber dam material with a series of holes corresponding to the number and configuration of teeth to be isolated. This technique isolates individual teeth sequentially and exposes the clinical crowns of the teeth only (the visible portion of the teeth above the gum line), which restricts the dentist primarily to procedures associated with the hard structures of the teeth above the gum line. Alternatively, the rubber dams of this disclosure may be perforated with a slit corresponding to the length of the portion of the alveolar arch to be isolated, which exposes both the teeth and the associated soft tissues and allows prosthetic procedures to be performed. In addition, a hybrid technique of utilizing both holes and a slit simultaneously is described. The devices described are true rubber dams and not barrier drapes, and are characterized by being actively stretched over anatomical structures, thereby creating internal tensile forces which interact with and serve to actively retract anatomical soft tissues such as the lips, cheeks, and tongue. The dams described in this continuation-in-part disclosure, as in the prior disclosure, are considered flat-plane rubber dams which are not pre-contoured to fit into every ‘nook-and-cranny’ of the interior oral cavity. True rubber dams which cover and retract the patient's lips in a complete circumferential manner are described, although alternative abbreviated intra-oral rubber dam devices, which retract less than 100% of the patient's lips are also within the spirit and scope of this disclosure, although they may not be specifically graphically depicted. Many of the dams disclosed are manufactured in a flat configuration, and then bent or formed by the end-user to a three-dimensional configuration, while other dams described are manufactured in a three-dimensional, multiplanar configuration, with or without subsequent bending by the end-user to conform to the desired end-configuration. None of these dams are pre-contoured to attempt to fit into every nuance of the oral cavity, as in the concept of a form fitting passive barrier drape of U.S. Pat. No. 5,078,604; by Oscar Malmin, Intra-oral Barrier Drape and Retention Device Thereof, since any attempt to anticipate and duplicate all of the anatomical variations of form of the human general population is an impossibility. All of the dams described, whether initially manufactured flat or in a standardized three-dimensional form, become stretched between the operative site and insert and the integrally attached frame when they are inserted into position in the oral cavity and interact with the soft tissues such as the lips and cheeks to retract these structures. The features of single or multiple-surface planar form, the stretching of the dams over anatomical soft tissue structures, and the generation of internal tensile stresses used for retraction of tissues and access to the operating site, qualify these devices as improvements upon the true prior art rubber dam.

An in-depth discussion of the ways in which a true rubber dam varies from an intra-oral barrier drape is addressed in the primary disclosure and will not be repeated here.

The Prior Art Introduction of Integral Frames in Rubber Dam Construction

The conventional prior art rubber dam in dentistry is composed of an elastic membrane generally 6″×6″ square of varying thickness for adults or a 5″×5″ square elastic membrane for pediatric applications. The prior art rubber dam is generally stretched over an external rubber dam frame which is a separate device from the rubber dam membrane itself. The rubber dam attaches to the frame by stretching the membrane over ‘nibs’ located around the periphery of the frame. In this type of prior art framework, reciprocal forces within the stretched membrane retain the dam to the framework.

The prior art also consists of rubber dams with integrally attached frameworks. In this type of embodiment, the rubber dam and frame are manufactured together as a single apparatus with the function of the integral frame roughly paralleling the function of the external rubber dam framework which is a separate device. The major limitation of dams with integrally attached frames is the inability of the clinician to variably retract the membrane. It should be noted that when a rubber dam with an integrally attached frame is placed in position in the mouth, the action of retracting the soft tissues of the lips and cheeks between the operating site and the framework actively stretches the membrane and generates internal tensile forces in the same manner as in the prior art rubber dam.

The patent literature lists a number of rubber dams with integrally attached frames which predominantly fall into the categories of malleable, resilient, or rigid material composition. All of these prior art dams, however, are conventional rubber dams with a simple membrane lacking an operative insert within the interior of the membrane which allows a specialized manner of clinical isolation of the operating site. The specialized operative inserts which modify the manner of isolating the dental operating site and are the subject of this disclosure differentiate the new types of rubber dams from all of the prior art rubber dams with integrally attached frames cited in the prior art literature. Some examples of prior art dams with integrally attached frames:

U.S. Pat. No. 4,721,465; Dental Dam With Integral Deformable Frame, issued Jan. 26^{th}, 1988 to Steven G. Barasz, discloses a plastic frame which can be bent to conform to the patient's face and retain its bent configuration during subsequent use of the dam. This integral frame is an example of a conventional rubber dam with a malleable integral frame. As clearly shown in FIG. 1 and FIG. 6, there is a simple membrane bordered by the frame on either three or four sides. No operative insert within the interior of the membrane is present which would provide a specialized method of clinical isolation. A clinician punches individual holes in this dam to isolate individual teeth sequentially in the conventional method of application of the dam.

U.S. Pat. No. 4,664,628; Screening Tool and Process Using the Tool For a Mouth Cavity in Dental Operations, issued May 12, 1987 to Giuseppe Totaro, discloses a dam which consists of an elastic sheet attached to a generally “U” shaped flexible frame which is said to allow adjustment of its shape. This frame is said to automatically perform liquid elimination in addition to framing the membrane. FIG. 1 clearly shows that within the confines of the exterior frame is a simple elastic membrane without a specialized operative insert. In addition, FIG. 3 shows a single tooth pulled through the membrane and clamped with a rubber dam clamp in the conventional application of the rubber dam. This dam is another example of a conventional rubber dam with an integrally attached malleable frame, which has no specialized operative insert within the interior of the membrane which functions to alter the method of clinical isolation.

On the contemporary U.S. market are two rubber dams with integrally applied frames, Handi-Dam and Quick Dam. Handi-Dam has an easily flexible plastic external frame with a plastic rod which maintains the dam in a convex configuration on one end. Quick Dam is another integrally applied frame with similar characteristics. Both dams have plastic frames with some characteristics of resiliency. Neither of these prior art dams have an operative insert in the interior of the membrane which allows the rubber dam to isolate a segment or quadrant in an alternative manner to a conventional rubber dam. These products are simply conventional rubber dams with integrally applied external frames which are not patented and have no references in the patent literature.

European patent disclosure EP 1 348 396 by Kilcher, De Rolo, and Aschman, describes both flat dams and three-dimensional dams of foil composition with pre-fabricated elevated projections anticipating the diameter and position of location of a series of teeth in a quadrant, segment, or whole alveolar arch. The concept is one of allowing individual holes to be opened of in a dam by cutting off the projections with a scissors, rather than punching holes in a flat dam with a rubber dam punch in order to prepare a rubber dam for conventional isolation of teeth. Unlike latex or other elastomeric materials, foil does not have an ability to effectively stretch to varying diameters to accommodate varying diameters of teeth in the spectrum of the human population. A foil shears easily and cannot be flossed between the contacts of teeth without tearing. In addition, the position of teeth cannot be anticipated in the whole population in a pre-configured dam. There is no mention of general field isolation of teeth with the dams presented. The bilateral whole arch dam of FIGS. 5 and 6 which would contact both the upper and lower alveolar arches simultaneously, has 14 projections for the isolation of an entire arch of teeth back to the second molars. This whole arch dam, generally resembling a ‘top hat’ or a thimble, has a flat-plane boundary located posterior to the second molar region which would completely obliterate the intra-alveolar space (the lingual space) and thus cause the patient to gag, choke, and reject the dam, thus causing failure of the dam clinically. The three-dimensional dams presented in this disclosure do not have any specific mechanisms for the resistance of inter-arch pressures in a manner which would prevent these dams from being easily crushed by or effectively retained by inter-arch forces. Both the unilateral and bilateral dams have contour lines in order to graphically display the three-dimensional forms of the dams, but these lines are not numbered or described in any way as structural elements which fulfill a specific function and impart efficacious functional qualities to the dams. A rubber dam frame which is a separate device and is not integrally attached to the dam is described.

Anatomical Features Facilitating Access to the Alveolar Arch by Retraction of the Lips and Cheeks

Nature has imbued the human animal with an ability to completely expose the front teeth as a threatening gesture to warn predators of impending danger and attack. ‘Baring of the teeth’ has evolved through millions of years as an effective and universally understood warning signal of mammals during the sympathetic ‘flight or fright’ fear and aggression response. At the opposite spectrum of human emotion, the ‘whole-hearted’ human smile as a friendly greeting response elicits the same significant degree of exposure of the human teeth. In each response, the coordinated effect of facial musculature retracts either one or both lips cervically, while retracting the mouth in the regions of the cheeks posteriorly (or distally, if one's perspective is a dental reference). During an extreme facial gesture, the complete flexure of the facial musculature assigned to retraction of the lips is accompanied by a complete relaxation of the orbicularis oris muscle, allowing the lips to stretch to their maximal relaxed circumference. Although human variability exists, at the extreme of human expression approximately all of the teeth in the anterior half of both of the alveolar arches, up to the distal surface of the second premolars or mesial surface of the first molars may be exposed if the mandibular teeth are occluding with the maxillary teeth. This degree of exposure of the anterior teeth is not easily attained when the mouth is in an opened position as in the circumstance of dental treatment being rendered. However, with the mouth in an opened position, the circumference of the lips still allows bilateral isolation of at least one anterior segment of teeth, usually as far posterior as the first or second premolar region. Alternatively, if a single arch is to isolated unilaterally, the same circumferential length of the lips generally allows the isolation of a quadrant of teeth, at least as far posteriorly as the first molar. These features of human anatomy make it possible to design oral retraction devices which simultaneously retract the lips and cheeks in an efficacious manner for either bilateral anterior or unilateral posterior isolation purposes. In many cases, retraction devices which are designed and produced in a flat configuration and have a planar posterior design component when flexed or folded, may be manufactured by high volume, low cost production methods. The rubber dam which is manufactured in a flat configuration is then flexed or folded into a three-dimensional configuration by the end-user. Of course, it is also possible to design three-dimensional rubber dams or retraction devices, but at a higher production cost. Both flat configuration, two-dimensional devices and also three-dimensional devices are deascribed and are considered to be within the spirit and scope of this disclosure.

### SUMMARY OF THE INVENTION

This continuation-in-part of a previous disclosure consists of a series of modified rubber dams with operative inserts and integrally attached frameworks described previously which allow unique alternative methods of isolation with rubber dams constructed with integral frames to enable a dentist to efficiently and effectively isolate various portions of the dental alveolar arch. As discussed in the primary disclosure Rubber Dams With Operative Inserts Which Isolate Anatomical Structures by Effectively Resisting External Vector Forces of Displacement, this series of rubber dams have an integral operative insert and integral framework imbedded within or attached to a barrier membrane in order to modify the manner in which a proposed operative dental site is isolated. An integrally attached exterior frame precludes the requirement of stretching the rubber dam membrane over an exterior frame which is a separate device. Dams with integral frames were described in the text of the previous disclosures, but only a few graphic illustrations were provided in the prior disclosures. The operative inserts of the dams discussed in this disclosure were specified in the primary disclosures as being composed generally of any one of the four general classifications of elastic, malleable (or capable of undergoing plastic deformation), resilient (at least to an elastic limit), and rigid or substantially rigid. The integrally attached exterior frames may also be composed of elastic, malleable, resilient (at least to an elastic limit), or essentially rigid materials. There are two general types of configurations of dams with integral frames: those in which the operative insert is a separate entity from the integral frame, attached only indirectly through the barrier membrane and functioning independently from the frame, or alternatively those in which the operative insert and integral frame are directly attached in one or more locations and function as a single unit. The barrier membrane may be an elastomeric membrane selected from a variety of different polymeric materials with a high percentage of elongation, such as latex, neoprene, polyurethane, nitrile, vinyl, silicone, or other materials, or alternatively may be of a malleable foil composition, or of a plastic or composite polymeric composition with a low percentage of elongation. These rubber dams may be applied with conventional isolation techniques relying on the perforation of individual holes in the rubber dam membrane and the individual isolation of the clinical crowns of teeth, or alternatively may be applied with a slit-like central opening to isolate groups of teeth at a time, a technique called general field isolation in the prior art. A hybrid type of isolation composed of both conventional and field isolation is also discussed. The dams may be manufactured with a solid operative membrane, requiring the end-user to choose the type of isolation method he desires and then punching hole perforations or cutting a slit for the application, or alternatively, the dams may be manufactured with central openings provided, allowing a rapid application of the dam without end-user input into preparation of the dam. Completely consistent with the primary disclosure, integral barrier adhesives may be applied to the membrane or alternatively mechanisms may be provided for the manual application of barrier adhesives. The dams with integrally applied frames may either be intra-arch dams, with an operative insert functioning wholly within a single alveolar arch, or alternatively may be inter-arch dams which interact with both of the opposing alveolar arches simultaneously. The addition of integral frames to the dams described in the primary disclosure in some cases allows dams to be manufactured in a flat configuration and then modified by the end-user into a three-dimensional form, while in other cases requires the dams may be manufactured on multi-planar or three-dimensional die or mold forms. Whether the dam is a simple flat-plane dam or a multiplanar dam, none of the dams described are pre-contoured to attempt to mimic all of the anatomy of oral structures, but rely instead on an interaction of the materials of the dams with with the hard and soft tissues of the oral cavity. Operative inserts which attach to an external frame in alignment with the midpoint of symmetry the horizontal elements of dams, as well as operative inserts which attach in alignment with the midpoint of the vertical side elements of a dam are discussed. Some discussion of oblique attachments is included.

Although graphic renderings in this disclosure show only selected bilateral and unilateral configurations of operative inserts, alternative configurations of operative inserts which anticipate the isolation of various sizes and configurations of proposed operative sites, from openings as small as 2-3 teeth, to segments, to quadrants, ¾ arch, and entire alveolar arch designs are within the spirit and scope of this disclosure. In general, all the variations of rubber dams described in the primary disclosure apply equally to the rubber dam devices with integral frames of this disclosure, whether the intended application is for general field isolation, conventional isolation, or the hybrid type of isolation described in the primary disclosure.

Rubber dams utilizing more than one operative insert constructed within a single dam, dams of alternative material construction, and dams with abbreviated operative inserts are presented. Although true rubber dams which retract the patient's lips in a complete 360 degree circumferential manner are emphasized as the major embodiments throughout the disclosure, abbreviated intra-oral dams which retract the lips less than 360 degrees are also disclosed.

### BRIEF DESCRIPTION OF THE DRAWINGS

FIG. 1 is an isometric view of an intra-arch dam with an anterior operative insert and an integrally attached framework.

FIG. 2 is a cross-sectional view of FIG. 1 taken along line 2-2, showing an operative insert and an exterior integral frame with a core of material in each case molded within the elastomeric material of the membrane.

FIG. 3 is a cross sectional view of a general field isolation rubber dam wherein a central opening has been formed in the membrane within the operative insert of the dam and an integral frame has been attached to the exterior of the membrane rather than being molded within the membrane.

FIG. 4a is an isometric view of a general field isolation rubber dam wherein a fabric or mesh material is provided for use with a manually applied barrier material and the operative insert and exterior integral frame is molded into the exterior periphery of the dam.

FIG. 4b is a cross-sectional view of FIG. 4a taken along line 4b-4b.

FIG. 5 is a cross-sectional view of a general field isolation rubber dam with a central opening wherein a fabric or mesh material has been applied to the inner flange of the membrane.

FIG. 6 is a cross-sectional view corresponding to FIG. 3, wherein an adhesive and a peel strip have been added to the inner flange to facilitate bonding of the dam inside of the patient's mouth.

FIG. 7 is a cross-sectional view of a general field isolation dam with an integrally molded external framework wherein the operative insert extends interiorly of the inner periphery of the membrane, in this case with a central opening provided.

FIG. 8 is a cross sectional view of an alternative embodiment wherein the operative insert is composed wholly of elastomeric material and the exterior peripheral frame has a core of material molded within the elastomeric membrane material.

FIG. 9 is a cross sectional view of a general field isolation rubber dam with an elastic operative insert as shown in FIG. 8 wherein an adhesive and peel strip have been added to facilitate bonding of the dam inside of a patient's mouth.

FIG. 10 is a cross-sectional view of an alternative embodiment of a general field isolation rubber dam with both the operative insert and the exterior peripheral frame attached to the outside of the membrane rather than imbedded within the elastomeric material.

FIG. 11 is a cross-sectional view of FIG. 10 with a fabric or mesh material is applied to the membrane interiorly to the operative insert.

FIG. 12 is a cross-sectional view corresponding to FIG. 10 wherein an adhesive and peel strip have been added to the membrane to facilitate bonding of the dam inside a patient's mouth.

FIG. 13 is a cross-sectional view corresponding to FIG. 10, wherein a malleable sheet has been applied to the membrane interiorly to the operative insert.

FIG. 14 is a cross-sectional view corresponding to FIG. 10, wherein a continuous malleable sheet molded within elastomeric material replaces the purely elastomeric rubber dam membrane.

FIG. 15 is a cross-sectional view corresponding to FIG. 14, wherein a discontinuous malleable sheet replaces the elastomeric rubber dam membrane.

FIG. 16 is a cross-sectional view of a general field isolation rubber dam with an integrally attached operative insert and framework, wherein the operative insert is a single discontinuous element.

FIG. 17a demonstrates that a rubber dam with an integrally attached frame and an operative insert with a solid interior membrane may be punched with a series of individual holes in the conventional method of application of a rubber dam; or a slit for general field isolation 17b, or both holes and a slit in a hybrid application of conventional and field isolation 17c.

FIG. 18a through 18h demonstrates the sequence of steps of bending the anterior malleable operative insert of a general field isolation rubber dam with an integrally attached frame and applying the dam intra-orally in the mouth of a patient.

FIG. 19a through 19h demonstrates the sequence of steps of bending a posterior malleable operative insert of a general field isolation rubber dam with an integrally attached frame and applying the dam intra-orally in the mouth of a patient.

FIG. 20a is an isometric view an intra-arch rubber dam with an operative insert 14 and integrally attached frame 16 attached to each other at location 15, while FIG. 20b shows the flexed exterior frame applying vector forces (arrows) against the patient's upper and lower alveolar arches.

FIG. 21a is an isometric view of an inter-arch rubber dam with an inter-arch operative insert 14 and integrally attached frame 16 attached to each other at locations 15. FIG. 21b shows the flexed exterior frame applying reciprocally opposing vector forces (arrows) against the patient's upper and lower alveolar arches.

FIG. 22a shows a front view and a cross-sectional view of a dam in which a bilateral anterior inter-arch operative insert attaches to the external frame at the midpoint of the horizontal elements of the frame in a generally anterior position.

FIG. 22b shows a front view and a cross-sectional view of a bilateral operative insert which attaches to the vertical side members of a frame in a generally posterior position.

FIG. 22c shows a front view and a cross-sectional view of a unilateral dam generally at 72 with an operative insert 14 which attaches to an external frame 16 to the left (patient's right) of the midline attachment 15 of the horizontal elements of the frame in an oblique method of attachment. An oblique attachment is any attachment which is not located in a generally symmetrical manner at the midpoint of either the horizontal elements or vertical side elements of adam.

FIG. 22d shows a front view and a cross-sectional view of the same type of dam shown in FIG. 22a, but with more rigid rectilinear bends made at the junction of the posterior transverse arches and the lingual bows. FIG. 22a, FIG. 22b, and FIG. 22c show a casual rounded flexure of the operative inserts 15 which results in a rounded “U” form of flexure, while FIG. 22d shows a rigid rectilinear bending of the elements, resulting generally in a square “U” form of bending. Note that there is a distinct upper bending axis 26u at the junction of the upper transverse arch 25a and upper lingual bow 60a, and also a distinct lower bending axis 26l at the junction of the lower transverse arch 25b and lower lingual bow 60b. Interposed between the two bending axes 26u and 26l, the vertical inter-occlusal distance is spanned by the inter-occlusal linking element 40 and the vertical distance between the lingual bows 60a and 60b and the occlusal biting surfaces of the teeth is spanned by the upper and lower transverse arches 25a and 25b.

FIG. 23a through 23e shows a solid membrane anterior bilateral inter-arch rubber dam generally at 11 with an integrally attached frame 16 attached to an operative insert 14 at locations 15, which is manufactured in a flat configuration. FIG. 23a shows the flat dam in an isometric view, FIG. 23b shows the flat dam being flexed into a rounded “U” shape, FIG. 23c Shows a clinician punching individual holes in the operative diaphragmatic membrane for a conventional isolation technique, FIG. 23d shows conventional isolation of a mandibular anterior segment, FIG. 23e shows isolation of a maxillary anterior segment.

FIG. 24a through 24e shows a three-dimensional bilateral anterior inter-arch dam with an integrally attached frame 16 attached to an operative insert 14 at locations 15. The dam depicted is manufactured in a three-dimensional form with either a flat interior membrane 13 or a concave interior diaphragm membrane 17 for isolating anterior segments primarily or isolation extending back to the posterior border of the anterior half of an alveolar arch (approximately the 1^{st} or 2^{nd} premolar area). FIG. 24a is a front view, FIG. 24b shows an isometric view of a dam from the back with a concave interior membrane 17, FIG. 25c shows an isometric view of a dam from the back, demonstrating a flat inner membrane 13, FIG. 25d shows isolation of an upper anterior segment with the dam, FIG. 24e shows isolation of a lower anterior segment.

FIG. 25a through 25e shows a three-dimensional bilateral inter-arch rubber dam for whole arch isolation with an integrally attached exterior framework 16 connected to an operative insert 14 at locations 15 and a concave inner diaphragm membrane 17 which accommodates intra-alveolar space and the patient's tongue and swallowing reflexes and allows an entire arch of teeth to be isolated. FIG. 25a is a front view, FIG. 25b is a top view, FIG. 25c is an isometric view of the dam from the back demonstrating the concave inner diaphragm membrane 17, FIG. 24d shows isolation of an upper arch, FIG. 25e shows isolation of a lower arch.

FIG. 26a through 26f shows a unilateral posterior inter-arch rubber dam manufactured as a flat two-dimensional dam with an integrally attached exterior framework 16 attached at upper and lower locations 15a and 15b to a unilateral inter-arch operative insert generally at 14. FIG. 26a is an isometric view of the flat dam as supplied by the manufacturer, FIG. 26b shows the flat dam being flexed into a rounded “U” configuration, FIG. 26c shows the clinician bending the anterior transverse arches at their bending axes, FIG. 26d shows a clinician punching individual holes 70 in the lower operative membrane 19 with a standard rubber dam punch 40 for a conventional application of the dam, FIG. 26e shows the dam isolating a lower left mandibular posterior quadrant, while FIG. 26f shows an upper right posterior quadrant being isolated.

FIG. 27a through 27e shows a three-dimensional unilateral posterior inter-arch rubber dam generally at 42 with an integrally attached exterior framework 16 attached at upper and lower locations 15a and 15b to a unilateral inter-arch operative insert generally at 14. FIG. 27a is a front view, FIG. 27b is a top view, FIG. 27c is an isometric view of the dam from the back, demonstrating its asymmetrical truncated pyramidal or conical form, FIG. 27d shows the dam isolating a lower left mandibular posterior quadrant, FIG. 27e shows an upper right posterior quadrant being isolated.

FIG. 28a shows a specialized intra-arch rubber dam with an operative insert with “T” shaped projection 20 for attaching the dam directly to soft tissues by suturing in order to isolate an edentulous segment for an implant 42 prosthetic application. FIG. 28b shows the same dam with a quick-disconnect rubber dam tissue clamp 90 being applied to the “T” shaped projection 20 for the same prosthetic implant 42 application. FIG. 28c shows a unilateral posterior inter-arch rubber dam isolating an edentulous posterior quadrant for implant 42 prosthetic procedures, while 28d shows a bilateral anterior inter-arch dam isolating an edentulous anterior segment with implants 42 placed for prosthetic reconstruction.

FIG. 29a and 29b show two configurations of an abbreviated inter-arch rubber dam devices with inter-arch operative inserts 14 integrally attached to external resilient frame members 16 at attachment locations 15, 29a representing a bilateral dam while 29b disclosing a unilateral dam. The drawing shows that these dams do not have a rubber dam membrane which completely circumferentially retracts the patient's lips. FIG. 29a is an anterior abbreviated dam generally at 41, while FIG. 29b is a posterior quadrant abbreviated dam generally at 42.

FIGS. 30a through 30d show a type of abbreviated dam generally at 51 with an anterior operative insert generally at 14 circumferentially connected (represented by the line of connection 15) to a circumferential frame 16. This configuration of dam extends the concept of the operative insert to the complete function of an external dam. FIG. 30a is an isometric view of the dam manufactured in a flat configuration. This dam can be manufactured in a three-dimensional configuration also (not shown). FIG. 30b shows the dam being flexed into a rounded “U” shape, FIG. 30c shows holes being punched in the dam for conventional application, FIG. 30d shows the dam isolating a mandibular anterior segment. In FIG. 30e, generally at 52, the outer perimeter of the operative insert, including the facial bows 58a and 58b are fully incorporated into the design of the dam as the exterior frame, now represented as 58a-16 and 58b-16. This slightly altered dam is isolating a maxillary anterior segment. Although this is a type of abbreviated dam, this dam completely retracts the patient's lips and cheeks in a complete circumferential manner with the frame remaining 100% outside of the patient's mouth during use.

FIG. 31a shows an isometric view of a flat dam and FIG. 31b shows the application view of the dam generally at 61 with an abbreviated bilateral anterior operative insert generally at 14 attached bilaterally at locations 15 where cheek retraction extensions 41 join to the circumferential frame 16. In this dam, the operative insert 14 is abbreviated with the facial bows missing, but the corresponding diaphragmatic alveolar membrane extends outwardly like a peripheral membrane to the exterior frame of the dam 16.

FIG. 32a shows an isometric view of an alternative embodiment of the flat dam and FIG. 32b shows an application view of the dam generally at 62 with an abbreviated bilateral anterior operative insert generally at 14 attached bilaterally at locations 15 where cheek retraction extensions 41 join to the circumferential frame 16. In this dam, the facial bow is replaced by facial projections 58a and 58c. The lingual bows 60a and 60b are present, as are the reciprocal posterior transverse archs 25, but the diaphragmatic alveolar membrane extends outwardly like a peripheral membrane to the exterior frame of the dam 16.

FIG. 33a shows an isometric view of yet another alternative embodiment and FIG. 33b shows the application view of a dam generally at 63 with an abbreviated bilateral operative insert generally at 14 attached bilaterally at locations 15 where cheek retraction extensions 41 join to the circumferential frame 16 and also at the midpoints of symmetry of the horizontal elements of the dam. In this dam, the lingual 60 bows are completely intact, but the facial bow segments 58a and 58b become lip retracting elements. The reciprocal upper and lower posterior transverse arches 25 separated by the inter-occlusal linking elements are present bilaterally. A side portion of the facial bow elements 58a and 58b are missing bilaterally.

FIGS. 34a through 34f show the embodiment of a dam with an abbreviated operative inserts of FIGS. 31a and 31b generally at 61 with cheek extensions 41 joining the operative insert 14 at locations 15 bilaterally to the exterior frame 16. In these graphic renderings, the dams is being prepared for conventional isolation of an anterior segment of teeth. FIG. 34a is an isometric view of the flat dam generally at 61, FIG. 34b shows the dam flexed into a rounded “U” shape, FIG. 34c shows the dam placed into the mouth, positioned, and marked where teeth are to be isolated, FIG. 34d shows holes being punched with a rubber dam punch where marks have been made to bring teeth through the membrane, FIG. 34e shows a front view of the dam in place isolating a lower anterior segment of teeth, while FIG. 34f shows a side view of the dam isolating the lower anterior teeth, demonstrating that the cheeks are retracted posteriorly by the cheek retracting elements 41 while a dentist performs dental treatment procedures.

FIGS. 38a through 38b show three-dimensional views of inter-arch dams with operative inserts 14 with cheek retracting elements 41 linked to external frames 16 in alignment with the midpoint of the vertical side members of the external frames. FIG. 38a is a posterior isometric view of an inter-arch bilateral anterior isolation dam generally at 71 with an operative insert generally at 14, manufactured as a three-dimensional dam with a flat inner membrane 13. FIG. 38b is a posterior isometric view of an inter-arch bilateral anterior isolation dam generally at 72 with an operative insert generally at 14, manufactured as a three-dimensional dam with a concave inner diaphragmatic membrane 17. FIG. 38c is a posterior isometric view of an inter-arch bilateral whole arch or posterior isolation dam generally at 73 with an operative insert generally at 14, manufactured as a three-dimensional dam with a concave inner diaphragmatic membrane 17. FIG. 38d is a posterior isometric view of an inter-arch unilateral posterior isolation dam generally at 74 with an operative insert generally at 14, manufactured as a three-dimensional dam.

FIG. 39a is a posterior isometric view of a three-dimensional intra-arch dam generally at 81 with an anterior bilateral intra-arch operative insert generally at 14 and a flat posterior inter-occlusal membrane 13, FIG. 39b is a posterior isometric view of a three-dimensional intra-arch dam generally at 82 with an anterior bilateral intra-arch operative insert generally at 14 and a concave posterior inter-occlusal membrane 17, FIG. 39c is a posterior isometric view of a three-dimensional intra-arch dam generally at 83 with a posterior bilateral intra-arch operative insert generally at 14, and 39d is a posterior isometric view of a unilateral intra-arch dam generally at 84 with a unilateral intra-arch operative insert generally at 14. All of these three-dimensional dams have their intra-arch operative inserts 14 integrally attached at 14 to an external frame 16. Alternatively the inserts may also be attached only to the barrier membrane of the dam. All of these dams are classified as intra-arch dams because their operative inserts contact one arch only.

FIG. 40a and 40b demonstrates the occasional application of rubber dam clamps 64 to supplement retention of an inter-arch dam. Although this type of dam is generally retained by reciprocal inter-arch forces of the patient's musculature, in a few cases supplementary rubber dam clamps may provide adjunctive retention. Also demonstrated is the insertion of a saliva ejector 48 and a supplementary air exchange tube 46 that always need to be applied whenever any inter-arch dam or three-dimensional intra-arch dam is utilized for isolation purposes. Although many patients will be comfortable breathing through their nose alone when these dams are applied, placement of a breathing tube is indicated in every circumstance of application of these dams.

### DETAILED DESCRIPTION OF PREFERRED EMBODIMENTS

### Applications of the Embodiments

Solid Membrane Dams

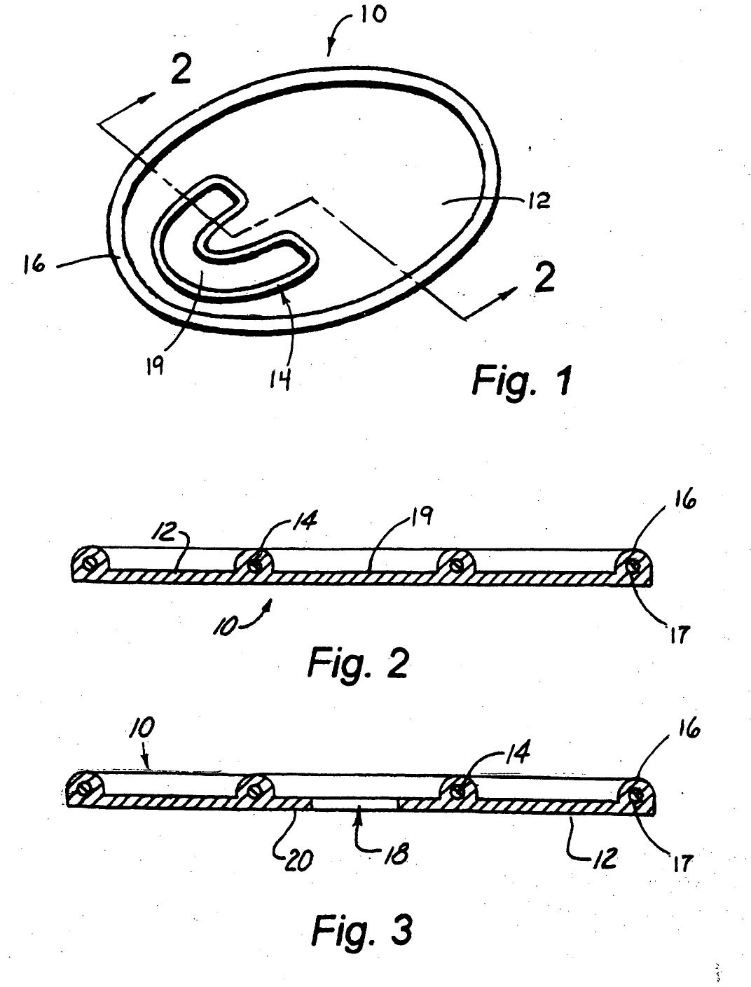

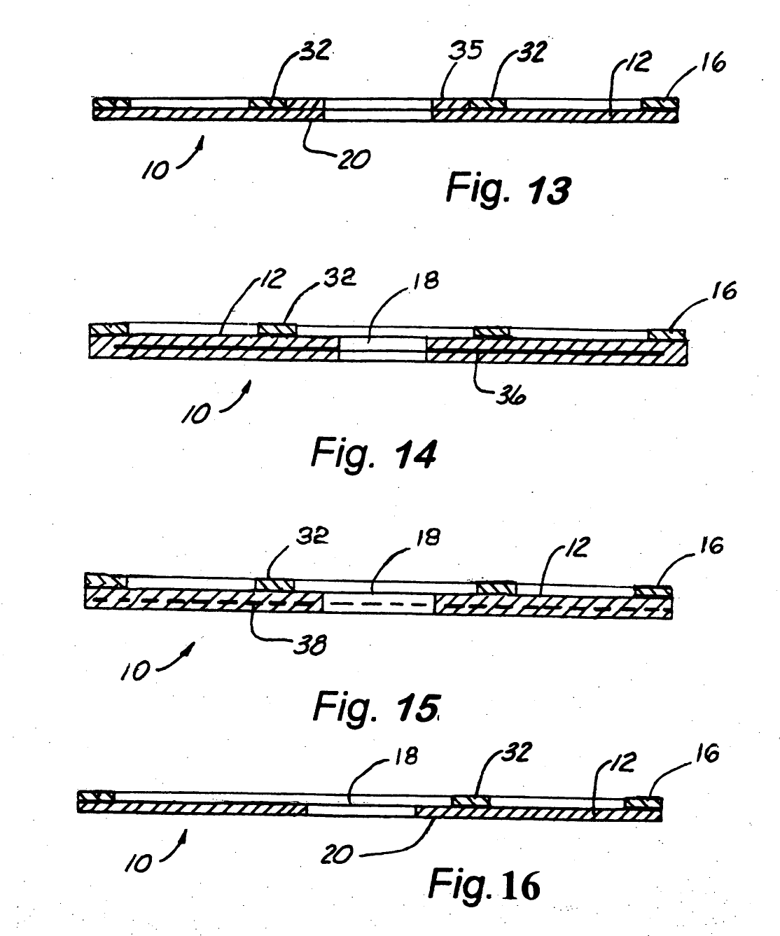

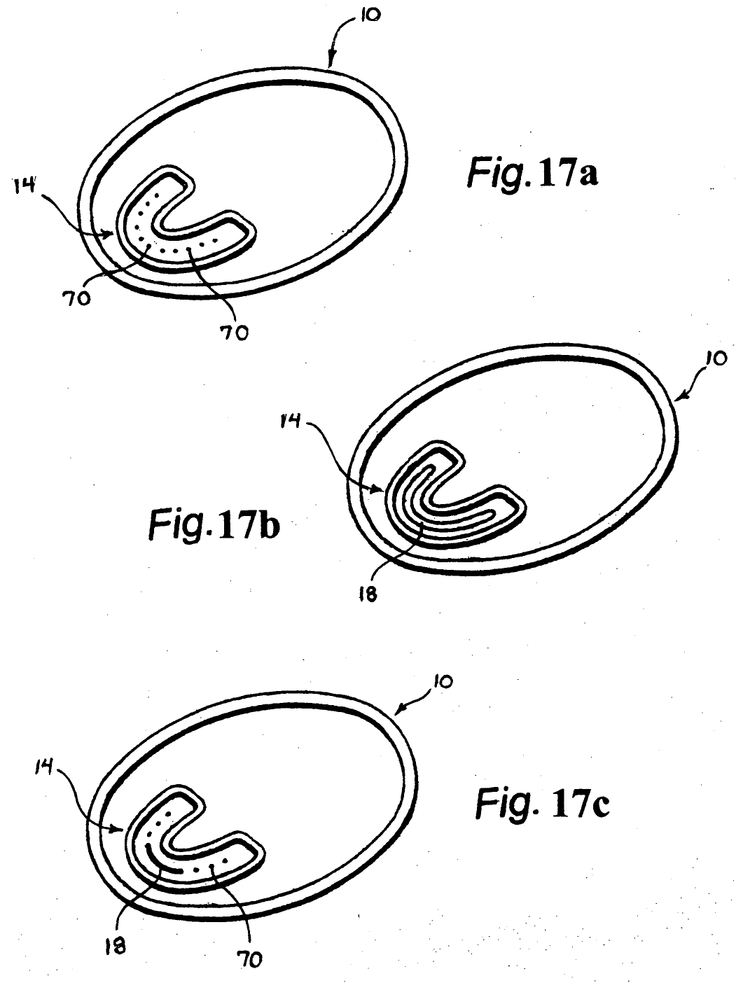

As shown in FIG. 1 and in cross-section in FIG. 2 generally at 10, rubber dams with solid membranes 19 interiorly of the operative insert 14, may be customized by the clinician. As shown in FIG. 17a, a clinician may punch individual holes 70 for conventional isolation of teeth or alternatively as shown in FIG. 1 7b, slits 18 may be punched with specialized rubber dam punches for general field isolation applications, or both holes 70 and slits 18 may be punched simultaneously in a hybrid application of both conventional and field isolation. Also as shown in cross-section in FIG. 2, the integral framework 17 may be molded within the membrane to form the integral frame 16 in the same manner as the operative insert 14. The operative insert 14 lies in the interior of the rubber dam membrane 12, while the integral frame 16, borders the exterior periphery of the membrane. Alternatively, any embodiment of dam may have an operative insert 14 and an integral frame 16 which is attached to the outside of the membrane rather than being molded within it. FIGS. 10 through FIG. 16 show inserts and frames attached to the outside of the rubber dam membrane. FIG. 6 shows an embodiment of a solid membrane dam with an elastomeric operative insert 14 and an integral frame 17 molded into a thickness of the elastomeric membrane 16. Although not shown specifically, the same solid membrane dam may be fabricated with insert and frame attached to the outside of the membrane.

B. Latex or Polymer Membrane Only Flange

A general field isolation rubber dam with an elastomeric inner flange 20 encircling a central opening 18 as shown in FIG. 3 may be used alone without any barrier material or subsequent to the application of an adhesive followed by a manually applied barrier material which adheres to the membrane by the applied adhesive, or alternatively by the application of any barrier material with an integrally applied adhesive composition within the barrier material itself.

C. A General Field Isolation Rubber Dam with Fabric or Synthetic Mesh Material for Application of Manually Applied Non-Adhesive Barrier Materials

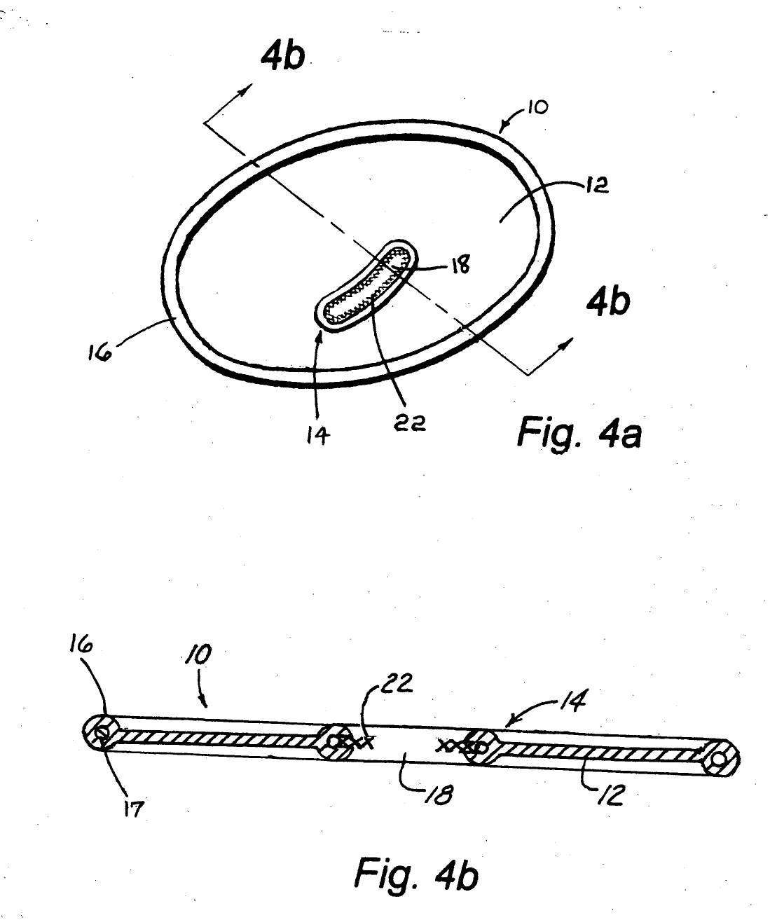

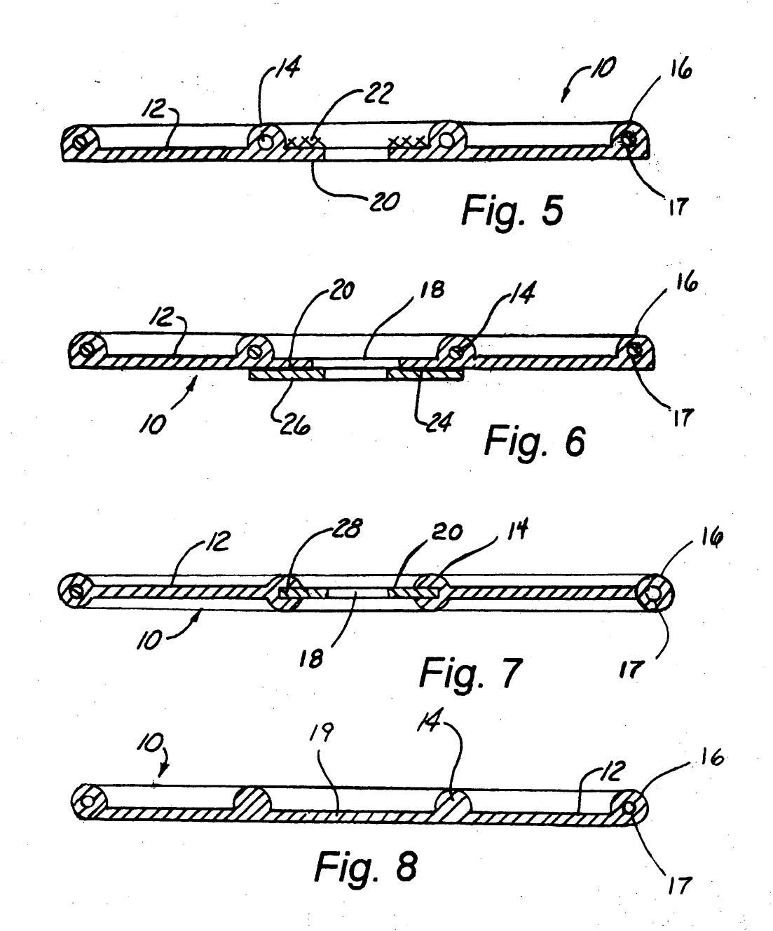

Illustrated in FIG. 4a, generally at 10, and shown in cross-section in FIG. 4b is a general field isolation rubber dam with fabric or synthetic mesh material for application of manually applied non-adhesive barrier materials, including an elastic membrane 12 showing the square outer perimeter of the membrane 12, and an oblong or elliptical open area 18 in a central area of the membrane 12. The outer perimeter of the opening 18 is bordered by a fabric or synthetic mesh material 22 approximately 2.5 to 3.0 millimeters in thickness, following the opening 18 all the way around the periphery with an unseen amount of the material 22 securely embedded in the rubber material of the membrane 12. Adjacent to the mesh material 22 in an outer direction from the internal opening is a raised thickened section of elastic material which is 2.0 to 3.0 millimeters in width and extends all the way around the periphery of the opening 18. Located within the thickened section of the membrane 14 is a malleable, dead-soft wire loop embedded in the membrane 12 which allows the operator maximum flexibility to create a three-dimensional operative work site in order to isolate multiple teeth and their associated soft tissues. Around the outer circumference of the membrane is a thickened section of the membrane with an integrally molded wire, plastic, or composite inner core material which may either be of a malleable, resilient, or rigid composition. FIG. 5 shows an alternative embodiment of a fabric mesh material 22 attached to the inner flange 20 projecting inward from the operative insert 14 and surrounding the central opening 18. These embodiments of the general field isolation rubber dam 10 allows the clinician to manually apply a liquid, putty, gel, or paste elastomeric material as a barrier material to create a moisture proof seal around the periphery of the operative perimeter of the general field isolation rubber dam 10 without the need for the application of adhesive to bond the polymeric barrier material to the dam 10. The barrier material used needs only to have properties of adequate wetting and flow of the barrier material into the fabric mesh 22, in order to lock the fully polymerized material into the microscopic retentive fibers of the mesh material 22. This design allows quite a number of different chemical compositions of polymeric materials to be used with this dam in creating a moisture proof seal at the interface between the dam and the tissues to be isolated. This dam is not to be used without an applied barrier material.

D. The General Field Isolation Rubber Dam With an Integrally Applied Mucosal Tissue Adhesive

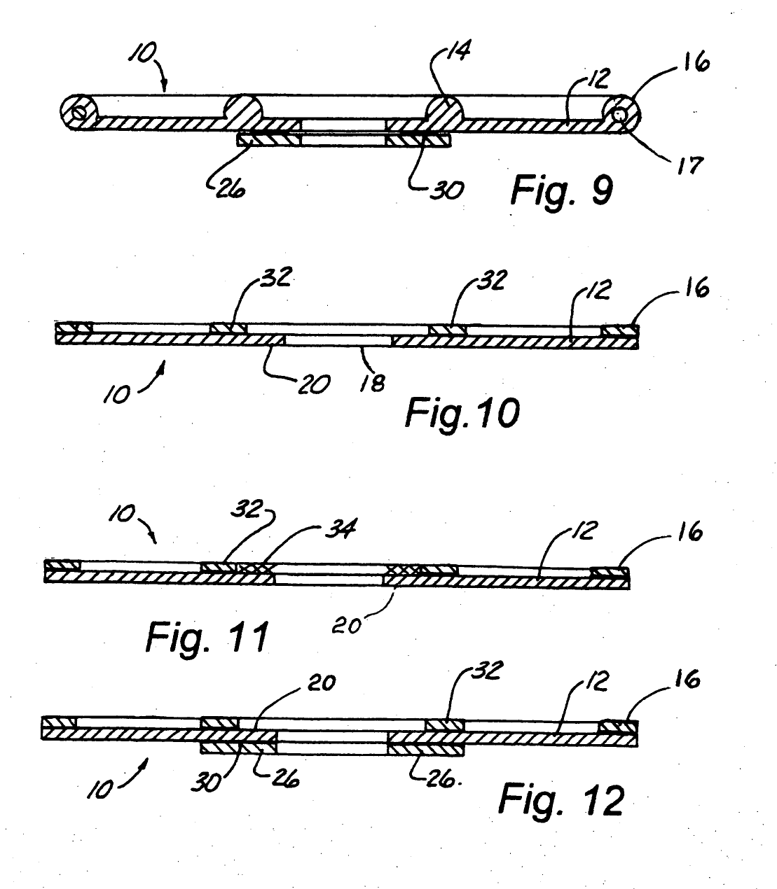

Another embodiment is a general field isolation rubber dam with a latex inner border and a pre-applied mucosal tissue adhesive to bond the latex membrane directly to the hard and soft intra-oral dental tissues as shown in FIG. 6. Integrally applied tissue adhesives are described in detail under the section pressure sensitive adhesives or non-pressure sensitive adhesives. In the embodiment shown in FIG. 6, an integral adhesive 24 is applied circumferentially around the central opening 18 on the tissue side of the inner flange 20. The integrally applied adhesive 24 is covered by a release liner 26 to keep it in a tacky state until application. Alternatively, an integrally applied adhesive may be applied to the operative side of the membrane in order to attach a manually applied barrier material to the dam to perfect the moisture seal around the periphery of an operating site. FIG. 6 shows this embodiment with an operative insert which may either be malleable, resilient, or rigid, while FIG. 9 shows this embodiment with an operative insert which is elastic.

E. The General Field Isolation Dam With Extensions of the Operative Insert Projecting From the Operative Insert Within the Membrane

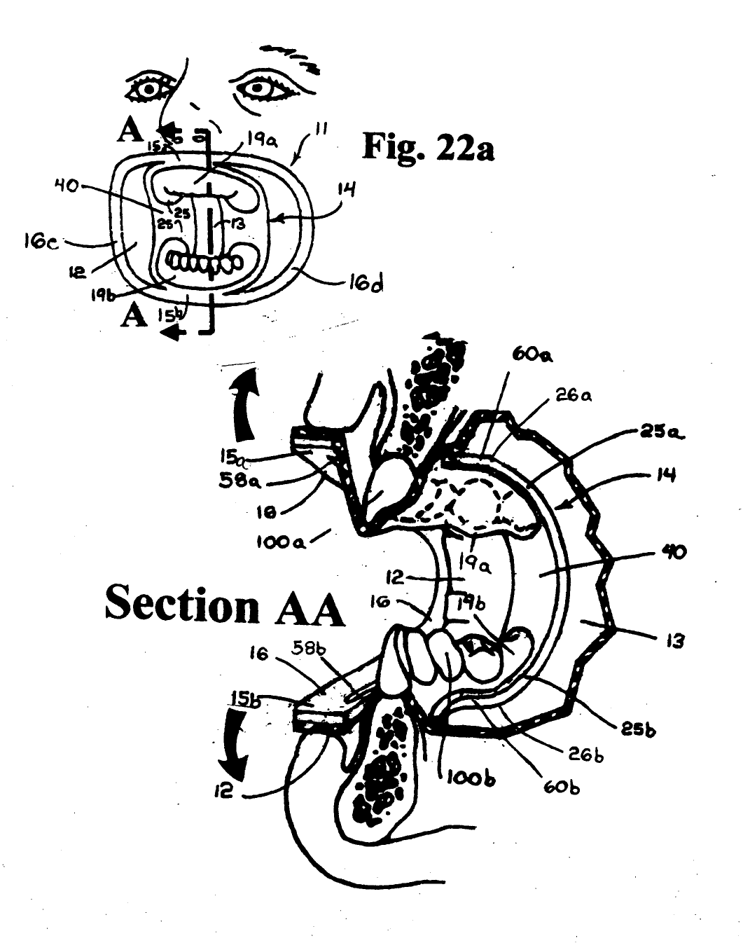

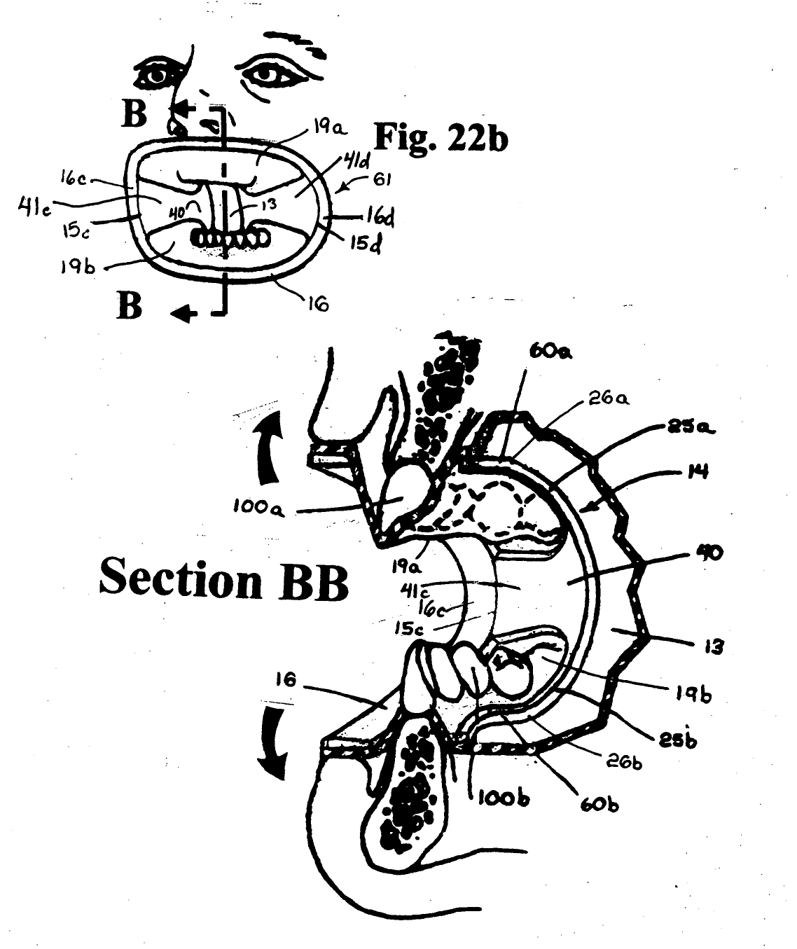

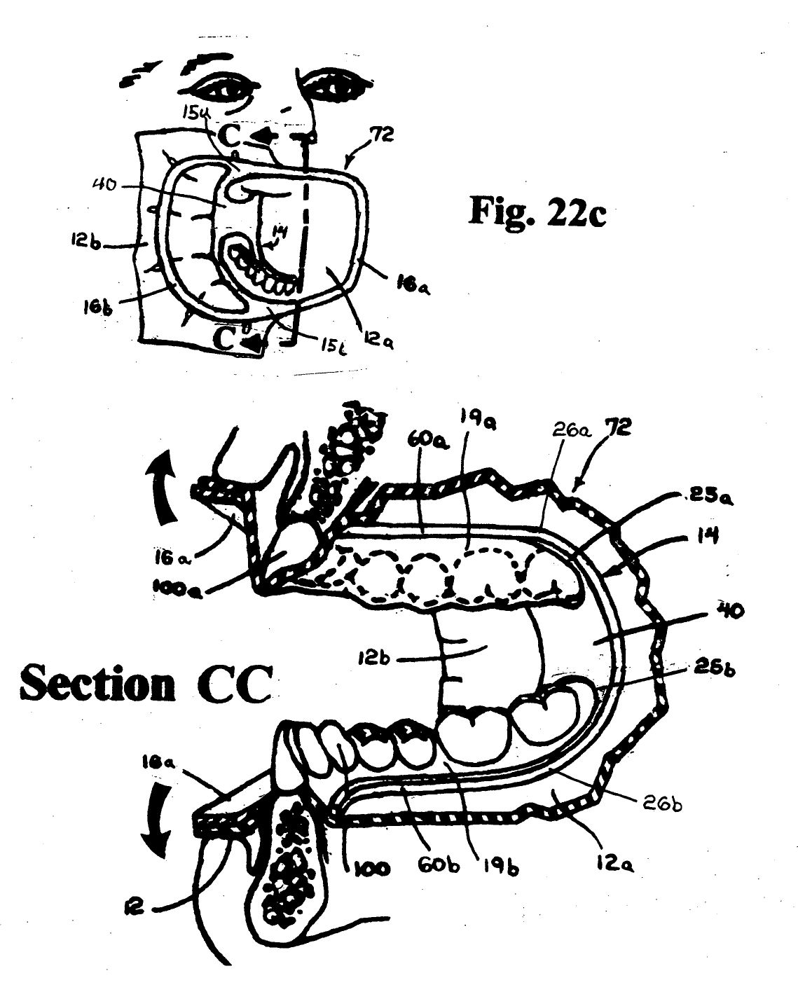

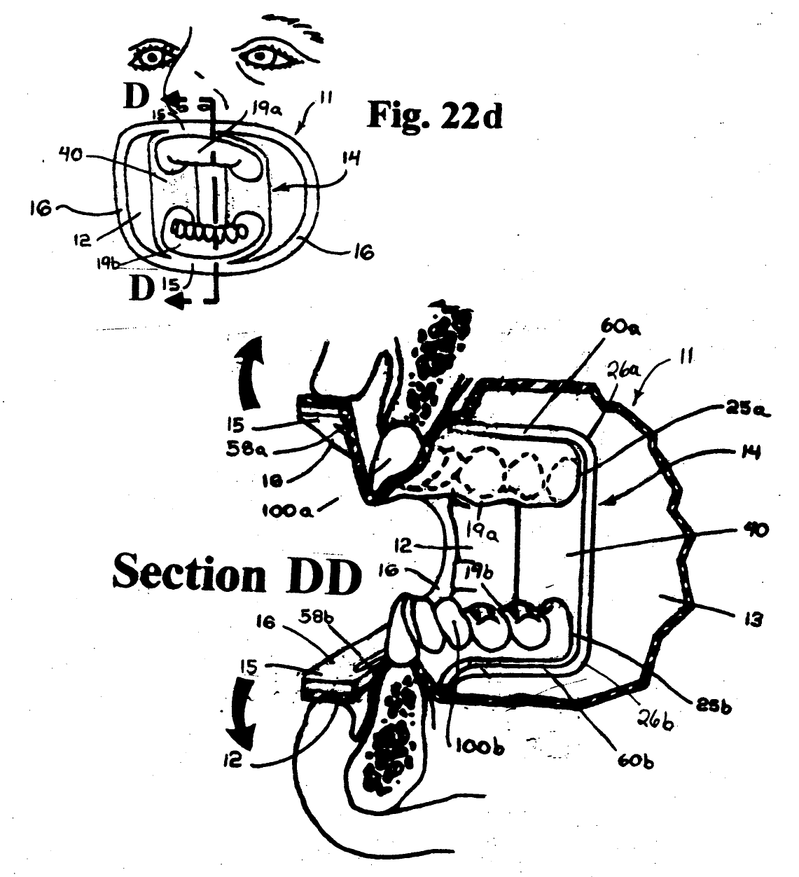

As shown in FIG. 7, generally at 10, a general field isolation rubber dam may have an operative insert 28 with projections 20 extending outside of the elastomeric material into the central opening 18 for varying purposes. One application is the use of localized projections to attach the dam directly to alveolar tissues. As shown in FIG. 22a, a localized “T” shaped projection 20 allows a clinician to suture a rubber dam directly to soft tissues in order to isolate an edentulous area of the alveolar arch which has previously had implants placed in preparation for prosthetic crowns to be constructed to restore an otherwise distal edentulous arch segment. A conventional rubber dam clamp 66 anchors this dam in the anterior of the alveolar arch. FIG. 22b shows the same dam being attached directly to soft tissues with the aid of a quick-release rubber dam tissue clamp 90 with a flexible shaft. This device, which is always attached directly over the alveolar process to fibrous tissue in a location away from the lingual and buccal nerve, allows both a rapid attachment mechanism for the dam and also a quick release mechanism to remove the dam as needed. Another example of a localized a projection of the operative insert which emerges from the dam and the operative insert in a direction perpendicular to the plane of the elastomeric membrane, provides an attachment mechanism for the direct attachment of a rubber dam clamp to the rubber dam. This embodiment is not shown in graphic depiction.

Alternatively a generalized projection of a malleable operative insert in the form of a circumferential malleable flange 20 around the central opening 18 is an example of a generalized projection of the operative insert which allows the dam interiorly of the operative insert to act like a foil to adapt three-dimensionally to the circumference of an operating site. A generalized projection of this malleable foil may alternatively project outwardly from the operative insert to form a foil exterior membrane with an elastomeric inner membrane, or both inwardly and outwardly from the insert to form an entirely foil dam.

### Intra-arch Rubber Dams With Integrally Attached External Frameworks

Anterior Intra-arch Dams With Integrally Attached External Frames

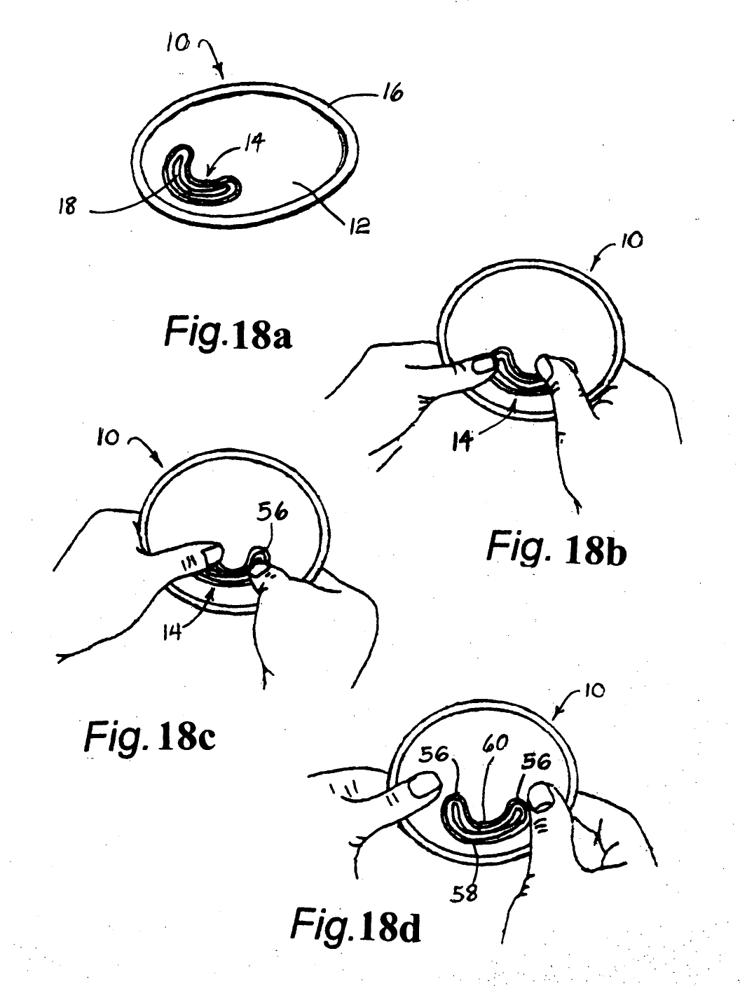

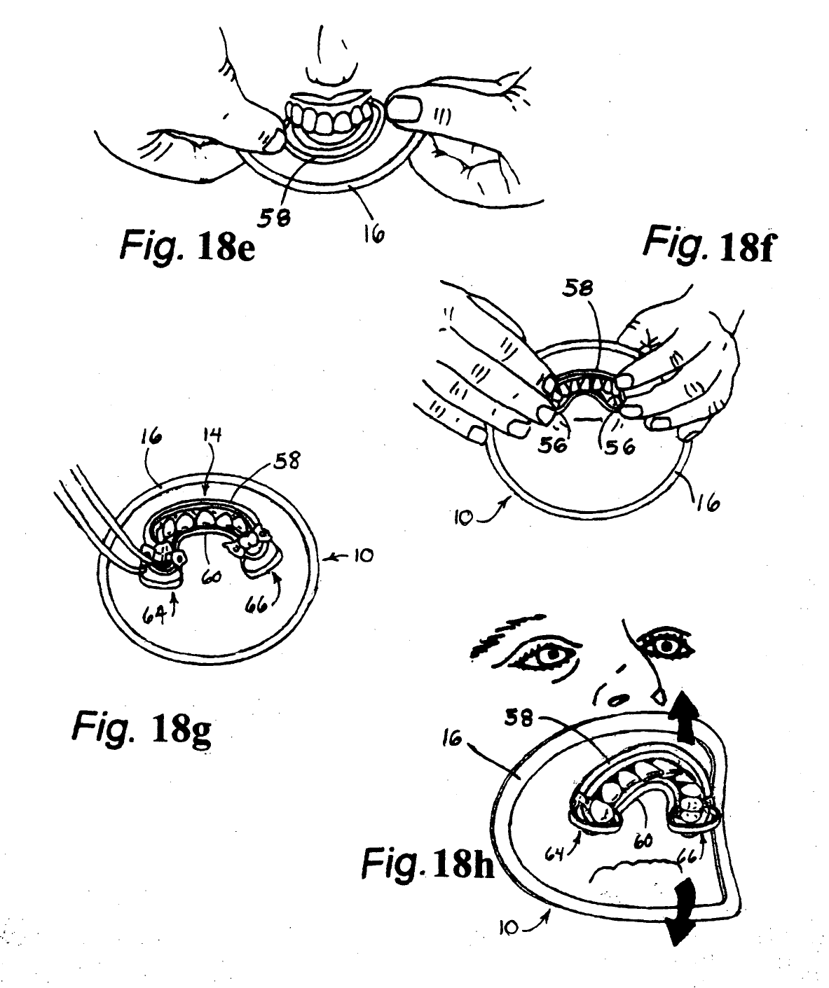

As shown in FIG. 18a through 18h, anterior intra-arch field isolation dams with integral frames generally are configured in the same manner as their counterparts without integrally applied frames. FIG. 18a shows a dam which has a bilaterally symmetrical anterior operative insert 14 with a central opening 18, placed within the elastomeric membrane 12 near the outer perimeter of the dam, with an integral frame 16 enclosing the circumference of the rubber dam. In the sequence of configuring the dam for an application, first one end of the operative insert is bent at a 45 degree angle to the plane of the dam as shown in FIG. 18b. This forms a transverse arch 56 attached at one end of a facial bow 58 and a lingual bow. Next, as shown in FIG. 18c, the other end of the operative insert is bent similarly to form a second transverse arch which completes a perimeter of two transverse arches 56 linking a facial or labial bow 58 and a lingual bow 60 as shown in FIG. 18d. The whole dam is aligned with the anterior segment of teeth as shown in FIG. 18e. The facial bow is seated first as shown in FIG. 18f, while pressure is applied symmetrically backward, stretching the rubber dam membrane from the integral frame 16 to the operative insert, with the greatest stretching occurring at the most posterior location of the bilateral posterior transverse arches 56. With the dam seated in position and retained temporarily with finger pressure, first one rubber dam clamp 66 is applied and then a second rubber dam clamp 64 is applied as shown in FIG. 18g. The complete application is shown in FIG. 18h. The resilient frame, having been flexed from its initial flat configuration to essentially an open “U” or rounded “V” shaped form, exerts a reciprocal force against both the lower mandibular arch (lower arrow) and the upper maxillary arch (upper arrow) in the anterior segments, thereby opposing the forces applied to the dam in the process of retracting the patient's lips. This stabilizes the facial bow 58 of the dam as well as the whole anterior operative insert. The configuration of dam shown in the sequence of steps 18a through 18h shows an operative insert and an integral frame which are separated by a rubber dam membrane. With an operative insert which is separated from the external frame, the insert may be manufactured from a malleable material for maximum adaptability around the operative perimeter, while the quality of resilience of the frame is utilized to apply reciprocal force to the facial bow of the operative insert to retract it cervically and maintain it in position. Conventional rubber dam clamps will suffice to secure this embodiment reasonably well, although the use of specialized cervical retraction clamps will contribute to the overall stability of isolation with this device.

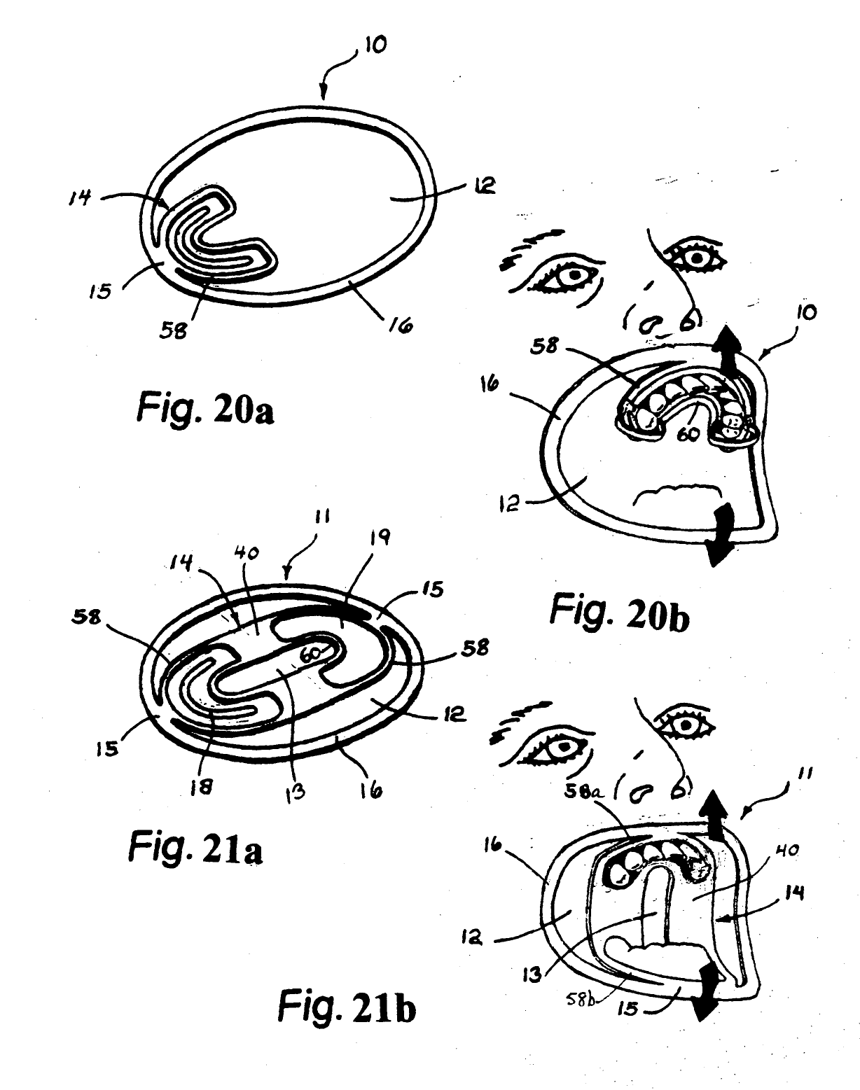

Alternatively, as shown in FIG. 20a and 20b, an anterior operative insert 14 may be directly connected to the external integral frame 16 at the midpoint of symmetry 15 of the insert. The embodiment allows a more direct transmission of force from the external frame 16 to the labial bow of the insert and allows the operative insert and frame to be injection molded or otherwise manufactured as a single device from a single material, thereby decreasing manufacturing costs and steps. If a resilient material is utilized, the operative insert will have less adaptability around the operating site, but the external frame will generate more reciprocal force. If a malleable material is used for both the insert and frame, the insert will retain its maximum adaptability around the site, but the external frame will generate less reciprocal force.

In this embodiment, the use of specialized cervical retraction clamps to retract the facial bow of the operative insert is indicated to retract the facial bow of the insert.

Posterior Intra-arch Dams With Integrally Attached External Frames

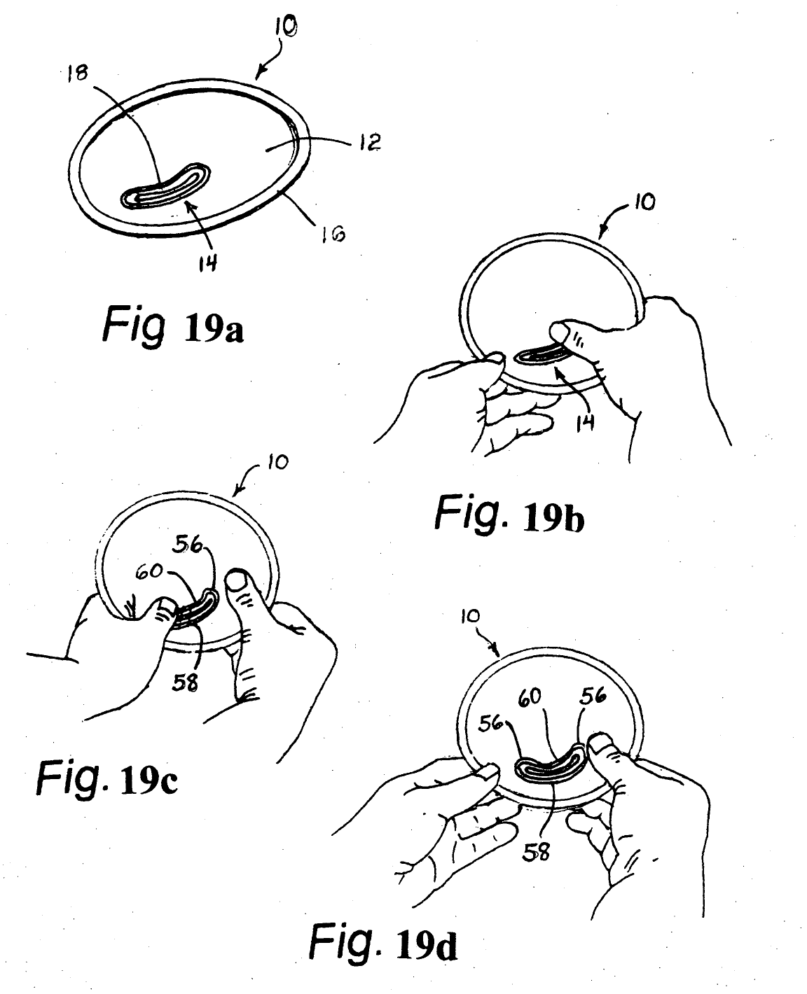

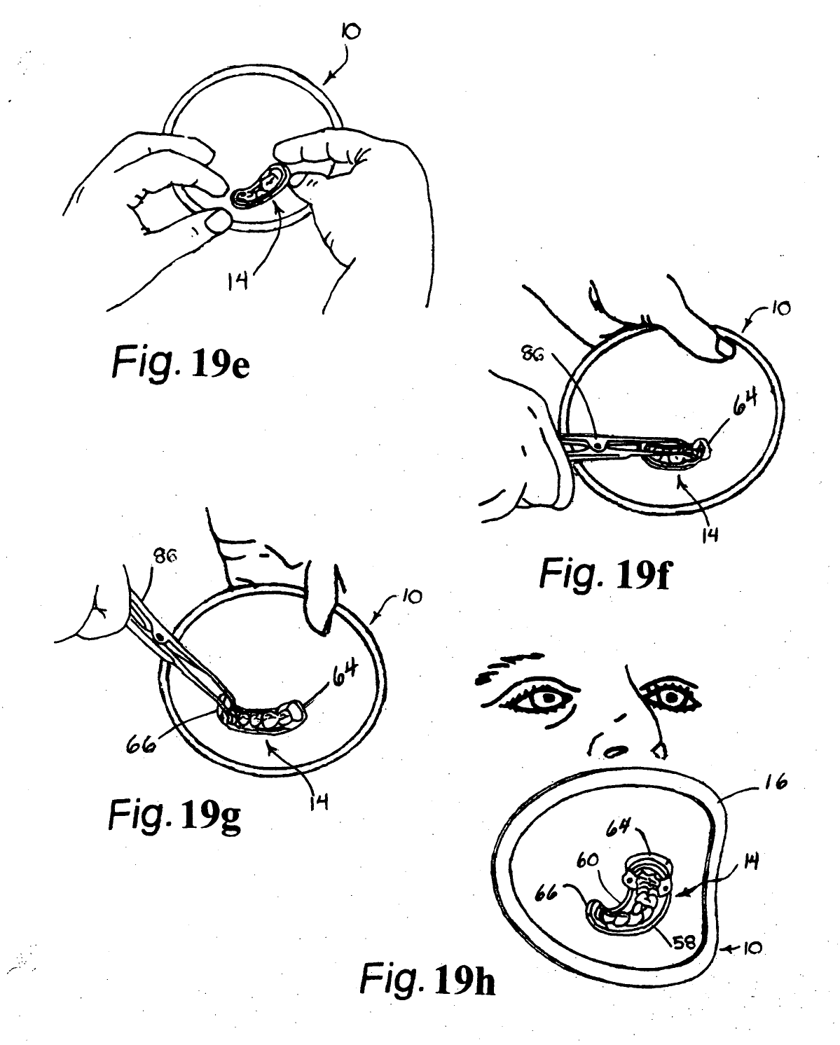

FIGS. 19a through FIG. 19h demonstrate the sequence of steps for the application of a posterior general field isolation rubber dam with an integrally applied external frame.

As shown in FIG. 19a through 19h, posterior intra-arch field isolation dams with integral frames generally are configured in the same manner as their counterparts without integrally applied frames. FIG. 19a shows a dam which has a unilateral posterior operative insert 14 with a central opening 18, placed within the elastomeric membrane 12 near the outer perimeter of the dam, with an integral frame 16 enclosing the circumference of the rubber dam. In the sequence of configuring the dam for an application, first one end of the operative insert is bent at a 45 degree angle to the plane of the dam as shown in FIG. 19b. This forms a transverse arch 56 attached at one end of a facial bow 58 and a lingual bow. Next, as shown in FIG. 19c, the other end of the operative insert is bent similarly to form a second transverse arch which completes a perimeter of two transverse arches 56 linking a facial or labial bow 58 and a lingual bow 60 as shown in FIG. 19d. The whole dam is aligned with the posterior segment of teeth as shown in FIG. 19e and the whole perimeter is forced distally to the most posterior tooth in the quadrant. Pressure is applied to retain the perimeter in position, stretching the rubber dam membrane from the integral frame 16 to the operative insert, with the greatest stretching occurring at the most posterior location of the perimeter at the posterior transverse arch 56. With the dam seated in position and retained temporarily with finger pressure, first one rubber dam clamp 64 is applied and then a second rubber dam clamp 66 is applied as shown in FIG. 19g. The complete application is shown in FIG. 19h. The configuration of dam shown in the sequence of steps 19a through 19h shows an operative insert and an in membrane. With an operative insert which is separated from the external frame, the insert may be manufactured from a malleable material for maximum adaptability around the operative perimeter, while a resilient material may be utilized for the outer peripheral frame. Conventional rubber dam clamps will suffice to secure this embodiment reasonably well, although the use of specialized cervical retraction clamps may be utilized to contribute to the overall stability of isolation with this device.

Alternatively, a posterior operative insert may be directly connected to an external integral frame near the location of the anterior transverse arch. This application is not shown in graphic representation. This serves to apply force from the exterior frame in the anterior portion of the quadrant which may be used to replace the need for an anterior applied rubber dam clamp. It also allows the operative insert and frame to be injection molded or otherwise manufactured as a single device from a single material, thereby decreasing manufacturing costs and steps. If a resilient material is utilized, the operative insert will have less adaptability around the operating site, but the external frame will generate more reciprocal force. If a malleable material is used for both the insert and frame, the insert will retain its maximum adaptability around the site, but the external frame will generate less cervical retraction force in the anterior area. In this embodiment, the use of specialized cervical retraction clamps to retract the facial bow of the operative insert is indicated to retract the facial bow of the insert.

### Methods of Isolation of Edentulous and Partially Edentulous Alveolar Arch Segments for Implant Prosthetics Procedures, Utilizing Specialized Intra-arch and Inter-arch Rubber Dams

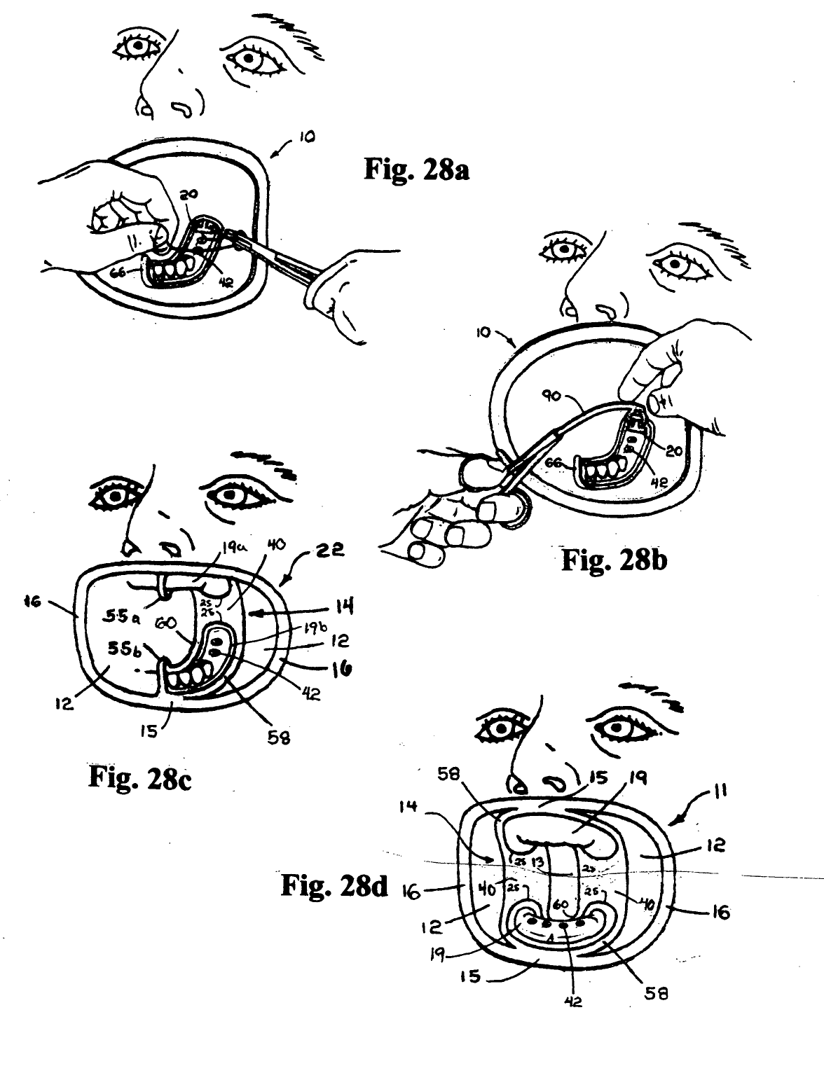

As shown in FIG. 7 embodiments of intra-arch rubber dams with attachment mechanisms emerging as extensions 20 from operative inserts which project externally from the elastomeric material, allow rubber dam clamps or retaining devices to attach the dams directly to soft tissues in edentulous areas where intact teeth are not present. In FIG. 7 the extensions of the operative insert 20 extend inwardly from the operative perimeter 14 into the central opening 18. In another embodiment, a specialized projection which emerges from the operative insert at a 90 degree angle to the plane of the elastomeric membrane (not shown graphically). These specialized “T” shaped projections may be utilized by the clinician to suture or otherwise attach with a quick release tissue clamp the rubber dam directly to soft tissues in order to isolate edentulous segments of the alveolar arch. FIG. 28a shows this embodiment of a specialized rubber dam being sutured in place to isolate a distal edentulous segment for implant prosthetics, while a conventional rubber dam clamp 66 anchors this dam anteriorly. FIG. 28b shows the same dam being attached directly to soft tissues with the aid of a quick-release rubber dam tissue clamp 90 with a flexible shaft. This device, which is always attached directly over the alveolar process on fibrous tissue in a location remote from the lingual and buccal nerve, allows both a rapid attachment mechanism for the dam and also a quick release mechanism to remove the dam quickly as needed. This type of dam is useful for completing prosthetics procedures where implants have been placed in preparation for prosthetic crowns to be constructed to restore an otherwise distal edentulous arch segment.

Inter-arch dams also serve to isolate edentulous alveolar arch segments. As shown in FIG. 28c, a unilateral inter-arch dam prepared for general field isolation may also serve to isolate the distal edentulous segment or quadrant, by utilizing reciprocal forces of the patient's musculature transmitted through the upper and lower alveolar arches. FIG. 28d shows an anterior edentulous segment with implants 42 placed previously, now awaiting the prosthetic phase of reconstruction of the missing teeth. Although implant prosthetic reconstruction has served as an example of the use of these dams in edentulous areas, other procedures may also be performed on edentulous quadrants or segments.

### The Essential Design Elements of Inter-arch Operative Inserts

Analysis of Components the Inter-arch Operative Insert as an Extension of Intra-arch Inserts;

There are essential design requirements for intra-arch and inter-arch operative inserts, and all elements of construction of the operative inserts contribute to the device functioning properly while isolating an alveolar arch or any portion of an alveolar arch. In understanding the design rationale for the inter-arch dams, one must first acknowledge the design elements of the intra-arch operative inserts and recognize that they form a basis for the extrapolation of design of these components to inter-arch applications.

Design Elements of an Intra-arch Operative Insert

The four elements of an intra-arch operative insert; with two transverse arches alternating with and connecting to a facial bow and a lingual bow in order to form a circumferential operative perimeter. If an intra-arch operative insert is constructed to isolate a unilateral portion of an alveolar arch, as in FIG. 19d, one transverse arch 56 is termed a posterior transverse arch and the other transverse arch 56 is termed an anterior transverse arch. These transverse arches alternate with and connect to a facial bow 58 and a lingual bow 60 to form a circumferential operative perimeter. If an intra-arch insert isolates bilaterally, such as an anterior segment operative insert shown in FIG. 18d, both transverse arches 56, 56 are termed posterior transverse arches since they both occupy positions posterior to the facial bow 58 and the lingual bow 60.

Design Elements of an Inter-arch Operative Insert:

All of the design elements of an inter-arch operative insert except one are directly analogous to the design elements of the intra-arch operative inserts. Since the inter-arch operative insert contacts portions of both the upper and lower alveolar arches at the same time, each reciprocal part of the operative insert usually has the same four elements of design of an intra-arch insert. The inter-arch operative insert can be viewed as being analogous to two reciprocally opposing intra-arch inserts, each contacting an alveolar arch and linked by an intervening inter-occlusal linking element(s). The inter-occlusal linking elements spans the distance between the upper and lower alveolar arches when the patient has his/her mouth open during treatment. All reciprocally opposing parts of the insert must be linked by this intervening design element in order to accommodates to the dimension of the patient's opened mouth and also in order to transmit reciprocal inter-arch opposing forces to both alveolar arches simultaneously.

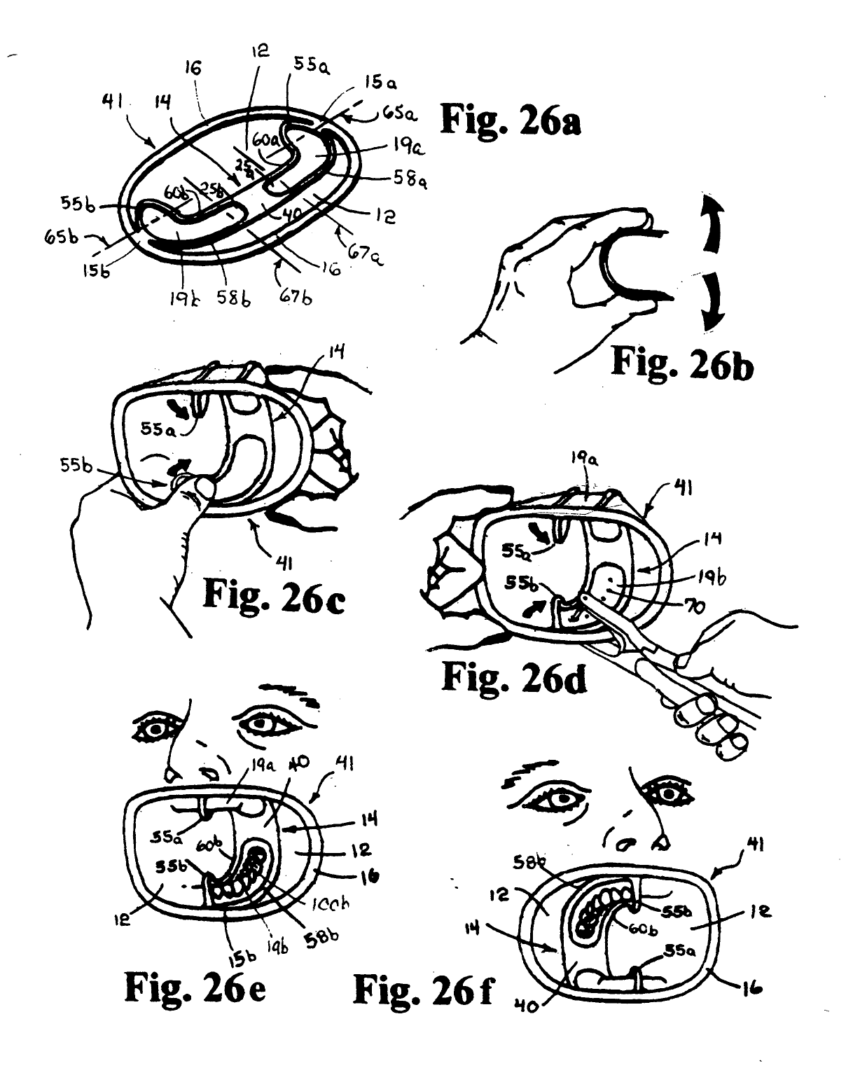

If an inter-arch operative insert 14 is a unilateral insert as is shown in FIG. 26a, elements of the insert directly contacting the upper arch and forming a circumferential perimeter are: an upper posterior transverse arch 25a, an upper anterior transverse arch 55a, an upper lingual bow 60a, and an upper facial bow 58a. Elements of the insert directly contacting the lower arch are a lower posterior transverse arch 25b, a lower anterior transverse arch 55b, a lower lingual bow 60b, and a lower facial bow 58b. Spanning the distance between the upper and lower teeth and connecting all upper and lower circumferential design elements is an inter-occlusal linking element 40, located between the upper and lower posterior transverse arches, 25a and 25b.

Each element of design of the inter-arch operative insert 14 has one or more specialized functions which contribute to a properly functioning and efficacious isolation device. When the operative insert is functionally bent into component elements, the posterior transverse arches 25a & b span the vertical distance between the int-occlusal linking element 40 and the facial 58a & b and lingual 60a & b bows. They also serve to transmit force between these elements to retract the facial and lingual bows cervically and to generate friction between the rubber dam membrane and alveolar arch to retain the dam in position. The anterior transverse arch 55 connects the anterior end of the facial bow 58 and the lingual bow 60 to complete the circumferential operative perimeter in the anterior portion of each arch. In FIG. 26d, the lower 19b diaphragmatic alveolar rubber dam membrane is punched with holes for the conventional isolation of the clinical crowns of the teeth. Alternatively, a central slit opening may be prepared for general field isolation in order to bring the teeth and soft tissues through the membrane and into the operating field. As shown in FIG. 26e, the diaphragmatic membrane 19a of the reciprocating side of the insert, contacting the opposite alveolar arch where teeth are not being isolated, is left intact without an opening. With the expansive force as demonstrated by the flexure of the dam in FIG. 26b (arrows show equal and opposite reciprocal forces ) of the operative insert flexed against both alveolar arches, the upper teeth 100a cradling within the upper alveolar diaphragmatic membrane 19a which centers and stabilizes the insert over this alveolar arch and generates frictional retentive forces which stabilize the operative insert and the dam. The lower diaphragmatic membrane 19b in the arch where the teeth 100b are isolated not only serves to bring the teeth into the operating field, but also to cradle the lower alveolar arch within the membrane, centering the insert over this alveolar arch and further stabilizing the operative insert, while stretching the rubber dam membrane, generating frictional and mechanical retentive forces.

### Inter-arch Rubber Dams with Operative Inserts Attached Directly to the External Frame

Anterior Attachment:

FIG. 22a shows a front view and a cross-sectional view of a dam generally at 11 with a bilateral anterior inter-arch operative insert 14 showing the fundamental design elements of an inter-arch operative insert attached anteriorly to an external frame, which is flexed into a generally rounded “U” shape and conventionally isolates the mandibular anterior half of an alveolar arch of teeth 100b to the first premolar region. Since the anterior bilateral inter-arch dams have a flat inner membrane 13, they can only be applied posteriorly to the posterior boundary of the anterior half of the alveolar arch, which is approximately the first or second premolar region, without intolerably violating the intra-alveolar space and causing the dam to be rejected by the patient. This cross sectional view shows the dam being stabilized by ‘cradling’ of the reciprocal maxillary alveolar arch quadrant of teeth 100a in the upper alveolar diaphragmatic membrane 19a and the mandibular alveolar arch of teeth 100b, with the mandibular teeth exposed through holes prepared in the lower diaphragmatic alveolar membrane 19b to conventionally isolate the lower anterior teeth. The operative insert 14 of this type of dam attaches to the exterior frame 16 in an upper anterior location 15a and a lower anterior location 15b.

Posterior Attachment

FIG. 22b shows a front view and a cross-sectional view of a dam generally at 61 with an operative insert 14 which attaches to an external frame 16 in alignment with the midpoint of the vertical side members of the frame 16c & 16d. When this type of dam is flexed, this type of attachment is in a posterior location relative to the portions of the alveolar arch that is isolated. Bilateral cheek retraction elements 41c & 41d are shown attaching the insert 14 to the frame 16 at locations 15c & 15d. The same reciprocal ‘cradling’ of the upper and lower alveolar quadrants of teeth 100a & 100b in the upper and lower alveolar diaphragmatic membranes 19a & 19b as are shown as in FIG. 22a. Mandibular anterior teeth 100b teeth are brought through holes in the lower diaphragmatic alveolar membrane 19b in a conventional manner of isolating teeth.

Oblique Attachment:

FIG. 22c shows a front view of a unilateral dam with an operative insert 14 attached to an external frame 16 at locations 15u and 151 which not in sumetrical alignment with the midpoint of the horizontal members of the frame nor in alignment with the midpoint of the vertical side members of the frame. Instead, the insert attaches to the external frame at locations between the horizontal and vertical midpoints of the frame in an oblique method of attachment. This type of attachment provides a mechanism for retraction of the cheeks posteriorly and lends some degree of stability and retraction to the lip on the side which is being isolated. It should be noted that the same reciprocal ‘cradling’ of the opposing alveolar quadrants of teeth are shown as in FIG. 22a and FIG. 22b are also present in this configuration.

### Inter-arch Rubber Dams With Operative Inserts Attached to the Barrier Membrane Only

Although this disclosure shows primarily graphic depiction of inter-arch dams with operative inserts 14 which attach both to the barrier membrane and also directly to the exterior frame, this disclosure also pertains to dams with operative inserts which attach to the barrier membrane only, without a direct attachment to the external frame. Inserts which are not directly connected to the exterior frame function more independently within the membrane in a manner similar to the previously described and graphically illustrated intra-arch operative inserts without connections to the exterior frame. Island placement of the insert within the rubber dam membrane allows stretching of the rubber dam from the frame all the way around the insert.

### Bilateral Isolation of the Anterior Segment or Anterior Half of the Alveolar Arch

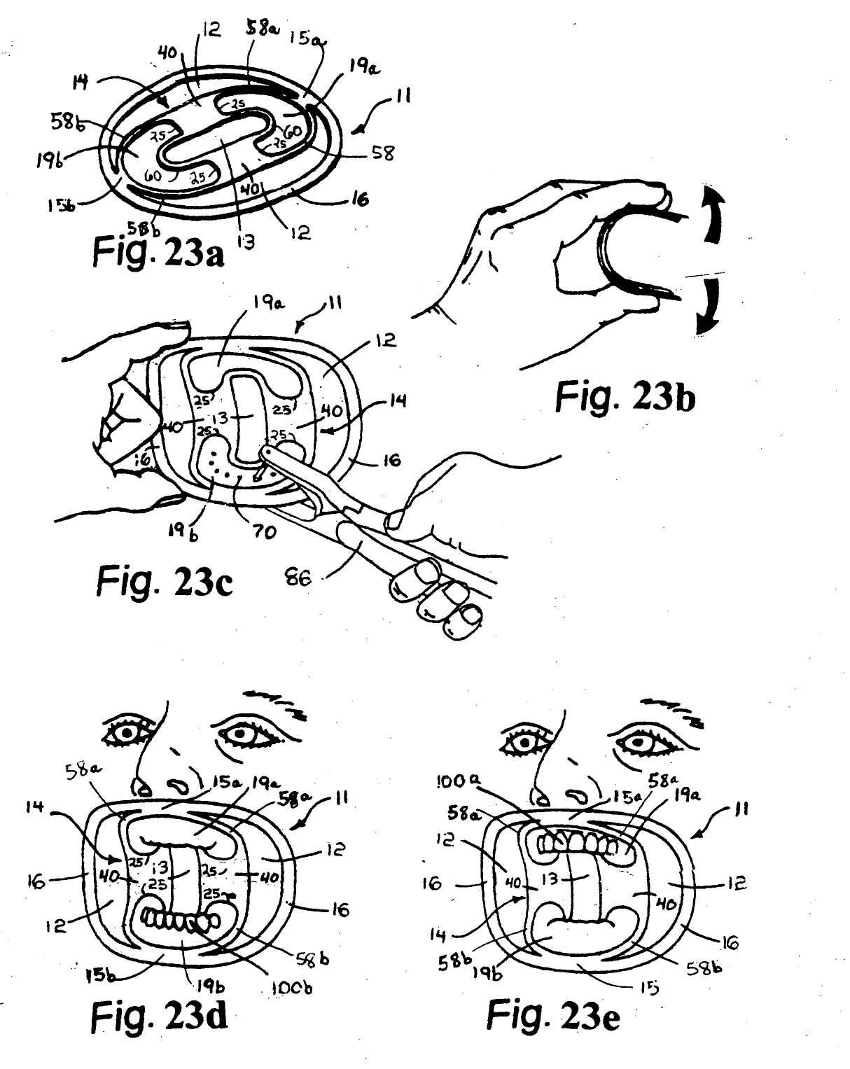

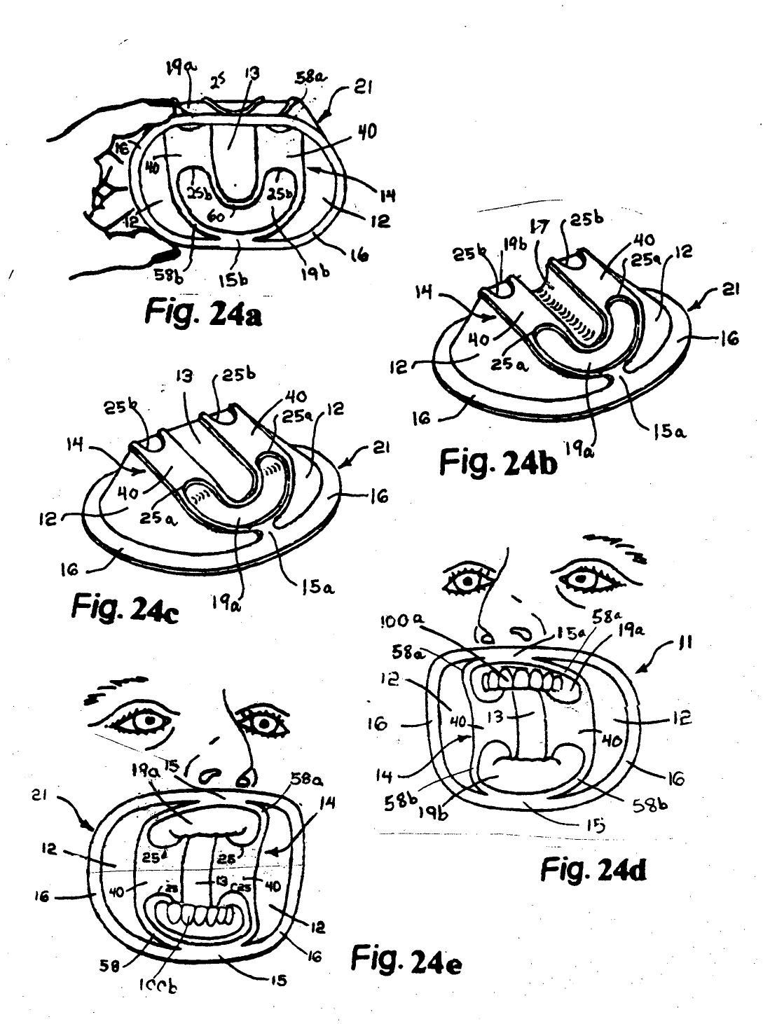

FIG. 21a shows an anterior bilateral inter-arch general field isolation dam generally at 11 which is manufactured in a flat configuration with an operative insert generally at 14 attached at the upper and lower midlines of the exterior frame 16 to the upper and lower opposing facial bows 58a & 58b. In this embodiment, the external frame 16 is integrally attached to the rubber dam membrane 12 and also directly attached to the operative insert 14 itself. Not shown is an alternative embodiment where the external frame 16 is attached to the rubber dam membrane 12 only and the operative insert 14 and frame 16 are separated by a portion of rubber dam membrane as separate entities. As shown in FIG. 21b, the embodiment shown which attaches the operative insert 14 directly to the integral frame 16 transmits reciprocal forces (arrows) of the flexed external frame directly to the facial bows 58a & 58b of the operative insert to cervically retract the anterior portion of the labial bows and lend stability to the insert during a clinical application. This direct attachment of operative insert and frame allows a single manufacturing step of injection molding or other manufacturing technique which simplifies the manufacturing process and reduces the costs of production of these devices. The anterior bilateral inter-arch dam shown generally at 11 with an integrally attached external frame has a flat oval interior rubber dam membrane 13 in the interior of the operative insert. This type of inter-arch dam may extend posteriorly in the oral cavity no further than the posterior boundary of the anterior half of the alveolar arch, thus not intolerably encroaching upon the intra-alveolar space (also called the lingual space). In general, this type of dam is most useful in isolating anterior segments, but may extend as far distally as the first premolars and in some cases possibly the second premolars. As described in the primary disclosure, the rule of thumb for inter-arch dams with a flat interior membrane is that this type of dam may maximally extend no further distally than the end of the anterior half of the alveolar arch. Although FIGS. 21a and 21b show the application of a general field isolation application with an integrally prepared slit 18, FIGS. 23a through 23e generally show the sequence of steps of conventionally isolating an anterior segment of teeth with a solid membrane anterior inter-arch dam by punching individual holes in the membrane for the isolation of teeth individually through each hole. FIG. 23a shows the flat dam as it is manufactured with upper and lower alveolar diaphragmatic solid membranes 19a & 19b. FIG. 23b shows reciprocal pressure applied with the fingers and thumb in the process of flexing the inter-arch dam into a rounded “U” shaped configuration. The inter-occlusal linking elements 40 accommodate to the inter-occlusal dimension of the opened mouth. Functional bending occurs at upper and lower bending axes 26a & 26b as described and shown graphically in FIGS. 22a-d located between the bilateral reciprocating posterior transverse arches 25 and the reciprocal opposing facial bows 58 and reciprocating lingual bows 60. The posterior transverse arches 25 span the vertical distance between the reciprocal bows 58, 60 and the inter-occlusal linking elements 40. The dam, in its flexed configuration, is tried into the mouth over the teeth to be isolated and the membrane contacting the incisal edges of the teeth is marked to register the location of teeth to be brought through the membrane (not shown). FIG. 23c demonstrates punching of individual holes 70 with a rubber dam punch 86 where the marks have been made and the individual teeth are to be brought through the membrane. FIG. 23d shows the completed application of the dam isolating a mandibular anterior segment of teeth 100a, while FIG. 23e shows the same dam rotated 80 degrees to isolate the maxillary anterior segment of teeth 100a. While these two views emphasize the versatility of this type of dam, alternatively the dam may be used with even greater versatility in that both the maxillary anterior segment 100a and mandibular anterior segments 100b may be isolated simultaneously with the same dam. Although most patients will be comfortable breathing through their nose during a procedure, placement of a breathing tube 46 beneath the dam as shown in FIGS. 42a-c to increase air exchange and facilitate mouth breathing is mandatory proper procedure in all cases. Also not shown is the required placement of a saliva ejector 48 beneath the dam, also shown in FIGS. 42a-c to manage accumulation of saliva and maintain an open airway during a procedure. FIGS. 23a through 23e show the manufactured flat configuration of this type of dam, while FIGS. 24a through 24e show the manufactured three-dimensional form of this same type of dam generally at 21. All elements are virtually identical, except that a bilateral anterior dam which isolates either anterior segments or the anterior one-half of the alveolar arch may either be manufactured with a concave interior membrane 17 as shown in FIG. 24b or a flat interior membrane 13 as shown in FIG. 24c. FIG. 24a is a front view of the embodiment with a flat interior membrane 13. This dam may either isolate an upper anterior segment of teeth 100a as shown in FIG. 24d or a lower anterior segment of teeth 100b as shown in FIG. 24e or both an upper and lower segment simultaneously.

### Bilateral Isolation Extending to the Posterior Half of the Alveolar Arch

Creating a device for isolation extending all the way to the posterior alveolar arch is a challenging design problem due to the need to maintain the integrity of the intra-alveolar space (also called lingual space) and to prevent the device from being rejected by the patient. An in depth discussion in the primary disclosure recites the needs of the patient with respect to the preservation of this space; namely the requirement of providing the patient's tongue room for movement due to periodic swallowing reflexes and preventing the encroachment of rubber dam material upon the posterior oral cavity and the soft palate where the gag reflex may be triggered. The solution to whole arch isolation, or to any bilateral inter-arch or intra-arch device which isolates beyond the approximate demarcation of the posterior boundary of the anterior half of the alveolar arch is a dam with a lingual concavity provided to provide unrestricted space for the patient's tongue while allowing an operative insert to protrude distally to isolate even the most posterior molars.

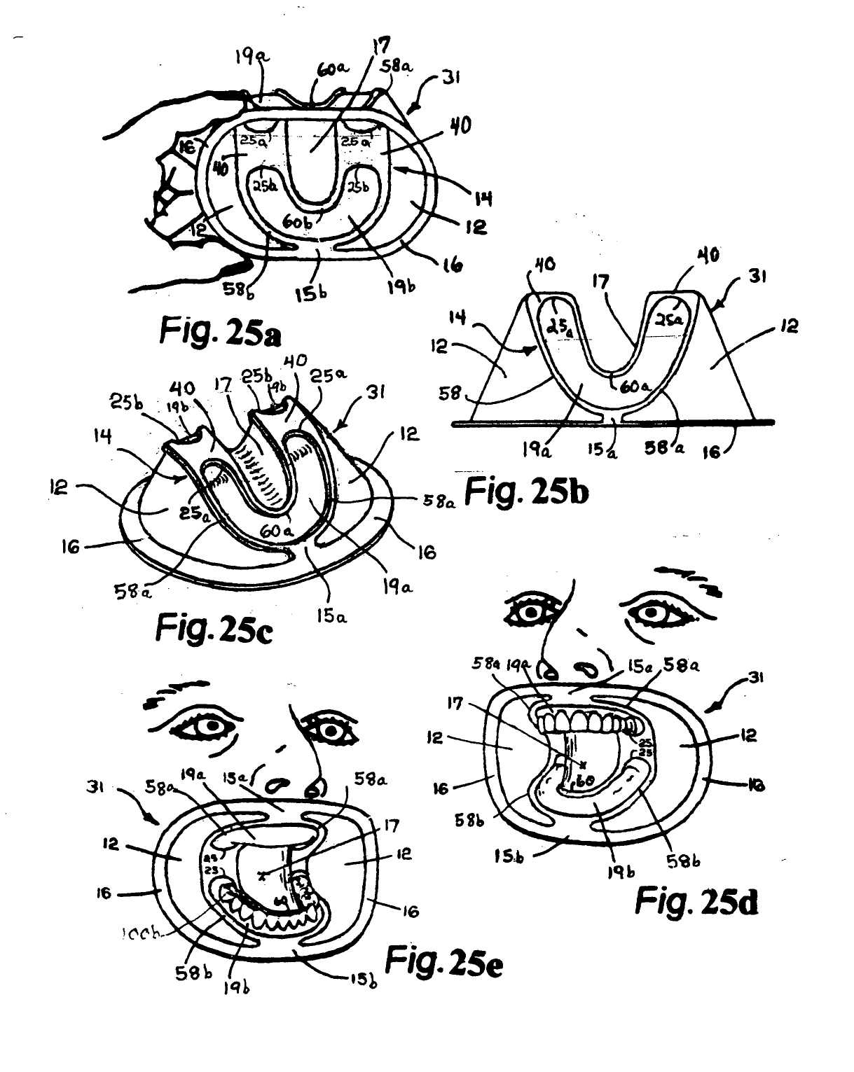

FIG. 25a shows a front view and an isometric view of a three-dimensional inter-arch dam generally at 31 which provides a bilateral operative insert 14 which attaches to an integral external frame 16 at the upper and lower midpoints of symmetry 15a and 15b of the insert and the dam. An elastomeric membrane 12 connecting the operative insert 14 with the integral frame 16 is shown bilaterally and labeled in FIGS. 25a-25e. All of the individual components of a bilateral inter-arch operative insert which have been discussed in the disclosure of the anterior inter-arch dam are applicable to this larger dam and will not be repeated here. The major difference as shown in FIG. 25b, a top view of the dam and in FIG. 25c in an isometric view of the dam from the back, which shows a central concave rubber dam membrane 17 in the interior of the dam, which prevents impingement of the dam upon the intra-alveolar space, allowing room for the patient's tongue and swallowing reflexes when the dam is in position in the mouth. FIG. 25e shows the dam isolating a whole mandibular arch of teeth 100b, while FIG. 25d shows a whole maxillary arch being isolated. This type of dam would find a market primarily in orthodontics, where whole arch banding and the bonding of brackets requires a dry field for the attainment of maximum bond strengths. Since this configuration requires the fabrication of a three-dimensional dam, the costs of production of this type of dam would be higher than the cost of fabricating dams which may be manufactured in a flat configuration.

### Unilateral Isolation of the Posterior Alveolar Quadrant

An inter-arch rubber dam with a unilateral operative insert 14 and an integrally attached external frame 16, manufactured in a flat configuration is shown in FIG. 26a generally at 41. This dam is configured to isolate a quadrant of teeth on one side of a patient's mouth and is therefore a unilateral dam. The basic design components analogous to the bilateral dams are an operative insert 14 integrally attached to an exterior frame 16 at attachment locations 15a and 15b and a barrier membrane 12 attached exterior to the operative insert 14 spanning to the exterior frame 16 and also upper and lower diaphragmatic alveolar membranes 19a & 19b spanning the interior of the upper and lower operative perimeters. This configuration of dam is a flat membrane dam that the clinician may modify to achieve conventional isolation, general field isolation, or a hybrid combination of both types of isolation.

### The Method Configuring a Flat Unilateral Inter-arch Dam With an Integral Frame for Conventional Isolation of a Quadrant of Teeth

FIGS. 26a through 26e show the sequence of preparing the flat dam generally at 41 for insertion into the patient's mouth and conventionally isolating a quadrant of teeth. FIG. 26a shows the bending axes 65a and 65b for bending the upper and lower anterior transverse arches 55a & 55b. Note that FIG. 26b shows the flat dam being flexed into a generally rounded “U” shape with arrows representing reciprocally opposing forces generated by the bending. This gradually rounded flexure of the posterior transverse arches 25a and 25b may be preferable to sharp angle bends as indicated for the bending of anterior transverse arch elements 55a and 55b at axes 65a and 65b as shown in FIG. 26c, but the basic elements of the operative perimeters and the subsequent use of the dam is as functional as it would be if sharp bends were made. When all of the bends are made, each of the upper and lower operative perimeters consist of an anterior transverse arch 55, a posterior transverse arch 25, facial bow 58, and lingual bow 60. Linking the posterior transverse arches and all reciprocal upper and lower elements of the dam is the inter-occlusal linking element 40.

When the dam is flexed into a generally rounded “U” shape configuration, as in FIG. 26b, it will be apparent to the clinician that the flexed dam wants to rebound back to its flat manufactured configuration. The reciprocal forces exerted by this tendency of the dam to return to an unflexed state oppose the reciprocal force of the patient's musculature transmitted through the upper and lower alveolar arches when the dam is in place in the mouth. These opposing forces generate frictional and mechanical forces which retain the rubber dam without the need for rubber dam clamps. In a few cases, supplementary rubber dam clamps may be added for extra retention, as shown in FIGS. 42a-c. With the anterior and posterior transverse arches formed, the clinician inserts the rubber dam into the mouth of the patient to check the fit and Positioning. When the dam is positioned properly, the diaphragmatic membrane 19b is marked at the location of the midline axis of each tooth that will be isolated (not shown). FIG. 26d shows a clinician punching individual holes 70 with a rubber dam punch at the positions where the teeth will be brought through the dam. With holes prepared for conventional isolation, the clinician then places the dam back into the mouth and flosses the rubber dam material between the contacts of the teeth in order to bring the teeth into the operating field in order to perform dental procedures. FIG. 26e shows the dam in position isolating a mandibular left quadrant of teeth 10b, while FIG. 26f shows the same dam isolating a maxillary right quadrant of teeth 100a. This dam may be used to isolate any of the four quadrants or posterior segments. Note that with the dam rotated 180 degrees, elements of the dam that were previously assigned to the upper arch are now in the lower arch and vice-versa.

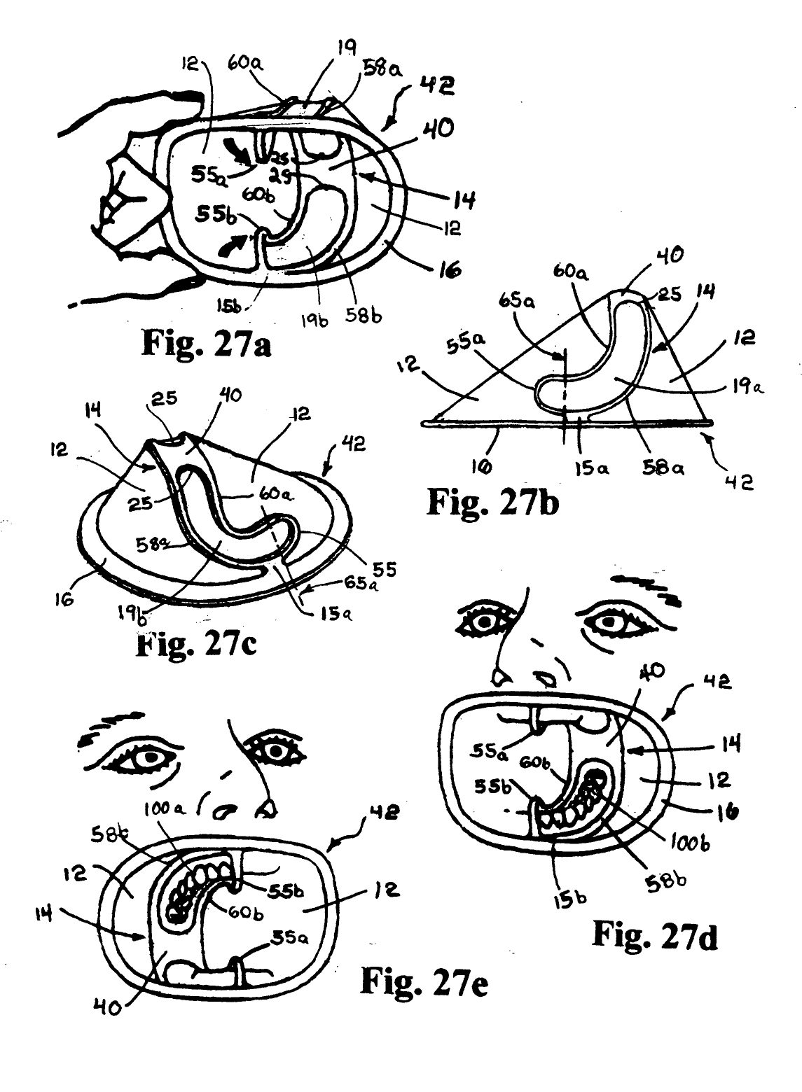

Three Dimensional Unilateral Inter-arch Rubber Dam With Integrally Attached Frame Shown in FIG. 27a through 26e, generally at 42, is a three-dimensional posterior inter-arch rubber dam with an integrally attached external framework 16 attached at locations 15a and 15b to a unilateral operative insert generally at 14, with features similar to that which was described for the flat configuration of posterior unilateral inter-arch dam. The posterior unilateral operative insert 14 of the dam is attached at the upper 15a and lower midline 15b of symmetry to the integrally attached frame 16. The upper attachment 15a to the unilateral operative insert 14 is at the anterior end of the upper facial bow 58a and the bending axis 65a of the upper anterior transverse arch 55a. The lower portion of the operative insert attaches 15b to the integrally attached frame in the corresponding location at the anterior end of the lower facial bow 58b where the bending axis 65b between the lower anterior transverse arch 55b and the lower facial bow 58b and lower lingual bow 60b are located. The end-user makes the bends just prior to insertion of the dam. Although a completely three dimension-al dam might also be manufactured with all elements in the final position, this configuration simplifies manufacturing processes and lowers the cost of fabrication with a subsequent reduction in cost to the end-user. FIG. 27d demonstrates the isolation of a mandibular left quadrant, while FIG. 27e shows the isolation of a maxillary right quadrant. Any of the four quadrants or posterior segments may be isolated with mirror image embodiments of this dam which can be rotated 180 degrees to accommodate either side of the mouth. Please note that when this same dam has been rotated 180 degrees, as in FIG. 27d, elements of the dam that were previously associated with the upper portion of the operative insert are now on the lower side and vice versa.

### Abbreviated Intra-oral Field Isolation Rubber Dam Devices With Integrally Attached Frames

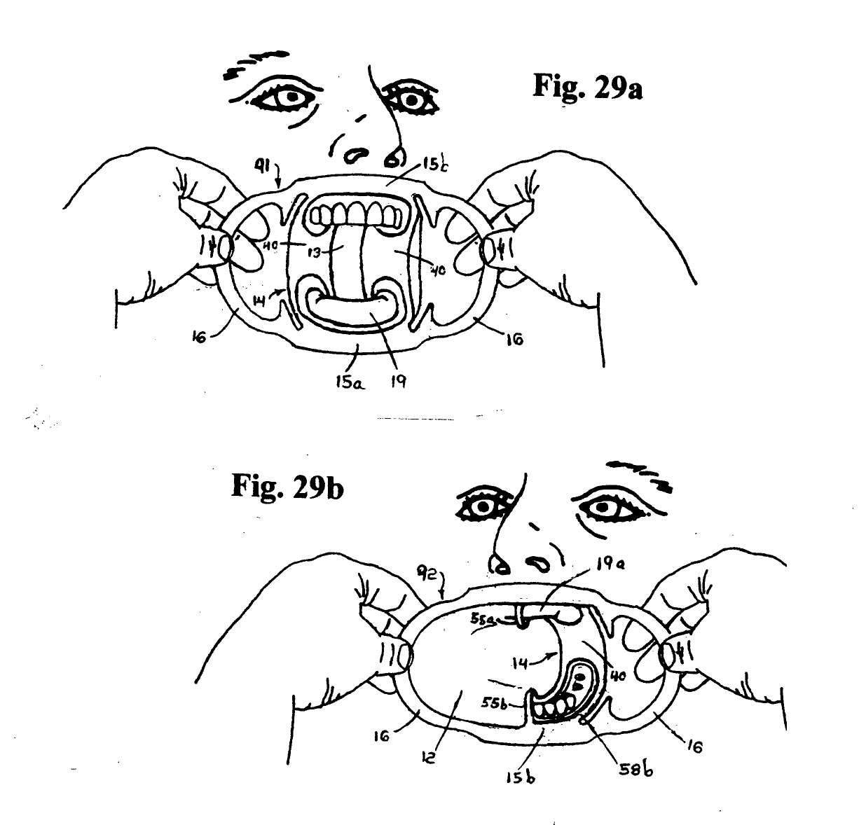

Some clinicians who do not favor the full rubber dam membrane for isolation will benefit from more abbreviated rubber dam devices with integrally attached frames. For the sake of classification, any rubber dam device which does not cover and retract the patient's lips in a full 360 degree manner as defined by the vermilion border or the interface between the non-keratin-ized mucosa and the beginning of the keratinized epithelium of the skin, should be classified as an abbreviated intra-oral rubber dam device. FIG. 29a shows an abbreviated bilateral intra-oral device generally at 91 with a bilateral anterior inter-arch operative insert generally at 14 and an external frame 16 attached at the upper and lower midline attachment portions of the frame 15a & 15b. This device has a smaller and distinctly different external framework than the full rubber dams and does not have an external rubber dam membrane 12 present bilaterally in connection to the frame. This device does not retract the patient's lips in the full 360 degrees like the full dams. The portion of the lips adjacent to the cheeks is not retracted, while the central portion of the upper and lower lips is retracted. The result is that approximately 50% of the circumference of the lips are actively retracted. This type of abbreviated dam may be manufactured as flat form or may be fabricated on a three-dimensionally. FIG. 29b shows an abbreviated unilateral intra-oral rubber dam device generally at 92 with a unilateral operative insert generally at 14 connected to the exterior frame at 15. This dam does not retract patient's lip and cheek directly adjacent to the side of the alveolar arch where the operative insert 14 isolates teeth, but does retract the other 75% of the circumference of the lips. The dam may be orientated 180 degrees to isolate teeth on either the patient's right side as well as the left side. All four posterior quadrants of teeth may be isolated with this type of abbreviated intra-oral rubber dam device. These devices preferably should have operative inserts and frameworks which are resilient or rigid with some properties of resilience, as the given application requires, but they could also be conceivably made of a malleable material. They may be configured to conventionally isolate teeth or alternatively field-isolate quadrants or segments. They may or may not have integrally applied chemically activated or pressure sensitive or photo-activated adhesives applied. They may be used with or without any manually applied barrier adhesive. They may be constructed with operative inserts with malleable or resilient and deformable wires, stampings, die castings, or other manufacturing processes; or they may be fabricated of or memory retaining plastics or composites, or injection molded plastics that act primarily as a static element, with some resiliency in the elastic range. The whole gamut of isolation techniques are possible with intra-oral rubber dam devices with integral frames. Any abbreviated rubber dam device which retracts the patient's lips from zero to 359 degrees and utilizes the principles of design and construction prescribed in this patent is considered to be within the spirit and scope of this disclosure. It is highly recommended that only abbreviated intra-oral rubber dam devices which fulfill two criteria be clinically promoted: first, the abbreviated rubber dam device should be manufactured too large to be fully inserted into the mouth to prevent any patient from ever swallowing or aspirating the dam; second, the abbreviated rubber dam device should be designed with an extra-oral component such as an exterior framework which would act like a handle for the clinician to quickly grasp and remove the dam swiftly if an occasion ever presented itself. Although it is not recommended that a completely intra-oral abbreviated rubber dam device be constructed which does not retract the patient's lips at all and fully inserts into the oral cavity, but if it were it should be constructed with a secure cord ligated to the device for safety and quick, predictable removal if necessary.

### Dams with an Operative Insert Circumferentially Attached to an Exterior Frame

Abbreviated Version:

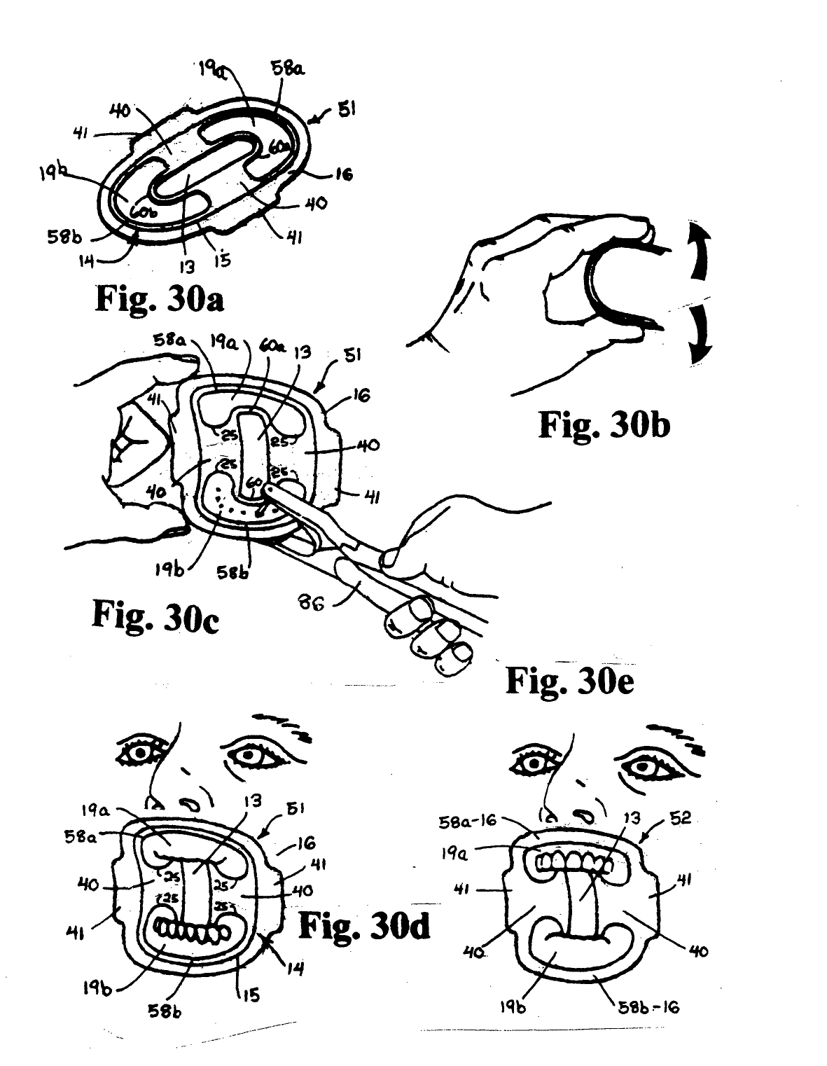

An abbreviated rubber dam with characteristics of a full rubber dam which retracts the lips circumferentially 360 degrees and also having characteristics of an abbreviated dam at the same time is shown in FIGS. 30a generally at 51. The dam has an operative insert generally at 14 and a circumferential exterior frame 16 attached in a complete circumferential manner to the exterior perimeter of the operative insert 14 at 15. This dam is designed for extra-oral use only, since its size prevents its insertion completely into the mouth. It applies to anterior segment isolation; either the maxillary anterior segment or the mandibular anterior segment and may extend isolation only as far posterior as the first premolars or in rare cases the second premolars. FIGS. 30b through 30e show the dam being prepared for conventional isolation of an anterior segment. This complete 360 degree retraction of the lips allows this type of dam to qualify as a true rubber dam and not an abbreviated intra-oral rubber dam device, but the dam truly is a type of abbreviated dam in comparison to the other types of full membrane rubber dams. Regardless of the fact that this dam defies classification, it has value for isolation of the oral cavity and deserves to be presented as an alternative embodiment. In a slightly different version of this dam graphically depicted in FIG. 30e, generally at 52, the facial bows 58a and 58b are completely fused with the circumferential frame 16 as a single element at location 15 (note that demarcation line 15 is missing). The abbreviated dams as well as all embodiments of dams presented herein may be constructed in any variation of configuration for any type of isolation of the teeth and/or sift tissues of the alveolar arch described in this disclosure.

### True Rubber Dams With Integral Frames and Abbreviated Inter-arch Operative Inserts

### Bilateral Flat Configurations of Dams With Abbreviated Operative Inserts

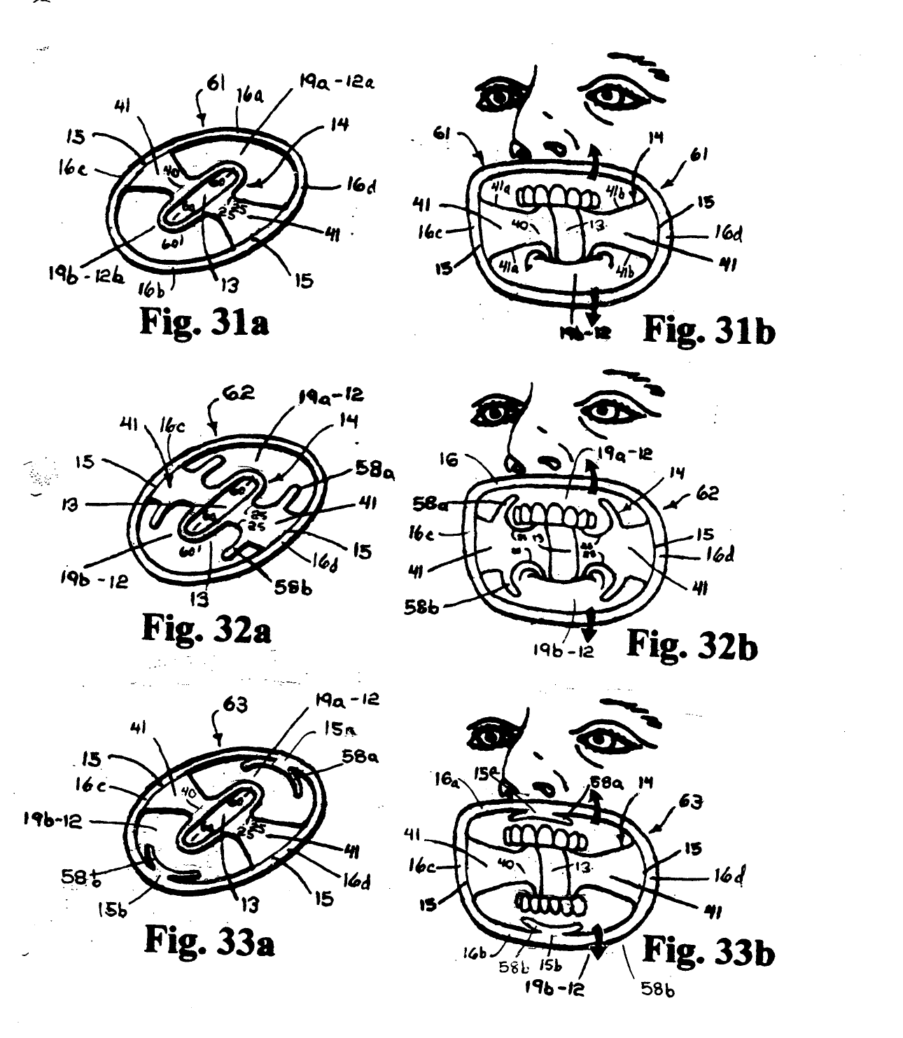

Graphically depicted in FIGS. 31a & b, 32a & b, and 33a & b are bilateral anterior rubber dams with abbreviated inter-arch operative inserts 14 connected at locations 15 to integrally attached frames 16. All of these dams are considered true rubber dams because they all cover and retract the lips 360 degrees in a complete circumferential manner. The three slightly different designs are functionally equivalent alternative embodiments of this type of flat inter-arch dam with abbreviated operative inserts 14, all either lacking or having an attenuated complement of insert elements. In each case, each embodiment has an abbreviated bilateral inter-arch operative insert generally at 14 which attaches to an exterior circumferential frame 16 bilaterally at vertical side elements 16c & 16d of the frame. Unlike the previous inter-arch dams disclosed, where the operative insert attaches at locations in the midline of the horizontal frame members of the dam in a manner which is coincidental with the patient's mid-saggital midline plane, the major elements of the operative inserts of these dams attach at the midline of the vertical (side) elements of the exterior frame. Like the previously described inter-arch operative inserts, these inter-arch dams also have bilateral elements 40 which accommodate the inter-occlusal distance of the patient's opened mouth between the upper and lower posterior transverse arches 25 and link all upper and lower reciprocal elements of the dam. Contiguously attached and radially located from the inter-occlusal linking elements 40 are the bilateral cheek retraction extensions 41 which retract the patient's cheeks posteriorly. The cheek retracting elements attach outwardly at locations 15c & 15d to the external integral frame 16 at locations 16c & 16d. While the patient's cheeks are retracted posteriorly by the cheek retraction extensions 41, the patient's lips are retracted cervically with respect to the patient's teeth by reciprocal membranes labeled 19a-12a and 19b-12b which are the upper and lower diaphragmatic alveolar membranes 19a and 19b joined to and combining functions with the upper and lower rubber dam membranes 12a & 12b stretched between the circumferential exterior frame 16 and the interior lingual bows 60. Tension in the membrane is developed from flexure of the rubber dam membrane between these two elements as it retracts the patient's cheeks and lips. As shown in FIGS. 31a and 31b generally at 61, the upper and lower facial bows 58a and 58b are missing and their functional contribution to the dam has been completely incorporated within and combined with the upper and lower external frame members 16a and 16b. The single membrane resulting fulfills the functions of both of the previous membranes and therefore has been named 19a-12a and 19b-12b. In embodiment 31a, the upper and lower posterior transverse arches 25a and 25b are separated by the inter-occlusal linking elements 40. The bilateral inclined planes 41a & 41b of the cheek retraction extensions 41 sloping inwardly to the posterior transverse arches 25, provides horizontal vector forces which deflect the dam laterally to create a self-centering mechanism for this dam. The upper and lower lingual bows 60a and 60b insert lingually to the upper and lower alveolar arches 110a & 100b to retain the dam and may be bent or deflected forwardly to accommodate the lingual curvatures of the arches during an application. A flat inner membrane 13 is located between the lingual bows at the center of the dam. The dam is retained in the mouth by reciprocal inter-arch forces of the stretched rubber dam membranes generating frictional forces in contact with the upper and lower alveolar arches. Retention is enhanced by mechanical retention of the lingual placement of the upper and lower lingual bows 60a and 60b against the inner surface of the alveolar arches. FIGS. 32a and 32b show another configuration of the bilateral dam generally at 62. FIG. 32a demonstrates that facial bows 58a and 58b still present, but as an incomplete insert elements. In this embodiment, these attenuated facial bows 58a and 58b bend anteriorly at their interface with the posterior transverse arches 25 to aid in cervically retracting the rubber dam membrane around the teeth and soft tissues in the posterior area of the arch. FIG. 33a and FIG. 33b show a bilateral inter-arch dam generally at 63 with an abbreviated operative insert 14. This dam has the posterior sections of the facial bows missing, but approximately the anterior ⅓^{rd} to ½ of the facial bow 58 in each arch is attached generally at the horizontal midline of symmetry of the dam at 15a & 15b.

### The Method of Preparing a Bilateral Inter-arch Dam With Abbreviated Operative Inserts

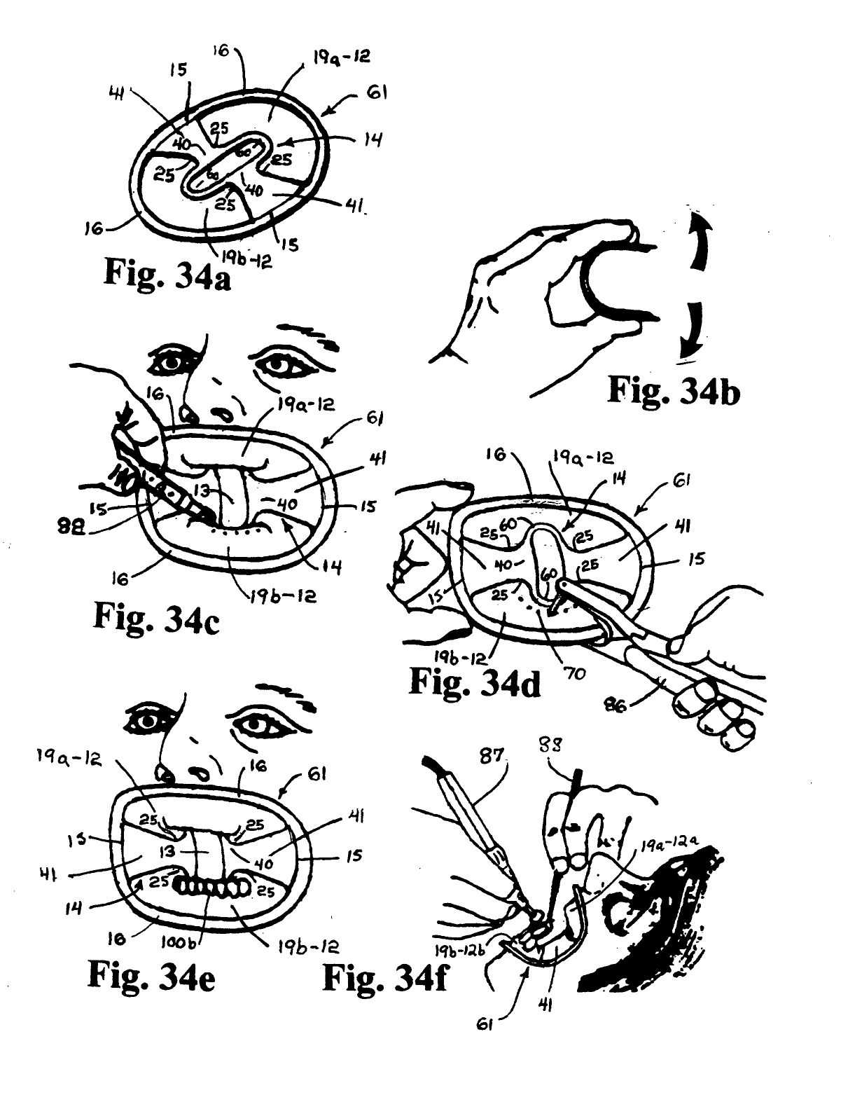

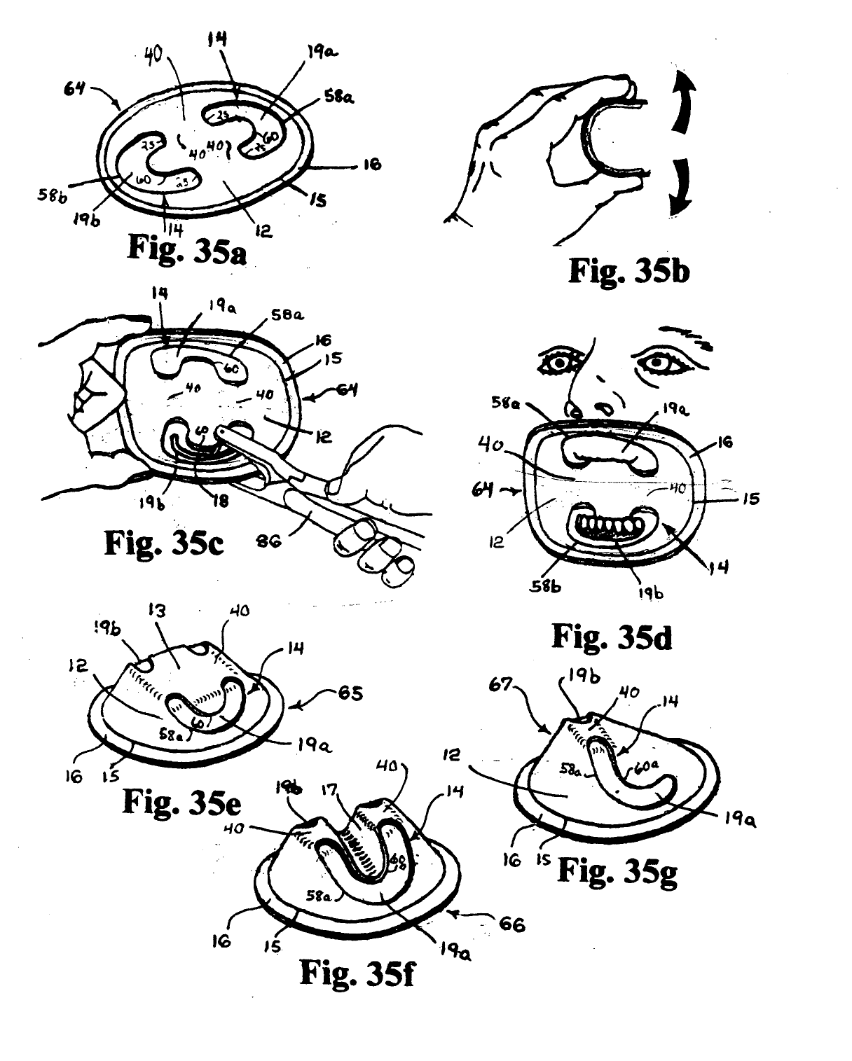

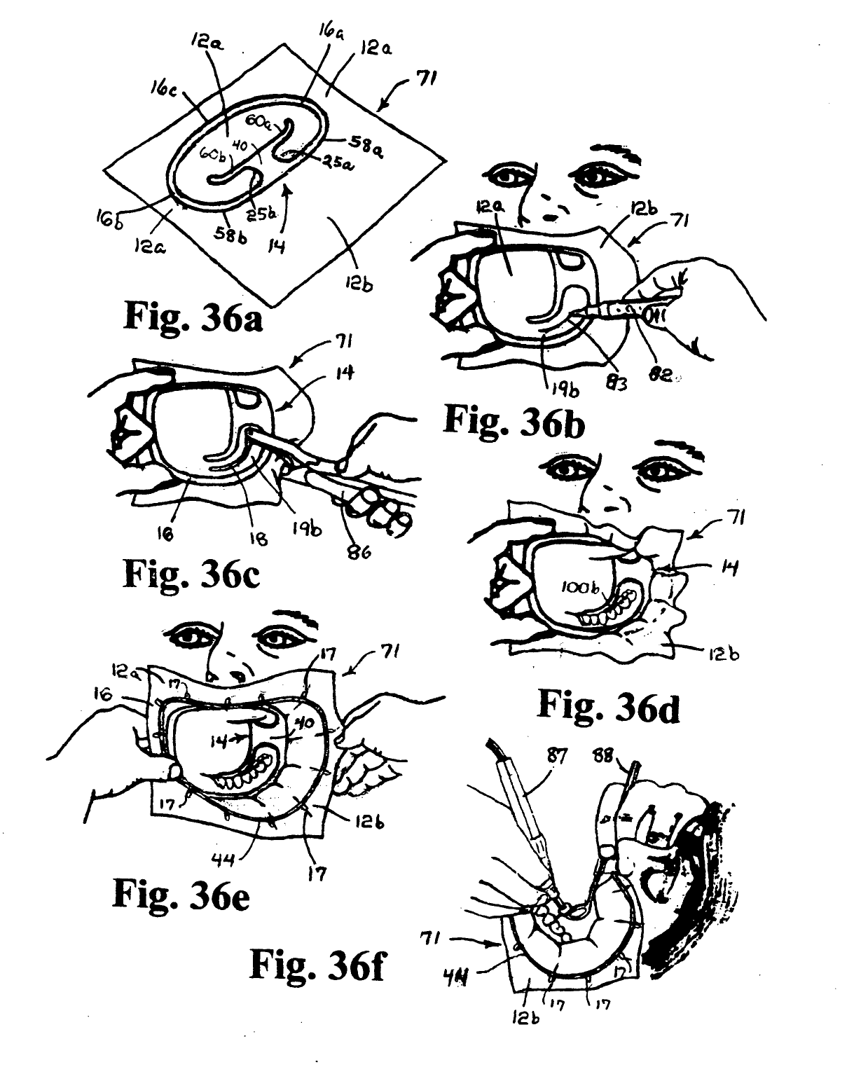

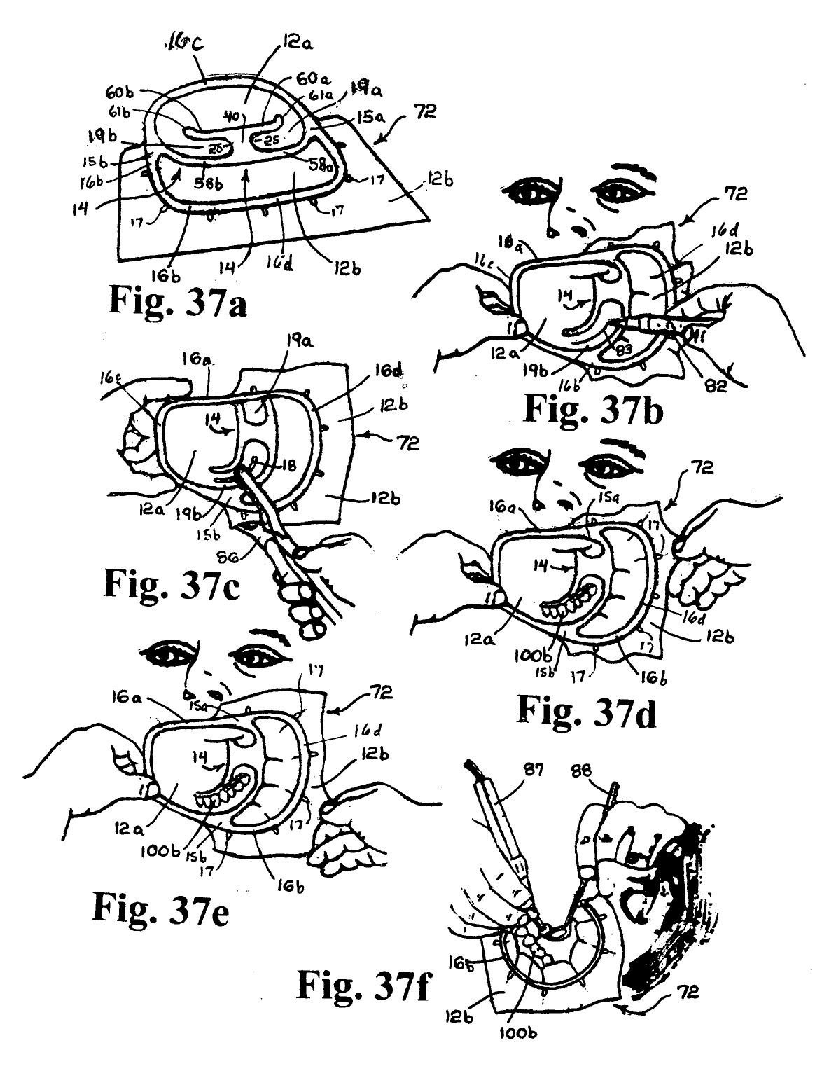

FIGS. 34a-34f show the methods of preparing the flat bilateral inter-arch dam with abbreviated operative inserts of FIGS. 31a and 31b for insertion into the mouth during an application. FIG. 34a shows the flat dam in isometric view. FIG. 34b shows a profile view of flexure of the dam into a “U” shaped form, FIG. 34c shows the dam placed into the mouth to check the fit and positioning and to mark with a marker 82 where teeth are to be brought through the membrane, FIG. 34d shows holes 70 being punched with a rubber dam punch 86 where the positioning marks have been made on the dam, FIG. 34e shows the dam in place in the mouth with the lower anterior teeth 100b brought through into the operating field, and FIG. 34f shows patient and the rubber dam generally at 61 in profile view demonstrating retraction of the cheeks posteriorly by the cheek retraction extensions 41 and the lips cervically by the upper and lower diaphragmatic alveolar membranes 19a-12a and 19b-12b during a treatment procedure.

### Abbreviated Operative Insert Circumferentially Connect to Exterior Frame

Another version of this type of dam with characteristics of a full rubber dam which retracts the lips circumferentially 360 degrees with an operative insert 14 having characteristics of an abbreviated operative insert is shown in a flat configuration in FIGS. 35a generally at 64. This dam has an operative insert that is an inter-arch insert fused in a completely circumferential manner to what was previously the intervening exterior barrier membrane 12 but is now made of material that is the same thickness and composition as the insert and exterior frame 16. The combined elements of the operative insert, intervening membrane, and exterior frame now form a unitary structure composed of the same material of construction. Reciprocal diaphragmatic alveolar barrier membranes 19a and 19b remain within the boundaries of the operative perimeters which are now fused to the unitary structure. This dam is an extra-oral dam, since its exterior frame circumference prevents its insertion completely into the mouth and provides complete circumferential coverage and retraction of the patient's lips. The flat interior membrane 13 is also composed of the same material of construction as the surrounding lingual bows 60a & 60b and become part of the unitary structure. The flat configuration of the interior portion of the dam 13 allows isolation of the anterior half of either the maxillary or the mandibular arch as far posterior as the first or second premolars since. FIGS. 35a shows the flat configuration of the dam. FIGS. 35b through 35d shows the method of configuring this type of dam for field isolation, although conventional or hybrid isolation are equally applicable. 35b shows the dam flexed into a “U” shape configuration. FIG. 35c shows a slit-like opening being prepared in the lower diaphragmatic alveolar membrane 19b. FIG. 35d shows the dam field isolating an anterior mandibular segment.

This concept of a dam with the operative insert, membrane, and external frame fused into a unitary structure is equally applicable to flat configurations and three-dimensional configurations. Shown in FIG. 35e generally at 65 is an anterior bilateral three-dimensional dam with a unitary body structure and upper 19a and lower 19b diaphragmatic membranes. FIG. 35f shows a dam generally at 66 which is the embodiment of a posterior or whole-arch bilateral three-dimensional dam with a unitary structure and upper 19a and lower 19b diaphragmatic membranes. FIG. 35g shows a dam generally at 67 which is a three-dimensional unilateral inter-arch dam with a unitary structure with upper 19a and lower 19b alveolar diaghragrnatic membranes. Although all of these embodiments show barrier membranes within the circumferential operative perimeters of the operative insert 14, another embodiment might retain the unitary body structure but discard the membrane completely to leave openings within the perimeters. This alternative embodiment, although not shown graphically, should be considered to be within the spirit and scope of this disclosure.

These alternative embodiments of dams may be fabricated out of alternative material s of construction with resilience such as a plastic, or malleable material which behaves rigidly or like a foil, or alternatively in the case of the prefabricated three-dimensional dams, a very economic but suitably rigid paper, cardboard, or fibrous material coated with a water-impermeable wax or plastic coating material.

### A Hybrid Inter-arch Dam With an Abbreviated Inter-arch Insert Attached to an External Frame, Having an Attached Barrier Membrane External to the Insert and the Integral Frame for Variable Attachment of the Barrier Membrane to a Frame Which is a Separate Device

FIG. 36a generally at 71 shows a hybrid unilateral inter-arch dam which has a unilateral inter-arch insert generally at 14 attached to and integrated within an integral frame 16. This dam has upper and lower posterior transverse arches 25, separated by an inter-occlusal linking element 40, but is missing the anterior transverse arch elements 55a and 55b. The upper and lower facial bows 58a and 58b are elements which completely merge with the external circumferential frame member 16. The upper and lower lingual bows 60a and 60b, lacking a connection to anterior transverse arches, cantilever anteriorly from their attachment to the posterior transverse arches 25a and 25b. External the circumferential exterior frame 16 is an exterior barrier membrane projection 12a of a selected uniform width. Projecting laterally from the exterior perimeter of the operative insert 14 along the upper and lower facial bows 58a and 58b and inter-occlusal linking element 40, is a substantial width of barrier membrane 12b, equaling the width of the operative insert and uniform width barrier membrane 12a around its periphery. The integrally attached frame 16 allows a clinician to control a significant portion of the barrier membrane and the flexure of the inter-arch operative insert 14 during insertion of the dam into the mouth. The barrier membrane exterior to the operative insert 14 and integrally attached frame 16 serves to allow the secondary attachment of an external frame which is a separate device to the dam to allow for variable retraction of the cheeks and lips adjacent to the facial bows 58a and 58b by the barrier membrane, and to improve overall cervical retraction of the inter-arch operative insert 14.

FIGS. 36b through 36f show the sequence of steps of preparing this type of hybrid dam for field isolation of a single posterior quadrant of teeth. FIG. 36b shows the dam flexed and inserted into a patient's mouth of the alveolar arch to be isolated. A line 83 is being drawn with a marker 82 on the lower solid alveolar diaphragmatic membrane 19b to mark where a slit will be punched to follow the contour of the alveolar arch. FIG. 36c shows a slit-like central opening 18 being punched in the alveolar diaphragm membrane 19b where the line 83 is marked. FIG. 36d shows that the dam has been flexed and placed back into the patient's mouth and the teeth and soft tissues 100b have been brought through the slit and into the operating field. FIG. 36e shows a front view of an external frame 44 which is a separate device applied to the barrier membrane 12a exterior to the integral frame 16 and 12b exterior to the operative insert 14 and adjacent to the facial bows 58a and 58b. FIG. 36e shows the rubber dam membrane 12b being stretched over rubber dam attachment nibs 17 of the detachable frame 44. FIG. 36f shows a side view of the detachable frame 44, retracting the patient's lips cervically and cheeks posteriorly to achieve optimal access to the quadrant of teeth that are involved in a dental procedure. The application of a detachable exterior frame 44 to the barrier membrane adjacent to the operative site 12b allows the clinician to modify and control the tensile forces of retraction in this area, while the integral frame 16 on the opposite side of the operative insert 14 allows the clinican greater control of the process of placing the dam in the mouth of a patient initially.

### Unilateral Flat Configurations of Dams With Abbreviated Inter-arch Inserts

FIG. 37a shows a dam generally at 72 which is a unilateral inter-arch dam with an abbreviated inter-arch operative insert in which anterior transverse arches 55a and 55b are missing, as compared to the unilateral dam represented in FIG. 26a. This dam is like the unilateral dam of FIG. 26a which isolates teeth and/or soft tissues on one side of the mouth only, but due to the lack of anterior transverse arches, does not require the bending of the anterior transverse arches at the bending axes 65a & 65b in preparation for insertion of the dam into the mouth. Still present in the operative insert are the lingual bows 60a and 60b, attached directly to the posterior transverse arches 25a and 25b. The inter-occlusal linking element 40 spans the distance between the posterior transverse arches. Since the anterior transverse arches 55a and 55b are missing, the lingual bows 60a & 60b attach posteriorly to the posterior transverse arches 25a & 25b, but end in free, unsupported ends 61a and 61b. The unsupported lingual bows thus function as cantilevering elements which absorb tensile forces to retract the rubber dam membrane cervically in each arch. One advantage of this type of design is that the end-user does not have to bend the anterior transverse arches 55a and 55b at the bending axes to prepare the device for insertion into the mouth. Since the cantilevering elements of the lingual bows 60a and 60b are unsupported at their ends by secondary elements, their material width and cross-section must be increased to compensate for this loss of support in order to achieve adequate cervical retraction. The facial bows 58a and 58b of the operative insert 14 attach the insert directly to the exterior frame 16 at locations 15a & 15b. An elastomeric membrane 12a is integrally attached to all elements of the entire operative insert 14, and also to the exterior frame 16 in generally the lingual half of the dam up to the location of the attachments 15a & 15b where the operative insert 14 is attached to the exterior frame. In this specific embodiment of this type of dam, the elastomeric membrane on the side of the operative insert 14 which primarily retracts the cheek, labeled 12b is not integrally attached. The portion of the rubber dam membrane 12a which is integrally attached to the frame improves the degree of control of placemant of the dam into the mouth initially to position it. The unattached portion of the membrane 12b allows the clinician to variably adjust the tension on the rubber dam membrane and the amount of retraction of the cheek and soft tissues by the degree of stretching of the membrane over the rubber dam attachment nibs 17 located on and equally spaced on the cheek side of the external frame 16b. Manual attachment of the rubber dam membrane in this region of the dam allows the clinician to control the degree of cervical retraction of the lips and posterior retraction of the cheeks by the degree of stretching of the dam and the resultant tensile forces generated within the dam. FIG. 37a is an isometric view of the flat configuration dam. FIG. 37b shows the dam flexed and positioned in the mouth and the locations where teeth will be brought through the diaphragmatic alveolar membrane 19b being marked with a marker 82. This view shows the integrally attached membrane 12a and the loose detached facial portion of the membrane 12b. Also in this view, the clinician, having positioned the dam in the mouth, is applying a line mark 83 with a marker 82 where a slit will be made by the clinician for general field isolation of the quadrant. In FIG. 37c a slit 18 is being punched with a special type of rubber dam punch 86 where the line marks was previously made. FIG. 37d shows a lower quadrant of teeth/soft tissues 100b brought through the slit 18 into the operating field. Also shown in FIG. 37d is the clinician stretching the detached rubber dam membrane 12b over the rubber dam attachment nibs 17 in order to variably attach the rubber dam membrane to the frame 16b. FIG. 37e shows a continuation of stretching the membrane 12b over the rubber dam attachment nibs 17. FIG. 37f shows the applied dam in a profile view in a patient's mouth, with the cheek retracted posteriorly and the lips retracted cervically for excellent access to the alveolar arch. A clinician is instrumenting with a dental handpiece 87 and a mouth mirror 88. This is an example of a hybrid dam with a portion of the membrane integrally attached to the frame and portion of the membrane which is manually attached to the exterior frame.

### Three-dimensional Dams with Abbreviated Inter-arch Inserts

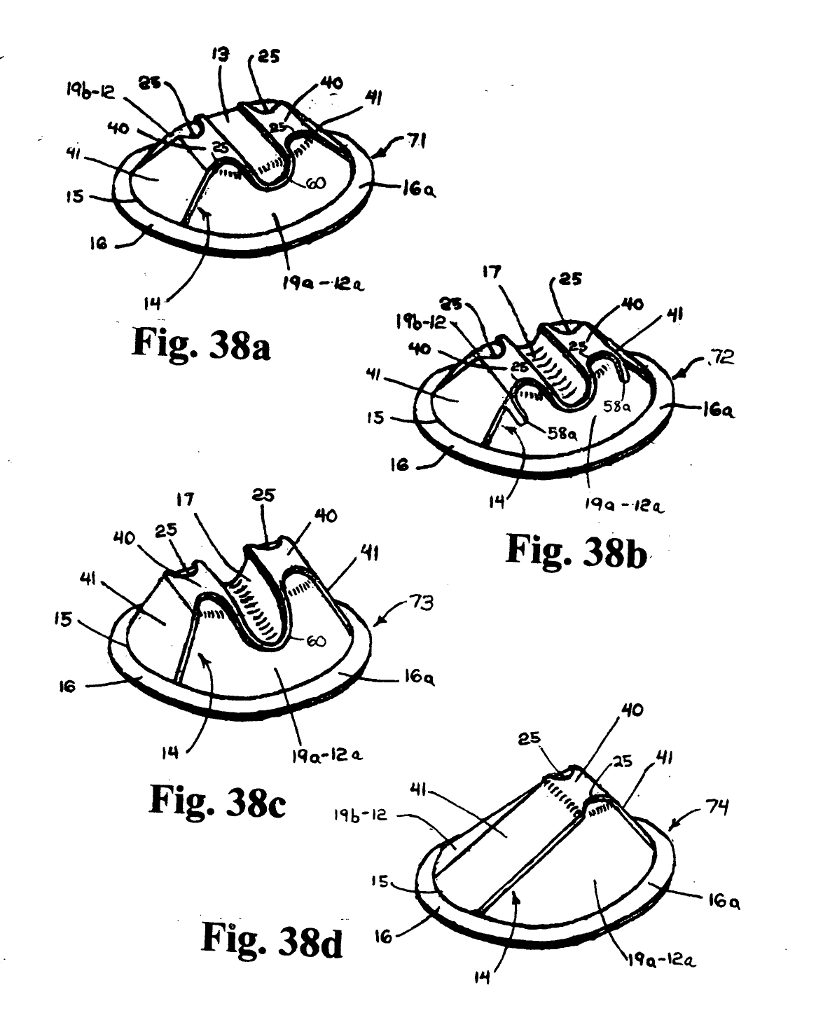

Although creasing the flat configuration dams to provide some posterior deflection of the operative insert will help to extend isolation posteriorly somewhat in these dams, there are limitations to this technique of extending the extent of posterior isolation with these dams. In order to achieve more posteriorly isolation with this concept of dam, a three-dimensional approach to manufacturing dams of this type is required. FIGS. 38a through 38d show three-dimensional configurations of the inter-arch dams with abbreviated inter-arch operative inserts 14. In each case, as with the flat configurations of dams of this concept, the dams are constructed of an operative insert designated generally at 14, engaged to a barrier membrane 12 with an integrally attached framework 16. As in the flat configurations, the incomplete or abbreviated elements of the operative inserts 14, combine the functions of the upper and lower diaphragmatic alveolar membranes, 19a and 19b with the barrier membrane 12 extended from the operative insert 14 to the integrally attached external framework 16. The resultant embodiment of membrane combining these functions has been designated as 19a-12a and 19b-12b, reflecting its combined functions. FIG. 38a shows a bilateral anterior three-dimensional inter-arch dam with the upper and lower facial bows 58a and 58b completely missing; and a flat interior membrane 13, sufficient for applications pertaining to the anterior half of the alveolar arch. FIG. 38b shows another embodiment of a bilateral anterior inter-arch dam with incomplete upper and lower facial bows 58a and 58b and a concave interior membrane 17, also applicable to isolation of the anterior half of the alveolar arch. FIG. 38c shows a bilateral posterior inter-arch dam with the facial bows 58a and 58b completely missing and a concave interior membrane 17 present to accommodate the intra-alveolar space, the patient's tongue, and swallowing reflexes. FIG. 38d shows a three-dimensional unilateral inter-arch dam for quadrant or posterior segment isolation with reciprocal posterior transverse arches, 25 spanning the distance between the inter-occlusal linking element 40, attached to bilateral cheek retraction extensions 41, each of which attach to the integral frame 16 at the mid-point of the vertical members of the dam at locations 15 which are aligned with an axis perpendicular to the vertical axis of the dam. All other elements of these dams are analogous to the features described in the disclosure of the flat configurations and are numbered accordingly.

### Three-dimensional Dams With Intra-arch Operative Inserts

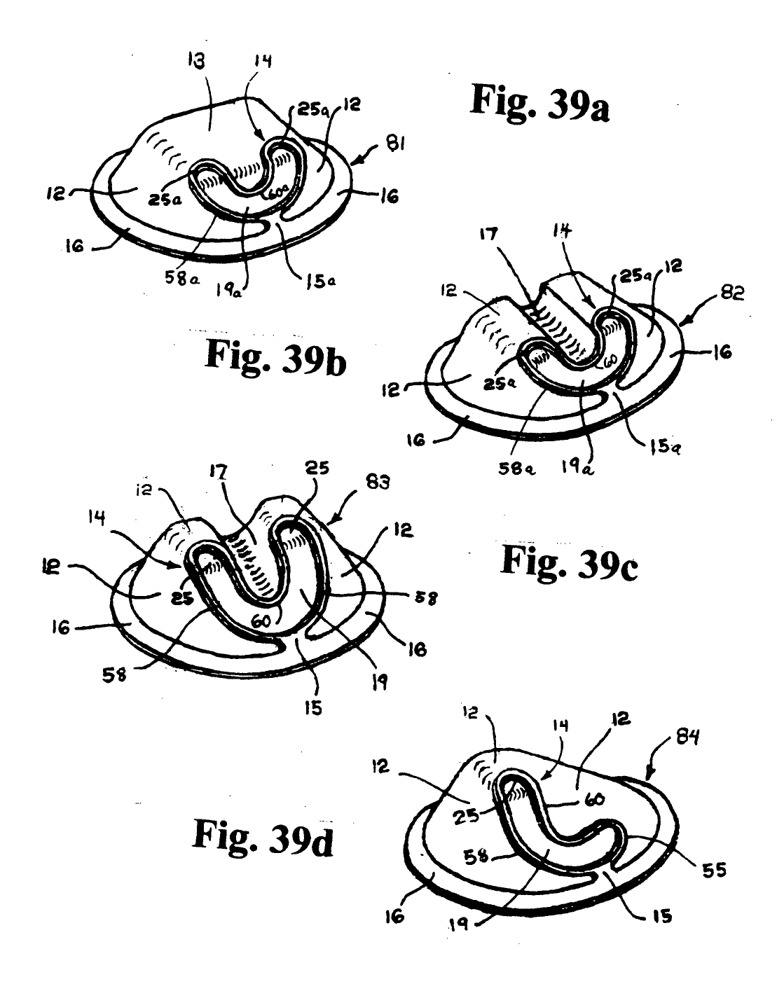

Shown in FIGS. 39a through 39d are three-dimensional dams with intra-arch operative inserts. Although a single intra-arch operative insert is shown in each of the graphic depictions shown, these dams may also have intra-arch operative inserts on both sides of the dams and still be classified as intra-arch rather than inter-arch dams. The primary difference in these concepts is that an inter-arch operative insert has all reciprocal elements connected by posterior inter-occlusal linking element(s) 40, thereby conveying reciprocal forces between the reciprocal elements and allowing the patient to use ‘biting’ forces to hold the dam in place. One can argue that these dams are also inter-arch dams, however, because the exterior frame 16, connected to both intra-arch elements, transmits inter-occlusal forces to the operative inserts in a manner which replaces the inter-occlusal linking elements 40, but is different than the dams with posterior inter-occlusal linking elements 40. Whatever classification one might assign to these three-dimensional dams, these dams are uniquely different than the inter-occlusal dams with posterior inter-occlusal linking elements have have a unique efficacious niche in rubber dam isolation with operative inserts and integral frames. FIG. 39a shows a three-dimensional bilateral anterior intra-arch dam with a single anterior operative insert 14 with a flat interior membrane 13, which is connected to the integral frame 16 at location 15. FIG. 39b shows a three-dimensional bilateral anterior intra-arch dam with a single anterior operative insert 14 with a concave inner membrane 17, which is connected to the integral frame 16 at location 15. FIG. 39c shows a three-dimensional bilateral posterior intra-arch dam with a single anterior operative insert 14 with a concave inner membrane 17, which is connected to the integral frame 16 at location 15. FIG. 39d shows a three-dimensional unilateral posterior intra-arch dam with a single posterior operative insert 14, which is connected to the integral frame 16 at location 15. Although all operative inserts graphically depicted are directly attached to the exterior frame, similar dams with the operative inserts connected only to the membrane itself are also within the spirit and scope of this disclosure. The operative inserts of these dams may be of a malleable or rigid or resilient material composition. These dams are highly dependent on the placement of rubber dam clamps to retain them in the mouth and over the respective operative sites.

### The Use of Supplementary Rubber Dam Clamps in Inter-arch Dam Applications

In some exceptional cases excessive vector forces may cause anterior displacement of the inter-arch dam, requiring the application of supplementary retention of the dam with rubber dam clamps. In these cases, supplementary clamps may be applied in either arch opposing the arch in which isolation is anticipated, or alternatively in the arch being isolated, or in both arches simultaneously. In the reciprocally opposing arch, clamps may be applied directly over the rubber dam membrane. If supplementary retention is required in the arch being isolated, the clamps may be applied anteriorly, in a location remote from the teeth being isolated. Conventional isolation, with interseptal rubber flossed interproximally between contacts, is much more retentive than general field isolation because the interseptal rubber forms a mechanical ‘lock’ around the teeth being isolated. In general field isolation, where the interseptal rubber is not present, there is less retention around the operating field, so the use of supplementary clamps will more likely need to be applied in these cases. Inter-arch dams constructed with resilient inserts or rigid inserts acting in a resilient manner within their elastic limits apply reciprocal inter-arch forces to retain the dam in position will have much more retention than inter-arch dam with malleable inserts. Malleable or purely elastic inter-arch dams will always require rubber dam clamps as a retentive mechanism. FIG. 42a shows the placement of a rubber dam clamp 64 in an anterior position in the mandibular arch opposing a segment of teeth to be isolated in the maxillary arch. FIG. 42b shows a clinician about to place a second clamp 64 in the maxillary arch. FIG. 42c shows two clamps 64, 64 placed in a reverse orientation toward the anterior of both arches.

### The Novel Application of Anteriorly Placed Rubber Dam Clamps to Isolate the Posterior Portion of an Alveolar Arch and the Resultant Stabilizing Vector Forces Applied to These Clamps

The use of clamps in the manner shown in FIGS. 42a, 42b, & 42c should be considered a novel alternative application of rubber dam clamps. Unlike the application of clamps in the posterior of a quadrant to retain a stretched conventional dam, this method of application subjects the clamps primarily to lateral forces, rather than tensile forces with a strong rotational and vertical component as in conventional application of rubber dam clamps opposing the stretched rubber dam membrane. As any practicing dentist may testify, the conventional application of clamps to retain a stretched conventional rubber dam, creates rotational forces within the clamps to tip them forward and easily dislodge them, thereby often causing the clamp and the rubber dam isolation to fail. In inter-arch dams the operative insert absorbs almost all of the anterior forces of a stretched rubber dam and the vertical displacing forces are opposed by the inter-arch occlusal forces of the patient biting down on the dam. Thus the significant displacing vertical and rotational forces placed on the clamps are nullified. The anterior application of clamps subject the clamps primarily to forces perpendicular to the long axes of teeth and creates a highly stable and reliable method of retaining a rubber dam. In cases where posterior teeth are so badly broken down that a clamp cannot be applied posteriorly, anterior placement of rubber dam clamps combined with the use of an inter-arch dam provides a very satisfactory solution for isolation of this type of circumstance.

### Three-Dimensional Dams With a Continuous Malleable Sheet Operative Insert

FIGS. 35e, 35f, and 35g depict the three-dimensional embodiments of alternative dams which are best suited for the application of alternative materials of construction. The three-dimensional dam with a continuous or discontinuous malleable sheet insert is an extension of the concept of the insertion of an operative insert, but instead of a malleable loop located in the membrane, the insert is either a solid sheet of malleable material interposed between exterior layers of elastomeric material. (Note: if a solid malleable sheet or foil is substituted without the exterior layers of polymeric material, this alternative embodiment should be considered to be within the scope and spirit of this disclosure). The malleable material allows the dam to behave like the action of a foil. This allows the dam to retain the memory of a configuration that the clinician molds it into in order to satisfy his requirements. This type of dam may be fabricated as a flat device or a three-dimensional device. If the dam is to satisfy a three-dimensional solution, it needs to be cast, formed, or molded in a configuration simulating the end-configuration of an elastomeric dam that has been stretched to its final operable form in the mouth. In the case of anterior bilateral dams, that means that the dam takes on a generally symmetrical truncated pyramidal form (like a pyramid with the top half of the form missing) or a truncated conical form. Bilateral whole arch foil dams take on a generally similar form, but have a roughly parabolic depression in the top of the truncated pyramidal form which creates a concavity in the final dam which accommodates the infra-alveolar space and the patient's tongue and swallowing reflexes (see discussion of dams formed on three-dimensional dies or forms in the parent disclosure). Unilateral foil dams take on a form of a generally asymmetrical truncated pyramidal form (see discussion of the end-form of stretching of a unilateral elastomeric dam in the parent disclosure). The foil dam does not lend itself to isolation of individual teeth well, as in the conventional technique of isolation with an elastomeric rubber dam. The reason for this is that foil shears easily and will not stretch over individual teeth, as in an elastomeric dam. For this reason, a purely foil dam is of greatest benefit if it is configured as a general field isolation dam, which can be simply placed over a segment or quadrant of teeth and molded to the anatomy. An exception to this is a foil dam with an elastomeric diaphragm over the alveolar arch location where the operating field is located. Since the malleable sheet is not present in this area, the resilient elastomeric membrane allows the punching of holes as in the conventional manner and stretching the dam over the teeth to isolate the clinical crowns.

A three-dimensional dam utilizing the concept of more than one type of operative insert simultaneously and cast, formed, or molded of a single material exhibiting different physical characteristics based on cross-sectional form and/or thickness is an alternative embodiment which may be economically manufactured without the need for assembly. Malleable materials, while quite contourable and adaptable in a very thin cross-section such as a foil, approach the properties of rigidity in thickened cross-section. The same type of plastic that exhibits the properties of an adaptable barrier membrane in very thin cross-section, may behave in a rigid or resilient manner in a thickened section. Thus the concept of an inter-arch operative insert and integral frame combined with a barrier which may be fabricated as a single unit in a single mold obviating the need for assembly and making the manufacturing cost/cost to the end-user feasible.

### The Method of Field Assembly of Dams With Operative Inserts and Integrally Attached Frames Utilizing an Insert Device with an Integrally Applied Adhesive

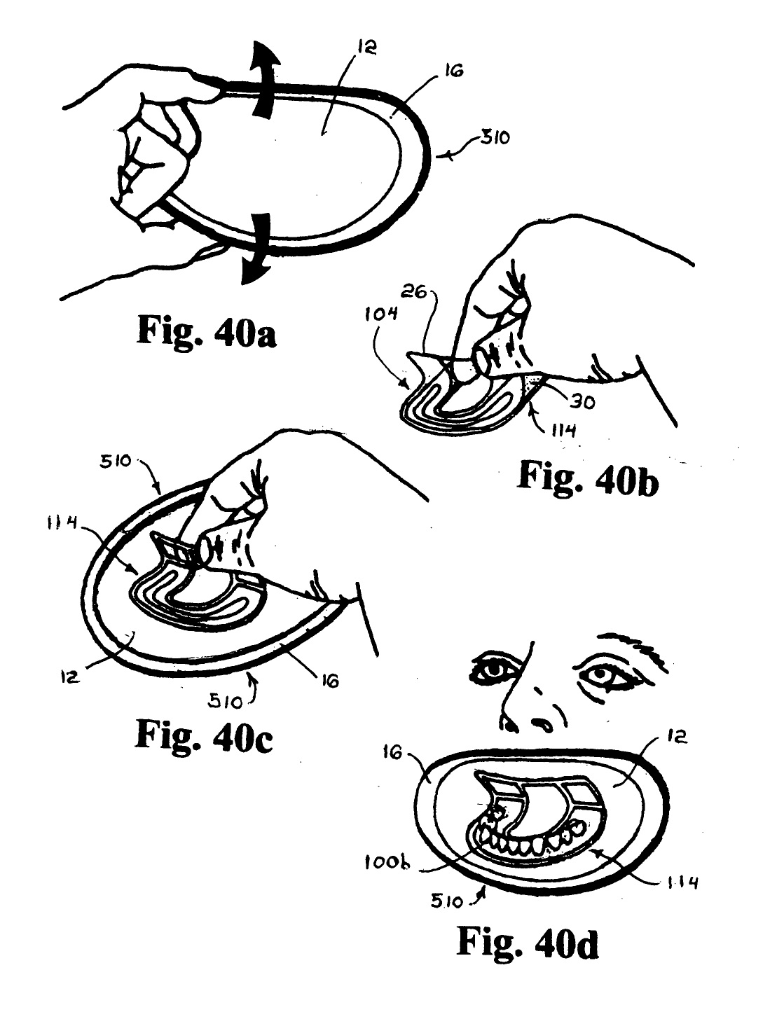

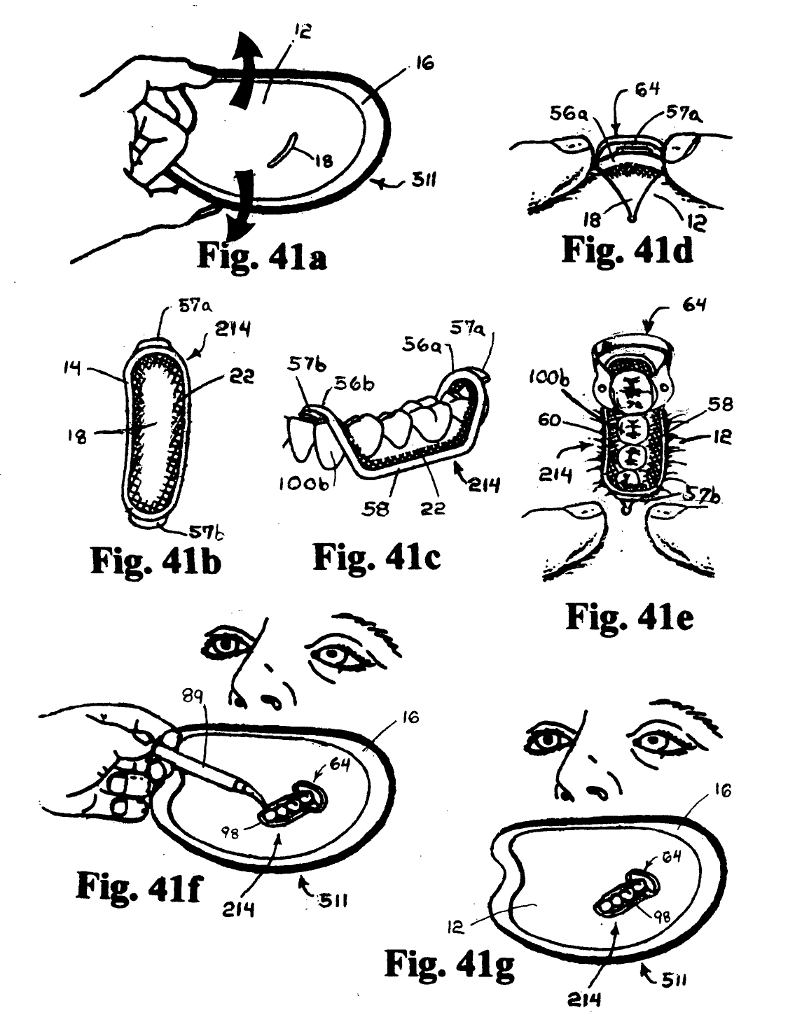

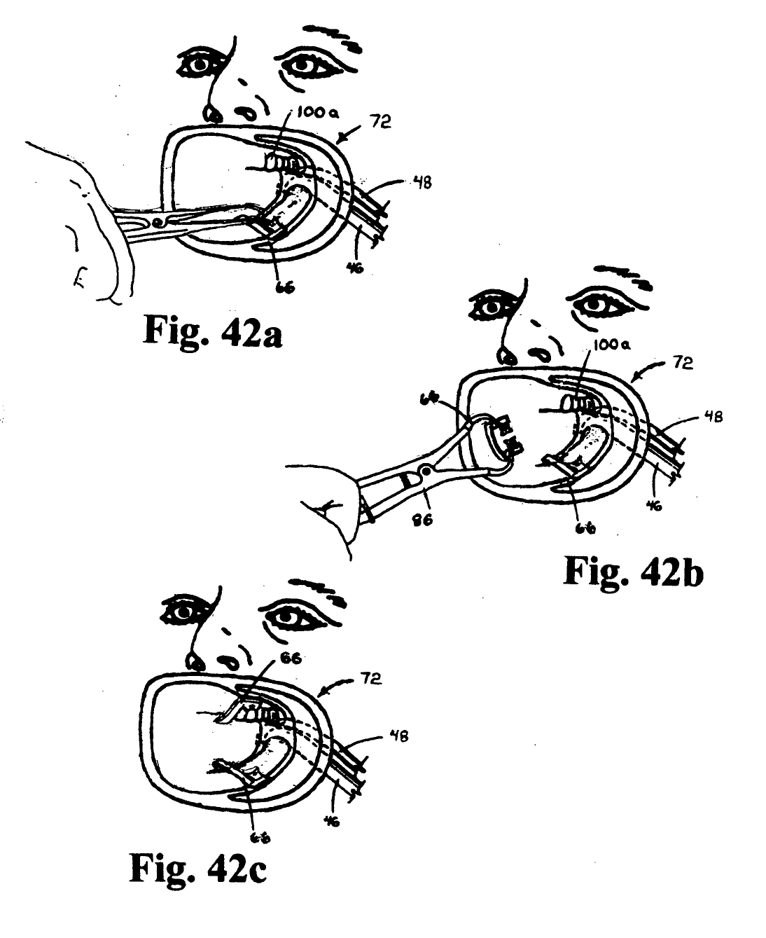

FIGS. 40a through 40d show a sequence of steps in which an operative insert which is a separate device shown generally at 104 has an adhesive applied to one surface of the insert, with a release liner 26 covering the adhesive to keep it in a tacky consistency until it is applied to a rubber dam. In this sequence of drawings, a rubber dam with an integrally attached frame as shown in FIG. 40a generally at 510 is selected. An inter-arch operative insert with an adhesive applied during the manufacturing process, as shown in FIG. 40b generally at 104 is prepared by peeling the release liner 26 off of the device to expose the pressure sensitive adhesive applied to the device. In FIG. 40c, the operative insert 104 is attached to the rubber dam 510. The resultant assembled dam now is an inter-arch dam with an integrally attached frame and has been field assembled by the clinician. All steps to prepare the dam for either conventional or field isolation previously discussed in this disclosure are applicable to this type of dam, so an in-depth discussion will not be repeated. Although an inter-arch operative insert device is graphically depicted, intra-arch operative inserts may also be manufactured and field assembled in the same manner.

FIGS. 41a through 41g demonstrate the sequence of steps for field assembly of a rubber dam with an operative insert which is a separate device with a fabric or mesh material in which to micro-mechanically bond a manually applied barrier material to the insert to seal the tissue-dam interface of a general field isolation rubber dam. The insert shown may or may not have an integrally applied adhesive applied to it in order to seal the interface between the insert and the dam. The embodiment of the insert device shown in FIG. 41b, generally at 105 does not have an adhesive applied to attach it to a rubber dam. Shown in FIG. 41a generally at 511 is a field isolation dam with an integral exterior frame 16 without an operative insert. This dam has previously had a central opening 18 prepared in the rubber dam membrane 12 either during the manufacturing process or alternatively by the end-user using the slit-dam method of cutting a slit with a scissors between two holes punched in the dam. The intra-arch insert device 105 is first prepared for insertion by bending the insert to form anterior and posterior transverse arches 56a and 56b connecting a facial bow 58 and a lingual bow 60 into a three-dimensional circumferential ential perimeter. As shown in FIG. 41c, the prepared insert is placed over the segment or quadrant of teeth to be isolated. The insert is then preliminarily anchored to the quadrant with a conventional rubber dam clamp 64. As shown in FIG. 41d, with the insert in place, the posterior end of the central opening 18 is stretched over the rubber dam clamp and the posterior end-tab projection 57a of the posterior transverse arch 56a. FIG. 41e shows the anterior end of the central opening 18 being stretched over the anterior end-tab projection 57b connected to the anterior transverse arch 56b, with the longitudinal sides of the central opening 18 tucked beneath the facial bow 58 and lingual bow 60. The tensile forces generated by circumferentially stretching the rubber dam around the insert device 105 and the rebound tendency of the stretched membrane attempting to return to a relaxed, un-stretched state seals the interface between the insert device 105 and the rubber dam membrane 12 without adhesive. FIG. 41f shows a barrier material 98 being manually applied with a syringe 89 to the fabric mesh material 22 of the insert device 105 around the periphery of the insert to seal the tissue-dam interface to prevent moisture seepage from entering the operating field. FIG. 41g shows the completed circumferential boundary of polymerized barrier material 98 around the operating site.

### An Alternative Method and Embodiment and of Field Assembly of Dams With Operative Inserts and Integrally Attached Frames Utilizing an Insert Device Which Lacks an Integrally Applied Adhesive

The text of the provisional application and the utility application describe methods of field assembly of rubber dams with operative inserts which are devices separate from the rubber dam membrane. As shown in FIG. 40a, a rubber dam with an integrally attached exterior frame as shown generally at 510, and an inter-arch operative insert 14 which is a separate device as shown in FIG. 40b generally at 114, may be attached by removing the release liner 26 off of the back of the operative insert device 114 to expose an integrally applied pressure-sensitive adhesive 30, and then turning the insert over and pressing it against the rubber dam membrane 12 to form a bilateral inter-arch dam with an operative insert 14 and an integrally attached frame 16. Of course this method is equally applicable to unilateral inter-arch inserts and intra-arch inserts of any type described in this disclosure, although not specifically graphically depicted. Another method of field assembly of a dam with an operative insert device which may lack an adhesive backing is shown in FIGS. 41a through 41e. FIG. 41a shows a rubber dam generally at 511 with an integrally attached frame 16, a rubber dam membrane 12 and a slit prepared in the membrane 18. FIG. 41b shows an intra-arch operative insert generally at 214 which has a fabric or mesh material 22 facing inwardly from the operative perimeter 14 around the central opening 18. Although FIG. 41b shows the flat configuration, FIG. 41c shows the operative insert device 214 bent into elements of an anterior transverse arch 56b, a posterior transverse arch 56a, a facial bow 58, and a lingual bow 60. Rubber dam tabs 57a & 57b projecting outwardly from their respective anterior and posterior transverse arches 56a and 56b.

The method of use of this device includes the bending of the device into the four elements of a three-dimensional operative perimeter and then placing the device over a posterior segment of teeth 100b as shown in FIG. 41c. A rubber dam clamp 64 is then placed over the posterior portion of the insert to anchor it to the alveolar arch. As shown in FIG. 41d, the central opening 18 of the rubber dam is then stretched over the rubber dam clamp 64, posterior transverse arch, 56a, and rests upon the posterior rubber dam tab 57a. The slit-like central opening in the dam 18 is then stretched anteriorly until it covers the anterior rubber dam tab 57b attached to the anterior transverse arch 56b and tucks under the facial bow 58 and the lingual bow 60. The stretched dam is then released and the rebound of the stretched material pressure seals the interface between the insert 214 and the rubber dam membrane 12 without the need for an adhesive. With the insert and dam in place and prepared with a central opening 18 for field isolation of a segment of teeth and the associated soft tissues, FIG. 41f shows a manually applied barrier material 98 being applied with a syringe 89 around the periphery of the insert 14 over the fabric or mesh 22 material. The wetting properties of the barrier material cause the unpolymerized material to flow into the mesh lattice. When the barrier material is completely applied and is polymerized as shown in FIG. 41g, a micro-mechanical bond is formed between the barrier material 98 and the mesh material 22, intimately sealing the tissue-dam perimeter against moisture leakage and contamination of the operating site and ingestion or aspiration of dental materials by the patient. The advantage of a mesh material forming a mechanical bond with a barrier material is that any kind of barrier material may be applied to seal the insert without regard to its chemical composition.

### Conventional Isolation Techniques, General Field Isolation, and Hybrid Isolation

It needs to be emphasized that all embodiments of this continuation-in-part disclosure of dams with operative inserts, a barrier membrane, and integrally attached frames, as with all embodiments of dams of the parent disclosure lend themselves to any type of clinical isolation method, whether it be conventional isolation of the clinical crowns of the teeth, or general field isolation of the teeth and soft tissues, or a hybrid type of isolation. This is true whether the darn is manufactured in a flat configuration or as a three-dimensional dam. It is equally true whether the openings are integrally prepared in the dams at the time of manufacture or alternatively at the time of application by the end-user. It is true whether the operative insert is an intra-arch insert or an inter-arch insert. It is true whether the dam is completely manufactured prior to reaching the end-user or alternatively is field-assembled by the end-user. While most graphic depictions presented are of solid membrane dams with unperforated diaphragmatic alveolar membranes, requiring the end-user to choose the type of preparation of the dam for isolation, any dam depicted may be pre-manufactured for any type of isolation method. This applies to any alternative embodiment disclosed in this continuation-in-part disclosure or the parent disclosure (whether graphically depicted or not) or logically designed by extrapolating from the ideas and principles of construction and methods of application presented is considered to be within the spirit and scope of this disclosure.

### Precautions for Use of Rubber Dams With Operative Inserts and Integral Exterior Frames

The precautions for use of the dams of this continuation-in-part disclosure, are virtually identical to the precautions listed in the text of the antecedent disclosures and therefore will not be duplicated in their totality. As a summary, a thorough health history should be undertaken to determine atopic predisposition, including a history of allergic response to any materials present in the type of dam to be applied, such as a previous response to latex. It cannot be emphasized enough that a thorough health history and survey of any breathing difficulties as outlined in the previous disclosure, as well as anxiety reactions such as panic attacks or feelings of claustro-phobia or other contraindications to the application of a rubber dam must be undertaken prior to application of these dams. The use of any rubber dam is contraindicated in cases of extreme emphysema, COPD, pulmonary fibrosis, or other severe pulmonary impairment, whether the individual is on oxygen therapy or not. In addition, extreme panic reactions, or extreme generalized anxiety reactions, psychosis or psychiatric syndromes, including claustrophobia, rule out the use of a rubber dam. A breathing tube should always be securely placed beneath the dams of this disclosure in order to enhance mouth breathing. Many patients may be comfortable breathing through their nose during a procedure, but the placement of a breathing tube is mandatory. The placement of a saliva ejector beneath the dam in such a manner that it effectively suctions saliva an maintains an open airway is of importance for the patient's comfort and safety and optimal functioning of the rubber dam clinically. Supplementary rubber dam clamps may be useful in a few cases where an inter-arch dam will not stay in place due to extended opening, but the placement of supplementary rubber dam clamps should be a ‘last resort’ and should always be accompanied by the placement of a breathing tube to enhance mouth breathing during the procedure. Any rubber dam clamps placed should be ligated prior to placement to facilitate quick removal, as well as any endodontic files, implant components, or other small devices. The use of rubber dam retaining devices such as the quick release device depicted in FIG. 22b to isolate an edentulous segment requires prior identification in the health history of any bleeding disorders which would contraindicate the use of such devices. In addition, the clinician must ascertain and avoid any pathway of any nerves in the vicinity where this type of device would be employed. This type of rubber dam retaining device should only be utilized to engage fibrous tissue directly over the alveolar process for maximum safety and adherence during deployment. Whenever supplementary rubber dam clamps or other auxiliary retaining devices are employed, the clinician should familiarize himself and feel confident that he could remove the rubber dam device quickly if an occasion of need presented itself. The employment of the conventional technique of rubber dam application should be considered prior to utilizing a general field isolation approach. Procedures requiring subgingival instrumentation, however, are excellent candidates for field isolation techniques. The clinician must be vigilant to maintain an hermetic seal around the operating site at all times to prevent the ingestion or aspiration of small objects. A second line of defense of the prevention of aspiration of small devices by ligating the small components prior to insertion into the operating field should always be employed. Conscientious attention to detail and the exercise of good clinical judgment in the use of isolation devices is ultimately the responsibility of the dentist as end-user. Any abbreviated intra-oral rubber dam devices should be designed with external frame component(s) which allow the clinician to rapidly remove the rubber dam device if necessary. Any abbreviated intra-oral rubber dam device manufactured without extra-oral elements should be securely ligated prior to insertion to allow for rapid removal of the rubber dam device if necessary. The clinician should familiarize himself with the use of any rubber dam device or accessory and feel confident that all clinical steps to prevent aspiration have been taken and that any device utilized could be removed quickly if the occasion presented itself.

### Material Handling Specifications for Dams With Operative Inserts and Integral Frames

### Polymeric Membrane Specifications

General field isolation dams of the present invention for dental purposes will consist generally of 6″×6″ square polymeric membranes for adults or 5″×5″ square membranes for children, with generally accepted specifications of thicknesses according to accepted dental standards, with the following values: thin 0.006″; medium 0.008″; heavy 0.010″; and extra heavy 0.012″. While these standard values will most likely be found to be the most useful, any general field isolation rubber dam manufactured with the parameters of 0.002″ to 0.200″ should be considered to be within the area of general filed isolation dams of the present invention.

The membranes may be manufactured of a wide variety of polymeric or thermoplastic materials such as latex, neoprene, silicone, polyethylene, vinyl, polyurethane, or other polymeric or thermoplastic materials of suitable qualities, so long as the membranes demonstrate the physical handling characteristics necessary for successful clinical field isolation of the dental operative site. Some of the typical parameters of physical characteristics of materials required of these polymeric membranes are: range of tensile strength 2,500-10,000 psi; elongation at break 400-1,110%; hardness (shore) 60- 100 A; and notched resistance to tearing 100+ kilonewtons per meter. These characteristics of physical materials are general guidelines only. Individual materials may vary depending on their composition and physical attributes, but still be considered to be within the spirit and scope of this invention.

Alternative materials of construction of the barrier membrane portion of these dams such as a malleable sheet material with the action of a foil, or alternatively a plastic, resin, mylar, or composite with a low percentage of elongation may be substituted for the elastomeric membrane in some types of dams as presented in the previous discussion.

### General Field Isolation Rubber Dams With Integrally Applied Barrier Adhesives

### Pressure Sensitive Adhesives

General field rubber dams may be constructed with barrier adhesives pre-applied in their manufacture. One classification of adhesives of potential application to the general field isolation rubber dam method of isolating tissues are generally are known as pressure-sensitive adhesives, also referred to as PSA's. Pressure sensitive adhesives are viscoelastic materials which, in solvent−free form, remain permanently tacky and will adhere instantaneously to a wide variety of solid surfaces as a result of application of very slight pressure. A PSA is usually applied in the form of a solvent—free coating on a “backing”, often a flexible backing—in this application to the polymeric surface of the general field isolation rubber dam. The PSA attaches the “backing” material (i.e., the flange of the dam), to a “receptor” (i.e., the surface to which the PSA is to adhere to with the application of pressure to the intra-oral mucosa or enamel of the teeth).

The PSA must have characteristics which satisfy the requirements of the application intended-in this case of an intra-oral isolation device. First, it must adhere to the receptor, in this case the hard tissues of the teeth and also the gingival and mucosal tissues, with sufficient t peel strength' which resists removal from the receptor for the purpose intended. Second, it must adhere to mucosal tissues in the presence of oral fluids being present upon application and continue to adhere tenaciously in spite of being in an environment which is bathed in oral fluids and water during the attachment phase. Third, it must be able to be removed cleanly from the receptor without leaving a residue of adhesive and without causing undue discomfort, tissue damage, or without rupturing the backing material. Fourth, it must be hypo-allergenic or not irritate the mucosal epithelium upon application or in any manner after application.

It is important that the adhesion to the oral tissues is low enough to allow the strip of material to be easily removed by simply peeling off the strip of material using only finger pressure when the dam is removed at the completion of the treatment session. The peel force required to remove the strip of material, which will typically be about ½ cm in width from the oral surface is from about 10 grams to 15 grams per side of oval operative perimeter. Since the removal of the oval perimeter requires both sides to be removed at the same time, this range varies from 20 grams to 30 grams as the dam is stripped off. A wider range of 0 grams to 50 grams is possible due to inconsistencies in the application of the dam and the flexural stiffness of the wire insert within the dam.

There are a variety of compositions of mucosal adhesives that would be suitable as integrally pre-applied barrier substances. Suitable limited water solubility polymer adhesives include: hydroxy ethyl or propyl cellulose. In addition polymer adhesives lacking water solubility include: ethyl cellulose and polyox resins. One possible adhesives suitable for integral application is polyvinylpyrrolidone; or still another is a composition of Gantrex and the semisynthetic, water-soluble polymer carboxymethyl cellulose. The widely used cyanoacrylates; methyl, dimethyl, ethyl, butyl, octyl and other are compositions compatible with mucosal tissue adherence. These PSA's can comprise a base polymer alone or a mixture of base polymer and one or more additives such as plasticizers, tackifiers, fillers, stabilizers, and pigments. This list of PSA's does not exhaust the range of possibilities of alternatives for integrally applied adhesives, and should not serve to limit the options available for this application. The integrally applied adhesive substance may be in the form of a viscous liquid, paste, gel, solution, or other suitable physical form in a substantially uniform continuous coating around the inner peripheral latex flange of the operative work site, on the side of the rubber dam designated for direct contact with the hard and soft tissues of the operative site.

The adhesive is covered by an easily removable covering, called a release liner, which keeps the adhesive in a maximally tacky state until it is required for use. At this time, the release liner is stripped off, exposing the adhesive, and applied to the receptor. The release liner may be composed of a single piece of flexible or rigid material or from two overlaying pieces of said material such as a typical adhesive strip bandage design. The release liner is preferably comprised of any material which exhibits less affinity for the adhesive coating than the adhesive substance exhibits for itself, and strips off with finger pressure to expose the adhesive film that it is adhered to. This liner may be comprised of a rigid sheet of material such as polyethylene, paper, polyester, or other material which is coated with a non-stick type of material. The release liner material may be coated with Teflon®, wax, silicone, fluoropolymers, or other non-sticky coating.

General field isolation rubber dams with pre-applied mucosal tissue adhesives acting as barrier agents to refine the integrity of the moisture seal between the patient's oral cavity and the dentist's operative work site will save time and effort for the clinician when applying the rubber dam for use in a procedure. In the case of PSAs used primarily as barrier materials the general tackiness and retentive adherence of the flange of the dam by the adhesive need not be strong enough to retain the rubber dam in place, since mechanical forces of applied rubber dam clamps and the rigidity of the wire insert are the principal means of retention of the dam. The applied adhesive need only attach the flange of the rubber dam to the hard and soft tissues with enough retentive force to prevent breakage of the moisture seal by frictional forces created by the lips, teeth, tongue, and other extraneous forces applied during a typical treatment session.

### Non-Pressure Sensitive Adhesives

Other classifications of tissue adhesives are polymeric compositions which are designed to adhere to hard and/or soft tissues of the human body (fibrin glues and methacrylates are two commonly applied categories, but other compositions may also be substituted), but need an initiator to activate the process of polymerization and adherence to the receptor, which is the tissue surface of the intended application. Generally, initiators fall into three categories of chemical, thermal, and photo-polymerization. Tissue adhesives which are chemically activated may be initiated with chemicals applied to them or chemicals naturally present in the biological tissues of the application. Water is one chemical which may be applied directly to a tissue adhesive by the clinician or may be found naturally in saliva. Hence, there are biologically compatible tissues that may be selectively activated by water. Other tissues adhesives may be activated by the application of or contact with other chemicals, such as components of human saliva or even proteins present in on the epithelial surface of the gingiva or mucosal tissues in the oral cavity or by proteins present in the enamel pellicle coating the surfaces of the teeth. Still other tissue adhesives are designed to be photoactivated by the exposure to light of a certain intensity and wavelength. Tissue adhesives activated by any of these methods are candidates for integral application to the general field isolation rubber dam.

### Photo-activated Tissue Adhesives

General field isolation dams with integrally applied tissue adhesives requiring photo-activation for adherence to hard or soft tissues of the oral cavity or other extra-oral tissues will be of great efficacy to the clinician in establishing adherence of the tissue-dam interface as a barrier to refine the moisture seal of the application or as retention of the dam to the tissues to be isolated or combination applications of barrier/retention simultaneously. General field isolation dams may be constructed to enhance the translucence of the polymeric membrane so that a photo-activated tissue adhesive which is applied to its surface may be activated by shining a visible wavelength curing light through the dam in order initiate polymerization and adhere the dam to the tissue surface. The ideal photo-activated tissue adhesive for this application would have a non-tacky dry, adhesively inactive external surface and would adhere to the dam tenaciously during the molding of the operative perimeter to the anatomical structures by the clinician in the preparation stage. Once in place and in contact with the tissues to be isolated, a visible wavelength light curing unit would be activated to shine light through the dam, turning the tissue adhesive into a gel with a wetting ability to make it intimately compliant to the surface, which means that it conform three dimensionally to the surface during polymerization to create a competent adhesive-tissue interface, which, after polymerization is intact, adheres the adhesive and the dam tenaciously to the surface. (Note: the degree of tenacity of retention of the adhesive-tissue interface is discussed under the pressure-sensitive adhesives discussion of peel strength and is the same requirement in both types of bonding of adhesives.) The same requirements of the adhesives applied in this type of application, such as being suitable in a moist environment and insoluble to moisture in saliva and other water-based liquids applied during a procedure, as indicated in the discussion of pressure-sensitive adhesives is applicable to the application of these adhesives also.

### Wire or Insert Selection and Specifications

Embedded with the polymeric membrane in an appropriate position is a continuous wire loop, metal stamping, or other suitable material with the requisite material handling characteristics and specifications. The shape of the loop, the cross-sectional shape of the material, the amount of material in cross section, the area moment of inertia, the alloy chosen on the basis of its modulus of elasticity, tensile strength, and yield point, and degree of tempering may vary, as long as the handling characteristics and mechanical properties of the insert requirements are satisfied with relation to the ease of bending by the operator and the resistance to deformation by the type and thickness of the stretched polymeric membrane within which it is inserted or to which it is applied.

While the behavioral characteristics of a metal formed into a wire or metal stamping are described for reference, any alternative material or device substituted should impart the following qualities: The operative perimeter should be quite soft and malleable so as to be easily bendable into any form required by the clinician manipulating it with finger pressure—at the preferred specifications, the clinician should feel that he or she is actually molding the operative perimeter instead of feeling like they are bending a stiff wire or metal stamping; once bent into the configuration required by the anatomical operative site, the wire must maintain its configuration with tenacity of a “memory” of the clinician's specifications and requirements for use without rebounding to another shape; it must withstand the tensile forces applied to it by the elastomeric membrane when it is stretched over an external framework and when subjected to the normal stresses of the restrained musculature during an ongoing procedure, such that it does not appreciably distort from the desired operative shape designated by the clinician who formed it.

Wires of different materials and different gauges were sought out for insertion and the operative inserts of the dam in this disclosure. Initially, wires of different metals and diameters were chosen from an intuitive basis for qualities of easy bending and handling and also resistance to moderate stresses. Through a process of trial and error, for different materials were selected and the appropriate gauges of wire narrowed down to refine the outcome of constructing inserts with appropriate handling characteristics for this disclosure.

A. Dead-soft, Malleable Inserts.

To test wires that were under consideration, an experiment was designed as follows. The test wire was first bent 180° around a cylindrical object with a 3/16″ diameter to form a U-shape configuration simulating one end of a typical operative insert. The U-shaped wire was inserted into a vise with ¾″ of the rounded loop extended perpendicularly of the vise. A strain gauge with a hook was attached to the end of the loop and pulled until the wire has been bent 45° from its initial position. An annealed copper wire of 0.040″ diameter was tested and found to require between about 1.75 and about 2 lbs. of pressure on the strain gauge. Since this wire had a satisfactory feel when deformed by hand, this range of force was selected as a preferred range. A 20 gauge C1008 brite annealed steel wire was similarly tested and found to have about the same range of force. Testing also revealed that an annealed 0.033″ diameter LVM stainless steel wire required about 1.64 to 2 lbs. of pressure to bend.

A number of diameters of aluminum wire were subjected to the same experiment. Aluminum, a very soft and pliable metal, proved to have excellent qualities of plasticity over a range of different diameters. A 0.050″ wire required 1.25-1.50 lbs. of bending pressure, while a 0.064″ wire of the same alloy required 1.75-2.00 lbs. of pressure, both within excellent ranges. Both larger and smaller diameters would be applicable to polymer membranes of different thicknesses. Larger diameters up to about 0.070″ might fulfill the handling characteristics required, but the diameter of wire would be quite thick for the application. It should be noted that while wire samples were measured for this application, metal stampings, or die-cast parts or other methods of producing the parts which would duplicate the amount of material in cross section would be comparable.

To further refine a range of optimal handling characteristics and to ascertain the parameters of acceptable substitutes for inserts in this particular thickness of latex rubber dam, a series of numbers were used to rate handling characteristics of wire loop inserts for two different metals, aluminum and bare copper wire. A scale of 1 to 10 was used for the rating scale, with 10 representing the most optimal performance of a wire loop insert for the application, and 1 representing an outcome that would be undesirable in any circumstance. The degrees of the scale are listed below for more clarification:

| Rating Number | Handling Characteristics |
|---|---|
| 10 | Excellent High Optimal |
| 9 | Near Optimal |
| 8 | Sub Optimal |
| 7 | Acceptable |
| 6 | Useful in many circumstances |
| 5 | Useful in some circumstances |
| 4 | Useful in few circumstances |
| 3 | Undesirable in many applications |
| 2 | Undesirable in most application |
| 1 | Undesirable in any circumstance |

Aluminum 1100 Wire Loops

| Wire | Diameter | Gauge | Forces | Rating of Handling |
|---|---|---|---|---|
| # | (inches) | (AWG) | (lbs.) | Characteristics |
| 1 | 0.0201 | 24 | 0.05 | 1 |
| 2 | 0.0253 | 22 | 0.12 | 2 |
| 3 | 0.0319 | 20 | 0.25 | 3 |
| 4 | 0.0403 | 18 | 0.5 | 6 |
| 5 | 0.0508 | 16 | 1.50 | 10 |
| 6 | 0.0640 | 14 | 1.75-2.0 | 9 |
| 7 | 0.0808 | 12 | 3.75-4.0 | 3 |
| 8 | 0.1250 | 8 | Way too high | 1 |

Bare Copper Wire Loops

| Wire | Diameter | Gauge | Forces | Rating of Handling |
|---|---|---|---|---|
| # | (inches) | (AWG) | (lbs.) | Characteristics |
| 1 | 0.0200 | 24 | 0.25 | 1 |
| 2 | 0.0250 | 22 | 0.5 | 2 |
| 3 | 0.0320 | 20 | 1.0-1.25 | 7 |
| 4 | 0.0400 | 18 | 1.75-2.0 | 10 |
| 5 | 0.0510 | 16 | 2.25-2.50 | 8 |
| 6 | 0.0640 | 14 | 5.50-6.0 | 2 |
| 7 | 0.0800 | 12 | 7.0-8.0 | 1 |

In summary, the material required in this application needs to be in an annealed state or at the most or have a soft temper, if it is a metal. According to the experiments conducted, wire loops of varying material alloys and varying diameters of cross section, bent with a force of from 1 & ½ lbs. to an upper limit of 2 & ½ lbs. were considered optimal with regard to handling characteristics by the operator and were within an acceptable range of resistance to deformation by tensile forces of the stretched medium thickness (0.008″) latex membrane. While other wires of varying diameters and gauges were tried for this application, many of which might be substituted and achieve somewhat acceptable results, the four wire/diameter combinations were chosen because they approached a range of optimal performance. Wire inserts with a bending force as measured by the aforementioned means with a range of from 2 & ½ lbs. to 4 lbs. of bending pressure were also possible candidates for construction of a general field isolation dam, but between 4 lbs.-6 lbs. of force as measured by the strain gauge demarked a gradual deterioration of the proper handling characteristics for the application, making the construction of a general field isolation d dam in this range or above gradually more undesirable but still possible from a clinical standpoint. Any use of an insert above 6 lbs. of bending pressure would be unacceptable in any malleable operative insert designed for manipulation with finger pressure alone.

While wires were used in the initial production of prototypes to ascertain the optimal handling characteristics and the parameters of performance of the operative inserts for the general field isolation rubber dams, it should be noted that the values obtained may be extrapolated to substitutes for the construction of inserts such as metal stampings or die cast parts or other formed parts if the insert is a metal, or molded parts is the material is a memory-retaining plastic or composite or other material to be substituted. It is also possible that larger diameter wires or stampings, with grooves cut in the material with a high enough density could weaken the material enough to simulate a similar result. Any other material or device that would serve as a substitute, however, must fulfill the clinical material handling characteristics as specified by this experimentally derived criterion for this application.

B. Reciprocal Forces in Dams With Resilient and Deformable Inserts and Integral Frames

The characteristics of resilient inter-arch operative inserts were tested to determine the optimal characteristics of resiliency and the generation of reciprocal forces for inter-arch dams with integrally attached exterior frames, and to determine parameters within which these resilient inserts might function successfully. The experimental protocal for the determination of values of resiliency of operative inserts in inter-arch applications is presented in the primary disclosure to which this continuation-in-part application makes reference and will not be repeated here. It should be noted, however, that rubber dams with resilient and deformable inserts and integrally attached frames generate different reciprocal forces than rubber dams with resilient inter-arch inserts without integral frames. The integral exterior frame, connected to the labial (facial) bow, cervically retracts this element of the dam with a degree of force which is not applied in the same manner as forces generated in dams without integral frames which are stretched over exterior frames which are separate devices. The distance of extension of the facial bow element of the dam from its point of connection to the posterior elements of the dam must be taken into consideration when calculating the amount of resiliency that should be imparted to the exterior frame. The summation of resilient forces of the integral exterior frame must be added to the summation of inter-arch forces of the inter-arch operative insert itself in order to reach an accurate calculation of the construction of elements of a dam which is compatible with the physiological requirements of a patient and the duration of the operating procedure.

While most dental appointments are approximately one hour in length, this rule of thumb is not universally true. Many dentists schedule short emergency appointments of approximately ½ hour, and extended appointments of 1 and ½ hour to two hours for extensive reconstruction are not uncommon. If a resilient dam exerts too much pressure to the patient's musculature over an extended period of time, muscular fatigue and cramping will occur, causing the patient discomfort. Patients differ remarkably, however, in their individuality and their ability to tolerate different circumstances; for example, in a burly patient with a very strong musculature, an insert which generates a higher amount of reciprocal force is necessary to encourage the patient to keep his mouth open during the procedure. A patient going through orthodontics at an age of 14 to 16 will not be able to resist the reciprocal forces of a resilient dam that is appropriate for an adult patient going through the same treatment regimen. for this reason, dams with integral frames may be constructed with different values of reciprocal forces which are appropriate in different circumstances.

Variations in Embodiments Due to Manufacturing Constraints and Financial Costs

The foregoing embodiments described herein may vary somewhat due to restrictions in manufacturing processes, the financial constraints of producing an end-product at a cost which is competitively priced to the end-user, and preferences of form or usage, but still fall within the spirit and scope of this disclosure. All features of embodiments and specifications for construction of the dams disclosed in the primary disclosure are as applicable to rubber dams with operative inserts and integral frames as they are to rubber dams lacking integral frames. Simple substitution of material composition, such as the substitution of polyurethane or nitrile or silicone or neoprene or vinyl or other elastomeric materials for the standard latex membrane should not be considered a change in novelty; nor should the departure from an elastomeric material, such as a foil or plastic or composite be considered a change in novelty. Construction of a dam with two types of operative inserts utilized simultaneously, such as a malleable sheet within the membrane itself and a resilient inter-arch operative insert and frame attached to the outside of the membrane to utilize the reciprocal forces of the patient's musculature transmitted through the upper and lower arches falls within the spirit and scope of this disclosure and would not be considered a change of novelty. Construction of a dam with an operative insert with a different material from the integral frame, such as an intra-arch dam with a malleable operative insert and a resilient integral frame should not be considered a departure of novelty from the foregoing discussion. The construction of a dam with the operative insert molded within the membrane, but the integral frame attached to the outside surface of the membrane and vice-versa should be considered to be within the spirit and scope of this disclosure. Departure from the formula of composition of the adhesives described which may be applied to the membranes to bond the dam directly to tissues or alternatively to allow the bonding of barrier materials directly to the rubber dam membrane should not be considered a change of novelty. An example of the use of a single “T” shaped projection from the operative insert of a posterior intra-arch dam is depicted and described in the primary disclosure, but dams which have multiple projections for securing the dam to soft tissue or inter-arch dams with similar mechanisms designed within their embodiments should be considered within the spirit and scope of the disclosure. The departure from the “T” shape of projection should not be considered a feature of novelty. The design of dams with projections which emerge perpendicularly to the plane of the dam instead of planar alignment as depicted in order to directly fasten rubber dam clamps or quick-release retaining devices to attach the dam to teeth or to soft tissues should not be considered a novel adaptation. While most dams graphically display a circular or oval framework, any other form of framework, including square, rectangular, pear-shaped, triangular, or other form may be substituted if it serves an efficacious purpose in the construction of an effective isolation device.

Any embodiment described in the disclosure but not graphically depicted, should be fully considered to be within the spirit and scope of the disclosure. The general principles of construction or methods of application of the dams described and depicted are illustrative of the basic principles of isolation with the rubber dams of the primary disclosures and also this continuation-in-part disclosure. Merely listing steps of a method in an alternative manner or leaving out or adding a step specified in a method of described use does not constitute a change in novelty. The foregoing description and drawings merely explain and illustrate the principles of the invention, but the invention is not limited thereto, except in so far as the claims are limited. Those skilled in the art of dentistry will recognize obvious potential modifications and variations therein which are within the spirit and scope of the invention, but such modifications will not constitute a change of novelty.

I claim:

1. A rubber dam comprising a sheet of elastomeric material, an operative insert engaged to the sheet of elastomeric material and an integrally attached exterior frame.

2. A rubber dam as defined in claim 1, wherein the operative insert and integral frame are molded within in the elastomeric material.

3. A rubber dam of claim 1, wherein the operative insert and integral frame are attached to the outside surface of the elastomeric material

4. A rubber dam of claim 1, wherein the operative insert and integral frame are imbedded within or attached to the rubber dam membrane but are not integrally attached to one another

5. A rubber dam of claim 1, wherein the operative insert and integral frame are imbedded within or attached to the rubber dam membrane and are also integrally attached to each other

6. A rubber dam as defined in claim 1, wherein the operative insert is elastomeric.

7. A rubber dam as defined in claim 1, wherein the operative insert is malleable to a plurality of adjusted, three-dimensional shapes.

8. A rubber dam as defined in claim 1, wherein the operative insert is resilient within its elastic limit, but deformable beyond its yield point

9. A rubber dam as defined in claim 1, wherein the operative insert is substantially rigid

10. A rubber dam as defined in claim 7, wherein the operative insert comprises a material selected from the group comprising metal wire, metal stamping, die cast metal, die-cut metal, or molded or otherwise formed memory-retaining plastics or composites.

11. A rubber dam as defined in claim 1, wherein the operative insert comprises a closed loop which divides the sheet into a region exteriorly of the operative insert and a region interiorly of the operative insert.

12. A rubber dam as described in claim 11, wherein the elastomeric material interiorly of the operative insert is a solid contiguous membrane.

13. A rubber dam as defined in claim 11, further comprising an opening in the elastomeric material inside the closed loop.

14. A rubber dam as defined in claim 11, wherein a mesh material encircles the periphery of the opening to provide a bonding surface for a barrier material to be secured to the rubber dam around the perimeter of the operating site of a medical procedure.

15. A rubber dam as defined in claim 11, wherein the elastomeric material encircles the periphery of the opening forming a flange extended inwardly of the operative insert.

16. A rubber dam as defined in claim 14, wherein an adhesive is applied to the flange.

17. A rubber dam comprising a sheet of elastomeric material in which is embedded a sheet of malleable material which may be readily adjustable by finger pressure to a plurality of retained three-dimensional shapes.

18. A rubber dam as defined in claim 17, wherein the sheet of malleable material is a continuous sheet.

19. A rubber dam as defined in claim 17, wherein the sheet of malleable material is a discontinuous sheet.

20. A rubber dam as defined in claim 17, further comprising at least one opening in the malleable sheet for isolation of a site of a medical procedure.

21. A rubber dam, comprising an operative insert engaged to the sheet of elastomeric material which resists the transmission of tensile forces in the elastomeric material on a first side of the operative insert from being transmitted to the elastomeric material on an opposite side of the operative insert.

22. A rubber dam as defined in claim 21, wherein the operative insert is a closed loop.

23. A rubber dam as defined in claim 21, wherein the operative insert comprises one or more discontinuous elements that do not form a closed loop.

24. A rubber dam as defined in claim 7, wherein the elements of the dam and methods for use of the dam in isolating the field of a dental procedure in a single alveolar arch comprise:
(a) a sheet of elastomeric material;
(b) an operative insert engaged to the sheet;
(c) an exterior integrally attached frame
(d) an opening in the elastomeric material through which the dental procedure will be performed; and
(e) wherein the operative element is malleable and deformed by hand manipulation to create, a lingual bow, a facial bow, and a pair of linking transverse arches which correspond to the anatomical contours adjacent the field and assists in positioning the opening around the field.

25. A rubber dam as defined in claim 1 for isolating the field of a dental procedure in the mouth of a patient having an upper dental ridge and a lower dental ridge, wherein elements of the operative insert span both the upper alveolar ridge and the lower alveolar ridge simultaneously, comprising;
(a) reciprocally opposing labial bows
(b) reciprocally opposing lingual bows
(c) reciprocally opposing transverse arches
(d) reciprocally opposing diaphragmatic alveolar membranes
(e) inter-occlusal linking elements linking all reciprocally opposing elements with respect to the inter-occlusal dimensions of the patient's opened mouth
(f) an exterior frame integrally attached to the operative insert of the rubber dam

26. A rubber dam as defined in claim 25, wherein the operative insert is resilient or substantially rigid and is held in place at least partially by the reciprocal forces of the patient's musculature transmitted through the opposing alveolar arches.

27. A rubber dam as defined in claim 25, wherein the operative insert is malleable and is held in place at least partially by rubber dam clamps or retaining devices.

28. A rubber dam as defined in claim 1, wherein the integrally attached frame is composed of a material which is either malleable, resilient, or rigid.

29. A rubber dam as defined in claim 1 for isolating the field of a dental procedure, wherein the operative insert disperses the forces of the sheet adjacent to the operative insert, so as to limit stretching and tearing of the sheet

30. The rubber dam as defined in claim 1, wherein a dental clamp is used to assist in releasably retaining the rubber dam in position.

31. The rubber dam as defined in claim 1, wherein an adhesive is used to form a seal around the interface of the dam around the operating site, thereby eliminating or minimizing the seepage of leaks and particulates at this interface.

32. A rubber dam as defined in claim 1, wherein projections emerge from the operative insert to the exterior of the elastomeric material to assist in releasably retaining the rubber dam in position.

33. a rubber dam of claim 32, wherein specialized projections allow the rubber dam to be sutured directly to soft tissues to secure the rubber dam in position in the mouth of a patient.

34 a rubber dam of claim 32, wherein the specialized projections allow specialized rubber dam retaining devices to be connected to releasably secure the rubber dam in position in the mouth.

35 a rubber dam of claim 25, wherein the inter-arch operative insert is attached to the barrier membrane and also directly to the exterior framework at a location which is generally symmetrical or in alignment with the midpoint of one or both horizontal frame elements

36 a rubber dam of claim 25, wherein the inter-arch operative insert is attached to the barrier membrane and also directly to the exterior framework at a location which is generally symmetrical or in alignment with the midpoint of one or both vertical side frame elements

37 a rubber dam of claim 25, wherein the inter-arch operative insert is attached to the barrier membrane generally and also directly attached at at least one location to the exterior framework at a location which is generally located obliquely between the midpoint of a horizontal and vertical element of the exterior frame.

38 the rubber dam of claim 25, wherein the inter-arch operative insert has an incomplete complement of circumferential elements for isolating an operating field

39. the rubber dam of claim 37, wherein at least one of the elements of the operative inserts is fused to the surrounding barrier membrane material of like composition

39 the rubber dam of claim 37, wherein all of the elements of the operative insert are fused to the surrounding barrier membrane of like material, creating a unitary dam

40 the rubber dam of claim 39, wherein the material composition of the unitary body of the dam may be malleable, resilient, rigid, or elastic

41. the rubber dams of claim 1, wherein the dams are manufactured as flat, two-dimensional embodiments

42 the rubber dams of claim 1, wherein the dams are manufactured as three-dimensional embodiments

43 the rubber dams of claim 1, wherein the dams may be configured for bilateral anterior isolation may either have a flat or concave interior membrane

44 the rubber dams of claim 42, wherein dams manufactured for bilateral posterior isolation have a concave interior membrane

45 the rubber dams of claim 1, wherein the dams may be manufactured for unilateral posterior arch isolation

46 the rubber dam of claim 1, wherein the rubber dam is a true rubber dam in which the exterior membrane covers and retracts the patient's lips in a complete 360 degree circumferential manner

47 the rubber dam of claim 1, wherein the rubber dam is an abbreviated intra-oral rubber dam device in which the exterior membrane covers and retracts the patient's lips in less than a complete 360 degree circumferential manner

48 a method of assembling a rubber dam with an operative insert and an integrally attached frame by attaching an operative insert which is a separate device to a rubber dam which already has an integral frame

49 a method of claim 48, wherein a operative insert which is a separate device is attached to the rubber dam with an adhesive applied to at least one surface of the insert

50 the method of claim 48, wherein a rubber dam membrane is stretched over the the insert device which is a separate device and allowed to rebound, thereby allowing the rubber dam to pressure seal the interface between the membrane and the device

51 The rubber dam as defined in claim 1, wherein the thickness of the elastomeric material is from about 0.004 inches to about 0.100 inches in thickness when used in dental applications

52 The rubber dam as defined in claim 11, wherein the closed loop operative insert is bent with a pressure of between 0.12 pounds to 6.00 pounds of force

53 a rubber dam of claim 25, wherein the integrally attached frame which retracts the cheeks and lips may be supplemented by utilizing a rubber dam frame which is a separate device

54 a rubber dam of claim 25, wherein a portion of the rubber dam frame is integrally attached to the barrier membrane while another portion of the frame is detached from the barrier membrane in order to allow manual stretching of the barrier material over rubber dam attachment nibs mounted on the detached portion of the frame
